(19) United States
(12) Patent Application Publication
(10) Pub. No.: US 2026/0114452 A1
(43) Pub. Date: Apr. 30, 2026

(54) ADDITIVES FOR COLOR DRIFT REDUCTION IN COPPER-BASED ANTIMICROBIAL POLYMERIC FORMULATIONS

(71) Applicant: CORNING INCORPORATED, CORNING, NY (US)

(72) Inventors: Theresa Chang, Painted Post, NY (US); Shu Yuan, Horseheads, NY (US)

(21) Appl. No.: 18/687,549

(22) PCT Filed: Aug. 31, 2022
(86) PCT No.: PCT/US2022/042171

§ 371 Date: Feb. 28, 2024

Related U.S. Application Data
(60) Provisional application No. 63/240,672, filed on Sep. 3, 2021.

(51) Int. Cl. A01N 59/20; A01N 25/22; A01P 15/00

(52) U.S. Cl. CPC A01N 59/20; A01N 25/22; A01P 15/00

(57) ABSTRACT

Biocidal compositions including a carrier, a copper-containing material, and a copper-coordinating additive are provided. Methods of minimizing the color drift of a carrier are also provided. Methods of accelerating a color endpoint of a carrier are also provided.

### CROSS-REFERENCE TO RELATED APPLICATIONS

This application claims the benefit of U.S. Patent Application Ser. No. 63,240,672, filed Sep. 3, 2021, the entirety of which is incorporated herein by reference for all purposes.

### TECHNICAL FIELD

The present disclosure relates to copper-coordinating additives. More particularly, the disclosure relates to copper-coordinating additives for addition to polymeric formulations.

### BACKGROUND

Coatings or compositions such as paint may be applied on a substrate or surface or stored in a container. Over time, the coating or composition may be exposed to a number of undesired contaminants such as bacteria, viruses, mildew, mold, fungi, algae, and the like. It is the tendency of copper-based antimicrobial agents to drift in color over time, at least potentially in part due to exposure to such undesired contaminants, thereby changing the color of the coating or composition in which the copper-based antimicrobial agents are included, which may render the coating or composition visually unattractive or unsuitable for a particular purpose. Color stability of coating products may be extremely important where the products are intended to be used to coat readily. Copper (II) that is solubilized, oxidized, and coordinated may result in a blue/blue-green coloring agent that may be a major contributor to color drift, with color and intensity of the coloring agent dependent upon the ligands to which the copper (II) is bound. By contrast, copper (I) complexed with ligands is typically colorless or has negligible color contribution. The copper species, once solubilized in solution or in a film may oxidize, leading to a color change in the water- or latex-based paint in which the copper species is included. Whereas a blue color in the water- or latex-based paint resulting from addition of a copper species may or may not be desirable, a color drift of the water- or latex-based paint is generally considered unacceptable.

Thus, there is a need for materials and additives that may be added to coatings or other polymeric products to reach their color endpoints quickly, that would coordinate copper but do not impact the efficacy of the copper species. Further, there is a need for materials that may be added to coatings or other polymeric products that minimized the total amount of color drift from the initial color but that did not impact the efficacy of the copper species.

### SUMMARY

In an example, the present disclosure provides a biocidal composition. The biocidal composition includes: a carrier; a copper-containing material in the carrier, wherein the copper-containing materials includes from 10 to 100 weight % of an amount of extractable copper; and a copper-coordinating additive in the carrier, in a molar ratio of the amount of extractable copper to an amount of the copper-coordinating additive of from 1:0.1 to 1:25, wherein a concentration of the copper-containing material and the copper-coordinating additive in the carrier is from 0.01% weight/weight of the carrier to 5% weight/weight of the carrier. In certain examples, the copper-containing material may include from 25 to 50 weight % of the amount of extractable copper. In other examples, the copper-coordinating additive may be a compound of formula (I), (II), (III), (IV), (V), (XI), or (XII):

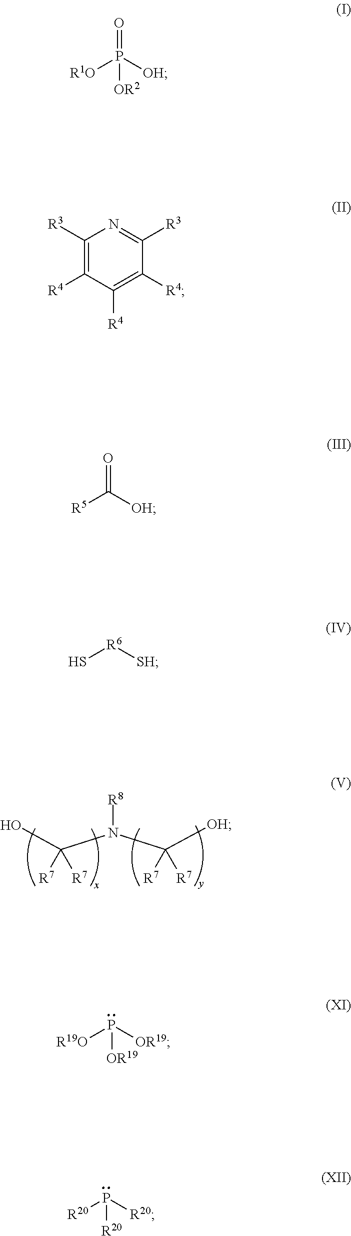

In still other examples, the copper-coordinating additive may be a compound of formula (I), (III), (VI), (VII), (IX), (X), (XI), or (II):

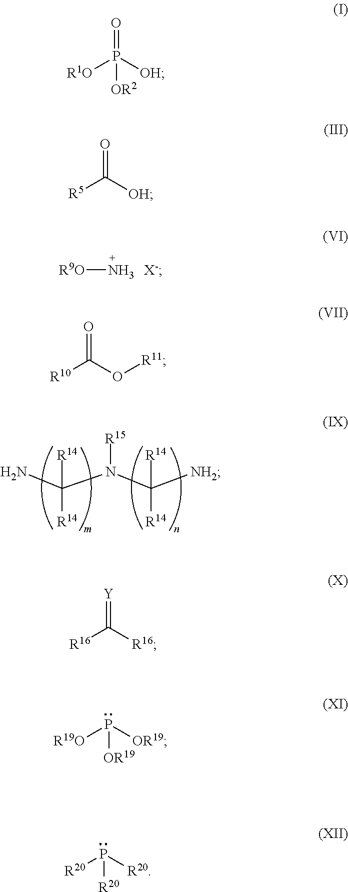

In still other examples, the copper-coordinating additive may be a compound of formula (VIII):

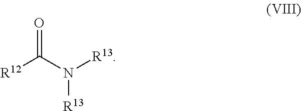

In still other examples, the copper-coordinating additive may be a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, 2,2′-bipyridine, terpyridine, citric acid, diethanolamine, triethanolamine, hydroxyamine hydrochloride, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen. In still other examples, the composition may demonstrate a greater than 3 logarithmic reduction in a concentration of a bacteria selected from the group consisting of Staphylococcus aureus, Enterobacter aerogenes, Pseudomonas aeruginosa, Methicillin Resistant Staphylococcus aureus, E. coli, and mixtures thereof.

In another example, the present disclosure provides a method of minimizing a color change in a biocidal material. The method includes: combining a copper-containing material including from 10 to 100 weight % of an amount of extractable copper with an amount of copper-coordinating additive, in a molar ratio of the amount of extractable copper to the amount of copper-coordinating additive of from 1:0.1 to 1:25 to form a copper-containing mixture; and combining the copper-containing mixture with a carrier to form the biocidal material, wherein a concentration of the copper-containing material and the copper-coordinating additive of the copper-containing mixture in the carrier is from 0.01% weight/weight of the carrier to 5% weight/weight of the carrier; and wherein the color change in the biocidal material is minimized relative to a change in color of a mixture of the carrier and the copper-containing material in the absence of the copper-coordinating additive. In certain examples, the copper-containing material may include from 25 to 50 weight % of the amount of extractable copper. In other examples, the copper-coordinating additive may be a compound of formula (I), (II), (III), (IV), (V), (XI), or (XII). In still other examples, the copper-coordinating additive may be a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, 2,2′-bipyridine, terpyridine, citric acid, diethanolamine, triethanolamine, 14-crown-4, 15-crown-5, 18-crown-6, dibenzo-18-crown-6, aza-15-crown-5, aza-18-crown-6, and salen. In still other examples, the biocidal material may demonstrate a greater than 3 logarithmic reduction in a concentration of a bacteria selected from the group consisting of Staphylococcus aureus, Enterobacter aerogenes, Pseudomonas aeruginosa, Methicillin Resistant Staphylococcus aureus, E. coli, and mixtures thereof. In still other examples, a CIE ΔE* value of the biocidal material may be less than about 10, as measured according to formula (XIII):

$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$

wherein L*, a*, and b* are the CIE L*, a*, and b* values of the biocidal material and the L*control, a*control, and b*control are the CIE L*, a*, and b* values of the carrier.

In yet another example, the present disclosure provides a method of accelerating to a color endpoint in a biocidal material. The method includes: combining a copper-containing material including from 10 to 100 weight % of an amount of extractable copper with an amount of copper-coordinating additive, in a molar ratio of the amount of extractable copper to the amount of copper-coordinating additive of from 1:0.1 to 1:25 to form a copper-coordinating mixture; and combining the copper-containing mixture with a carrier to form the biocidal material; wherein a concentration of the copper-containing material and the copper-coordinating additive of the copper-containing mixture in the carrier is from 0.01% weight/weight of the carrier to 5% weight/weight of the carrier; wherein a CIE ΔE* value of the biocidal material is less than about 10, as measured according to formula (XII), wherein L*, a*, and b* are the CIE L*, a*, and b* values of the color endpoint and the L*_{control}, a*_{control}, and b*_{control} are the initial CIE L*, a*, and b* values of the biocidal material; and wherein the color endpoint in the biocidal material is accelerated relative to a change in color to a color endpoint of a mixture of the carrier and the copper-containing material in the absence of the copper-coordinating additive. In certain examples, the copper-containing material may include from 25 to 50 weight % of the amount of extractable copper. In other examples, the copper-coordinating additive is a compound of formula (I), (III), (VI), (VII), (IX), (X), (XI), or (XII). In still other examples, the copper-coordinating additive may be a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, citric acid, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen. In still other examples, the biocidal material may demonstrate a greater than 3 logarithmic reduction in a concentration of a bacterial selected from the group consisting of Staphylococcus aureus, Enterobacter aerogenes, Pseudomonas aeruginosa, Methicillin Resistant Staphylococcus aureus, E. coli, and mixtures thereof. In still other examples, the method further includes: treating the copper-containing material with a pretreatment solution prior to the combining with the amount of copper-coordinating additive. In still other examples, the copper-coordinating additive may be a compound of formula (VIII).

### DRAWINGS

In order that the present disclosure may be well understood, there will now be described various forms thereof, given by way of example, reference being made to the accompanying drawings. The components in the figures are not necessarily to scale. Moreover, in the figures, like-referenced numerals designate corresponding parts throughout the different views.

FIG. 1 illustrates a plot of total color drift for a control paint sample commercially available from Behr® (“Control B”) and various copper-coordinating additives added to the control paint sample at various molar ratios of extractable copper, in a copper-containing material including from 10 to 70 weight % of an amount of extractable copper, to copper-coordinating additive, at a concentration of 50 grams of the mixture of the copper-coordinating additive and the copper-containing material per gallon of the control paint sample, prepared according to the principles of the present disclosure;

FIG. 2 illustrates a plot of the antimicrobial efficacy of the control paint samples including the copper-coordinating additives and the copper-containing material at the molar ratios and concentrations in control paint samples indicated in FIG. 1;

FIG. 3 illustrates a plot of total color drift for a control paint sample and various copper-coordinating additives added to the control paint sample at various molar ratios of extractable copper, in the copper-containing material including from 10 to 70 weight % of an amount of extractable copper, to copper-coordinating additive, at a concentration of 50 grams of the mixture of the copper-coordinating additive and the copper-containing material per gallon of control paint sample, prepared according to the principles of the present disclosure;

FIG. 4 illustrates a plot of the antimicrobial efficacy of the control paint sample including the copper-coordinating additives and the copper-containing material at the molar ratios and concentrations in control paint samples indicated in FIG. 1;

FIG. 5 illustrates a plot of total color drift for a control paint sample commercially available from Nippon® (“Control N”) and various copper-coordinating additives added to the control paint sample at various molar ratios of extractable copper, in the copper-containing material including from 10 to 70 weight % of an amount of extractable copper, to the copper-coordinating additive, at a concentration of 50 grams of the mixture of the copper-coordinating additive and the copper-containing material per gallon of the control paint sample, prepared according to the principles of the present disclosure;

FIG. 6 illustrates a plot of the antimicrobial efficacy of the control paint samples including the copper-coordinating additives and the copper-containing material at the molar ratios and concentrations in control paint samples indicated in FIG. 5;

FIG. 7 illustrates a plot of total color drift for a control paint sample and various copper-coordinating additives added to the control paint sample at various molar ratios of extractable copper, in the copper-containing material including from 10 to 70 weight % of an amount of extractable copper, to the copper-coordinating additive, at a concentration of 50 grams of the mixture of the copper-coordinating additive and the copper-containing material per gallon of control paint sample, prepared according to the principles of the present disclosure;

FIG. 8 illustrates a plot of the antimicrobial efficacy of the control paint samples including the copper-coordinating additives and the copper-containing material at various molar ratios of extractable copper, in the copper-containing material including from 10 to 70 weight % of an amount of extractable copper, to the copper-coordinating additive, and a concentration of 15 grams of the mixture of the copper-coordinating additive and the copper-containing material per gallon of control paint sample prepared according to the principles of the present disclosure;

FIG. 9 illustrates a plot of a retesting of the antimicrobial efficacy of the control paint samples including the copper-coordinating additives and the copper-containing material at the molar ratios and concentrations in paint indicated in FIG. 8;

FIG. 10 illustrates a plot of total color drift for various copper-coordinating additives added to the control paint sample at a 1:3 molar ratio of extractable copper, in the copper-containing material including from 10 to 70 weight % of an amount of extractable copper, to the copper-coordinating additive, at a concentration of 50 grams of the mixture of the copper-coordinating additive and the copper-containing material per gallon of control paint sample, prepared according to the principles of the present disclosure;

FIG. 11 illustrates a plot of the antimicrobial efficacy of the control paint samples including the copper-coordinating additives indicated in FIG. 10 and the copper-containing material at a 1:3 molar ratio of extractable copper, in the copper-containing material including from 10 to 70 weight % of an amount of extractable copper, to the copper-coordinating additives, and a concentration of 15 grams of the mixture of the copper-coordinating additive and the copper-containing material per gallon of control paint sample prepared according to the principles of the present disclosure;

FIG. 12 illustrates a plot of the antimicrobial efficacy of the control paint samples including the copper-coordinating additives indicated in FIG. 10 and the copper-containing material at a 1:3 molar ratio of extractable copper, in the copper-containing material including from 10 to 70 weight % of an amount of extractable copper, to the copper-coordinating additives, and a concentration of 50 grams of the mixture of the copper-coordinating additive and the copper-containing material per gallon of control paint sample, prepared according to the principles of the present disclosure;

FIG. 13 illustrates a plot of total color drift for various copper-coordinating additives added to the control paint samples at a 1:3 molar ratio of extractable copper, in the copper-containing material including from 10 to 70 weight % of an amount of extractable copper, to the copper-coordinating additives, at a concentration of 50 grams of the mixture of the copper-coordinating additive and the copper-containing material per gallon of control paint sample, prepared according to the principles of the present disclosure;

FIG. 14 illustrates a plot of the antimicrobial efficacy of the control paint samples in the absence of hydrogen peroxide including the copper-coordinating additives indicated in FIG. 13 and the copper-containing material at a 1:3 molar ratio of extractable copper, in the copper-containing material including from 10 to 70 weight % of an amount of extractable copper, to the copper-coordinating additives, and a concentration of 50 grams of the of the mixture of the copper-coordinating additive and the copper-containing material per gallon of control paint sample, prepared according to the principles of the present disclosure;

FIG. 15 illustrates the drift in blue color resulting from an increase in the ratio of number of ligand compounds complexed to a copper atom in control paint samples, from a 0:1 ligand compound to copper atom ratio to a 4:1 ligand compound to copper atom ratio;

FIG. 16 illustrates the differences in color of colorless polymers and tinted polymers mixed with 3.6 weight % of a copper-containing material including from 10 to 70 weight % of an amount of extractable copper;

FIG. 17 illustrates the differences in color of poly(methyl methacrylate) (“PMMA”) in chloroform with various amounts of a copper-containing material including from 10 to 70 weight % of an amount of extractable copper and 2-ethylhexyl phosphate (“2EHP”);

FIG. 18 illustrates the differences in color of PMMA in toluene with a copper-containing material including from 10 to 70 weight % of an amount of extractable copper in the presence and absence of 2EHP; and

FIG. 19 illustrates the differences in color of PMMA in N-methylpyrrolidone (“NMP”) with a copper-containing material including from 10 to 70 weight % of an amount of extractable copper in the presence and absence of 2EHP.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Numerical values, including endpoints of ranges, may be expressed herein as approximations preceded by the term “about,” “approximately,” or the like. In such cases, other examples include the particular numerical values. Regardless of whether a numerical value is expressed as an approximation, two examples are included in this disclosure: one expressed as an approximation, and another not expressed as an approximation. It will be further understood that an endpoint of each range is significant both in relation to another endpoint, and independently of another endpoint.

As used herein, the term “antimicrobial” means a material, or a surface of a material, that will kill or inhibit the growth of microbes including, but not limited to, bacteria, viruses, mildew, mold, algae, and/or fungi. The term “antimicrobial,” as used herein, does not mean the material or the surface of the material will kill or inhibit the growth of all species of microbes within such families, but that the material or the surface of the material will kill or inhibit the growth of one or more species of microbes from such families.

As used herein, the term “biocidal” means a material with an active substance that is intended to destroy, deter, render harmless, prevent the action of, or otherwise exert a controlling effect on undesired organisms such as bacteria, viruses, mildew, mold, algae, and/or fungi.

As used herein, the term “logarithmic reduction” means the negative value of log (Cₐ/C₀), where Cₐ refers to the colony form unit (“CFU”) number of the antimicrobial surface and C₀ refers to the CFU of the control surface that is not an antimicrobial surface. As an example, a 3 logarithmic reduction equals about 99.9% of the microbes killed and a logarithmic reduction of 5 equals about 99.999% of microbes killed. The logarithmic reduction value may be measured according to the ASTM D2574-16 (2016) “Standard Test Method for Resistance of Emulsion Paints in the Container to Attack by Microorganisms.”

The uses of the terms “a” and “an” and “the” and similar references in the context of describing the present disclosure (especially in the context of the following claims) are to be construed to cover both the singular and the plural, unless otherwise indicated herein or clearly contradicted by context. Recitation of ranges of values herein are merely indicated to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

As used herein, the terms “comprise(s),” “include(s),” “having,” “has,” “can,” “contain(s),” and variants thereof, are intended to be open-ended transitional phrases, terms, or words that do not preclude the possibility of additional acts, structures, elements, or components. The present description also contemplates other examples “comprising,” “consisting of,” and “consisting essentially of,” the examples or elements presented herein, whether explicitly set forth or not.

As used herein, the term “about,” when used in the context of a numerical value or range set forth means a variation of ±15%, or less, of the numerical value. For example, a value differing by ±15%, ±14%, +10%, or ±5%, among others, would satisfy the definition of “about,” unless more narrowly defined in particular instances.

The term “alkyl,” by itself or as part of another substituent, means, unless otherwise stated, a straight, branched, or cyclic chain hydrocarbon (“cycloalkyl”) having the number of carbon atoms designated (i.e., “C₁-C₃₀” means one to thirty carbons). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl. Most preferred are —(C₁-C₁₈)alkyl. In certain examples of the present disclosure, a —(C₁-C₃₀)alkyl group, whether straight, branched, or cyclic, may not be a —C₁alkyl group, and/or may not be a —C₂alkyl group, and/or may not be a —C₃alkyl group, and/or may not be a —C₄alkyl group, and/or may not be a —C₅alkyl group, and/or may not be a —C₆alkyl group, and/or may not be a —C₇alkyl group, and/or may not be a —C₈alkyl group, and/or may not be a —C₉alkyl group, and/or may not be a —C₁₀alkyl group, and/or may not be a —C₁₁alkyl group, and/or may not be a —C₁₂alkyl group, and/or may not be a —C₁₃alkyl group, and/or may not be a —C₁₄alkyl group, and/or may not be a —C₁₅alkyl group, and/or may not be a —C₁₆alkyl group, and/or may not be a —C₁₇alkyl group, and/or may not be a —C₁₈alkyl group, and/or may not be a —C₁₉alkyl group, and/or may not be a —C₂₀alkyl group, and/or may not be a —C₂₁alkyl group, and/or may not be a —C₂₂alkyl group, and/or may not be a —C₂₃alkyl group, and/or may not be a —C₂₄alkyl group, and/or may not be a —C₂₅alkyl group, and/or may not be a —C₂₆alkyl group, and/or may not be a —C₂₇alkyl group, and/or may not be a —C₂₈alkyl group, and/or may not be a —C₂₉alkyl group, and/or may not be a —C₃₀alkyl group.

The term “alkylene,” by itself or as part of another substituent, means, unless otherwise stated, a straight, branched, or cyclic chain bivalent saturated aliphatic radical having the number of carbon atoms designated (i.e., “C₁-C₃₀” means one to thirty carbon atoms) such as methylene (“C₁alkylene,” or “—CH₂—”) or that may be derived from an alkene by opening of a double bond or from an alkane by removal of two hydrogen atoms from different carbon atoms. Examples include methylene, methylmethylene, ethylene, propylene, ethylmethylene, dimethylmethylene, methylethylene, butylene, cyclopropylmethylene, dimethylethylene, and propylmethylene. In certain examples of the present disclosure, a —(C₁-C₃₀)alkylene group, whether straight, branched, or cyclic, may not be a —C₁alkylene group, and/or may not be a -C₂alkylene group, and/or may not be a —C₃alkylene group, and/or may not be a —C₄alkylene group, and/or may not be a —C₅alkylene group, and/or may not be a —C₆alkylene group, and/or may not be a —C₇alkylene group, and/or may not be a —C₈alkylene group, and/or may not be a —C₉alkylene group, and/or may not be a —C₁₀alkylene group, and/or may not be a —C₁₁alkylene group, and/or may not be a —C₁₂alkylene group, and/or may not be a —C₁₃alkylene group, and/or may not be a —C₁₄alkylene group, and/or may not be a —C₁₅alkylene group, and/or may not be a —C₁₆alkylene group, and/or may not be a —C₁₇alkylene group, and/or may not be a —C₁₈alkylene group, and/or may not be a —C₁₉alkylene group, and/or may not be a —C₂₀alkylene group, and/or may not be a —C₂₁alkylene group, and/or may not be a —C₂₂alkylene group, and/or may not be a —C₂₃alkylene group, and/or may not be a —C₂₄alkylene group, and/or may not be a —C₂₅alkylene group, and/or may not be a —C₂₆alkylene group, and/or may not be a —C₂₇alkylene group, and/or may not be a —C₂₈alkylene group, and/or may not be a —C₂₉alkylene group, and/or may not be a —C₃₀alkylene group.

The term “alkenyl,” by itself or as part of another substituent, means, unless otherwise stated, a stable mono-unsaturated or di-unsaturated straight chain, branched chain, or cyclic hydrocarbon group, with a carbon-carbon double bond (—CH═CH—), and having the stated number of carbon atoms (i.e., “C₂-C₃₀” means two to thirty carbons). Examples include vinyl, propenyl, allyl, crotyl, isopentenyl, butadienyl, 1,3-pentadienyl, 1,4-pentadienyl, cyclopentenyl, cyclopentadienyl, and the higher homologs and isomers. Functional groups representing an alkene are exemplified by —CH═CH—CH₂— and CH₂═CH—CH₂—. In certain examples of the present disclosure, a —(C₂-C₃₀)alkenyl group, whether straight, branched, or cyclic, may not be a —C₂alkenyl group, and/or may not be a —C₃alkenyl group, and/or may not be a —C₄alkenyl group, and/or may not be a —C₅alkenyl group, and/or may not be a —C₆alkenyl group, and/or may not be a —C₇alkenyl group, and/or may not be a —C₆alkenyl group, and/or may not be a —C₉alkenyl group, and/or may not be a —C₁₀alkenyl group, and/or may not be a —C₁₁alkenyl group, and/or may not be a —C₁₂alkenyl group, and/or may not be a —C₁₃alkenyl group, and/or may not be a —C₁₄alkenyl group, and/or may not be a —C₁₅alkenyl group, and/or may not be a —C₁₅alkenyl group, and/or may not be a —C₁₇alkenyl group, and/or may not be a —C₁₈alkenyl group, and/or may not be a —C₁₉alkenyl group, and/or may not be a —C₂₀alkenyl group, and/or may not be a —C₂₁alkenyl group, and/or may not be a —C₂₂alkenyl group, and/or may not be a —C₂₃alkenyl group, and/or may not be a —C₂₄alkenyl group, and/or may not be a —C₂₅alkenyl group, and/or may not be a —C₂₆alkenyl group, and/or may not be a —C₂₇alkenyl group, and/or may not be a —C₂₈alkenyl group, and/or may not be a —C₂₉alkenyl group, and/or may not be a —C₃₀alkenyl group.

The term “alkenylene,” by itself or as part of another substituent, means, unless otherwise stated, a straight, branched, or cyclic chain bivalent unsaturated aliphatic radical containing a double bond having the number of carbon atoms designated (i.e., “C₂-C₃₀” means two to thirty carbons) and that may be derived from an alkyne by opening of a triple bond or from an alkene by removal of two hydrogen atoms from different carbon atoms. In certain examples of the present disclosure, a —(C₂-C₃₀)alkenylene group, whether straight, branched, or cyclic, may not be a —C₂alkenylene group, and/or may not be a —C₃alkenylene group, and/or may not be a —C₄alkenylene group, and/or may not be a —C₅alkenylene group, and/or may not be a —C₆alkenylene group, and/or may not be a —C₇alkenylene group, and/or may not be a —C₈alkenylene group, and/or may not be a —C₉alkenylene group, and/or may not be a —C₁₀alkenylene group, and/or may not be a —C₁₁alkenylene group, and/or may not be a —C₁₂alkenylene group, and/or may not be a —C₁₃alkenylene group, and/or may not be a —C₁₄alkenylene group, and/or may not be a —C₁₅alkenylene group, and/or may not be a —C₁₆alkenylene group, and/or may not be a —C₁₇alkenylene group, and/or may not be a —C₁₈alkenylene group, and/or may not be a —C₁₉alkenylene group, and/or may not be a —C₂₀alkenylene group, and/or may not be a —C₂₁alkenylene group, and/or may not be a —C₂₂alkenylene group, and/or may not be a —C₂₃alkenylene group, and/or may not be a —C₂₄alkenylene group, and/or may not be a —C₂₅alkenylene group, and/or may not be a —C₂₆alkenylene group, and/or may not be a —C₂₇alkenylene group, and/or may not be a —C₂₈alkenylene group, and/or may not be a —C₂₉alkenylene group, and/or may not be a —C₃₀alkenylene group.

The term “alkynyl,” by itself or as part of another substituent, means, unless otherwise stated, a stable carbon-carbon triple bond-containing radical (—C≡C—), branched chain, or cyclic hydrocarbon group having the stated number of carbon atoms (i.e., “C₂-C₃₀” means two to thirty carbons). Examples include ethynyl and propargyl. In certain examples of the present disclosure, a —(C₂-C₃₀)alkynyl group, whether straight, branched, or cyclic, may not be a —C₂alkynyl group, and/or may not be a —C₃alkynyl group, and/or may not be a —C₄alkynyl group, and/or may not be a —C₅alkynyl group, and/or may not be a —C₆alkynyl group, and/or may not be a —C₇alkynyl group, and/or may not be a —C₈alkynyl group, and/or may not be a —C₉alkynyl group, and/or may not be a —C₁₀alkynyl group, and/or may not be a —C₁₁alkynyl group, and/or may not be a —C₁₂alkynyl group, and/or may not be a —C₁₃alkynyl group, and/or may not be a —C₁₄alkynyl group, and/or may not be a —C₁₅alkynyl group, and/or may not be a —C₁₆alkynyl group, and/or may not be a —C₁₇alkynyl group, and/or may not be a —C₁₈alkynyl group, and/or may not be a —C₁₉alkynyl group, and/or may not be a —C₂₀alkynyl group, and/or may not be a —C₂₁alkynyl group, and/or may not be a —C₂₂alkynyl group, and/or may not be a —C₂₃alkynyl group, and/or may not be a —C₂₄alkynyl group, and/or may not be a —C₂₅alkynyl group, and/or may not be a —C₂₆alkynyl group, and/or may not be a —C₂₇alkynyl group, and/or may not be a —C₂₈alkynyl group, and/or may not be a —C₂₉alkynyl group, and/or may not be a —C₃₀alkynyl group.

The term “alkynylene,” by itself or as part of another substituent, means, unless otherwise stated, a straight, branched, or cyclic chain bivalent unsaturated aliphatic radical containing a triple bond having the number of carbon atoms designated (i.e., “C₂-C₃₀” means two to thirty carbon atoms) and that may be derived from an alkyne by removal of two hydrogen atoms from different carbon atoms. In certain examples of the present disclosure, a —(C₂-C₃₀)alkynylene group, whether straight, branched, or cyclic, may not be a —C₂alkynylene group, and/or may not be a —C₃alkynylene group, and/or may not be a —C₄alkynylene group, and/or may not be a —C₅alkynylene group, and/or may not be a —C₆alkynylene group, and/or may not be a —C₇alkynylene group, and/or may not be a —C₈alkynylene group, and/or may not be a —C₉alkynylene group, and/or may not be a —C₁₀alkynylene group, and/or may not be a —C₁₁alkynylene group, and/or may not be a —C₁₂alkynylene group, and/or may not be a —C₁₃alkynylene group, and/or may not be a —C₁₄alkynylene group, and/or may not be a —C₁₅alkynylene group, and/or may not be a —C₁₆alkynylene group, and/or may not be a —C₁₇alkynylene group, and/or may not be a —C₁₈alkynylene group, and/or may not be a —C₁₉alkynylene group, and/or may not be a —C₂₀alkynylene group, and/or may not be a —C₂₁alkynylene group, and/or may not be a —C₂₂alkynylene group, and/or may not be a —C₂₃alkynylene group, and/or may not be a —C₂₄alkynylene group, and/or may not be a —C₂₅alkynylene group, and/or may not be a —C₂₆alkynylene group, and/or may not be a —C₂₇alkynylene group, and/or may not be a —C₂₈alkynylene group, and/or may not be a —C₂₉alkynylene group, and/or may not be a —C₃₀alkynylene group.

The term “alkoxy,” by itself or as part of another substituent, means, unless otherwise stated, an alkyl group having the designated number of carbon atoms, as defined above, connected to the rest of the molecule via an oxygen atom, such as, for example, methoxy, ethoxy, 1-propoxy, 2-propoxy (“isopropoxy”), and the higher homologs and isomers. In certain examples of the present disclosure, a —(C₁-C₃₀)alkoxy group, whether straight, branched, or cyclic, may not be a —C₁alkoxy group, and/or may not be a —C₂alkoxy group, and/or may not be a —C₃alkoxy group, and/or may not be a —C₄alkoxy group, and/or may not be a —C₅alkoxy group, and/or may not be a —C₆alkoxy group, and/or may not be a —C₇alkoxy group, and/or may not be a —C₈alkoxy group, and/or may not be a —C₉alkoxy group, and/or may not be a —C₁₀alkoxy group, and/or may not be a —C₁₁alkoxy group, and/or may not be a —C₁₂alkoxy group, and/or may not be a —C₁₃alkoxy group, and/or may not be a —C₁₄alkoxy group, and/or may not be a —C₁₅alkoxy group, and/or may not be a —C₁₆alkoxy group, and/or may not be a —C₁₇alkoxy group, and/or may not be a —C₁₈alkoxy group, and/or may not be a —C₁₉alkoxy group, and/or may not be a —C₂₀alkoxy group, and/or may not be a —C₂₁alkoxy group, and/or may not be a —C₂₂alkoxy group, and/or may not be a —C₂₃alkoxy group, and/or may not be a —C₂₄alkoxy group, and/or may not be a —C₂₅alkoxy group, and/or may not be a —C₂₆alkoxy group, and/or may not be a —C₂₇alkoxy group, and/or may not be a —C₂₈alkoxy group, and/or may not be a —C₂₉alkoxy group, and/or may not be a —C₃₀alkoxy group.

The term “alkenyloxy,” by itself or as part of another substituent, means, unless otherwise stated, an alkenyl group having the designated number of carbon atoms, as defined above, connected to the rest of the molecule via an oxygen atom.

The term “alkynyloxy,” by itself or as part of another substituent, means, unless otherwise stated, an alkynyl group having the designated number of carbon atoms, as defined above, connected to the rest of the molecule via an oxygen atom.

The term “aromatic” generally refers to a carbocycle or heterocycle having one or more polyunsaturated rings having aromatic character (i.e., having (4n+2) delocalized π (pi) electrons where n is an integer).

The term “aryl,” by itself or in combination with another substituent, means, unless otherwise stated, a carbocyclic aromatic system containing one or more rings (typically one, two, or three rings) wherein such rings may be attached together in a pendant manner, such as a biphenyl, or may be fused, such as naphthalene. Examples may include phenyl, anthracyl, and naphthyl. Preferred are phenyl and naphthyl, most preferred is phenyl.

The term “aryloxy,” by itself or in combination with another substituent, means, unless otherwise stated, an aryl group connected to the rest of the molecule via an oxygen atom.

The term “arylene,” by itself or in combination with another substituent, means, unless otherwise stated, a bivalent radical produced by removal of two hydrogen atoms from two different carbon atoms of an aryl group.

The terms “heterocycle” or “heterocyclyl” or “heterocyclic,” by themselves or as part of other substituents, mean, unless otherwise stated, an unsubstituted or substituted, stable, mono- or multi-cyclic heterocyclic ring system that consists of carbon atoms and at least one heteroatom independently selected from the group consisting of N, O, and S, and wherein the nitrogen and sulfur heteroatoms may be optionally oxidized, and the nitrogen atom may be optionally quaternized. The heterocyclic system may be attached, unless otherwise stated, at any heteroatom or carbon atom that affords a stable structure.

The term “heterocyclyloxy,” by itself or in combination with another substituent, means, unless otherwise stated, a heterocyclyl group connected to the rest of the molecule via an oxygen atom.

The term “heterocyclylene,” by itself or in combination with another substituent, means, unless otherwise stated, a bivalent radical produced by removal of two hydrogen atoms from two different carbon atoms of a heterocyclyl group.

The terms “heteroaryl” or “heteroaromatic,” by themselves or as part of other substituents, mean, unless otherwise stated, a heterocyclic having aromatic character. A polycyclic heteroaryl may include fused rings. Examples include indole, 1H-indazole, 1H-pyrrolo[2,3-b]pyridine, and the like. A polycyclic heteroaryl may include one or more rings that are partially saturated. Examples include indoline, tetrahydroquinoline, and 2,3-dihydrobenzofuryl.

Non-limiting examples of heteroaryl groups include: pyridyl; pyrazinyl; pyrimidinyl, particularly 2- and 4-pyrimidinyl; pyridazinyl; thienyl; furyl; pyrrolyl, particularly 2-pyrrolyl; imidazolyl; thiazolyl; oxazolyl; pyrazolyl, particularly 3- and 5-pyrazolyl; isothiazolyl; 1,2,3-triazolyl; 1,2,4-triazolyl; 1,3,4-triazolyl; tetrazolyl; 1,2,3-thiadiazolyl; 1,2,3-oxadiazolyl; 1,3,4-thiadiazolyl; and 1,3,4-oxadiazolyl.

Polycyclic heterocycles include both aromatic and non-aromatic polycyclic heterocycles. Non-limiting examples of polycyclic heterocyclic include: indolyl, particularly 3-, 4-, 5-, 6-, and 7-indolyl; indolinyl; indazolyl, particularly 1H-indazol-5-yl; quinolyl; tetrahydroquinolyl; isoquinolyl, particularly 1- and 5-isoquinolyl; 1,2,3,4-tetrahydroisoquinolyl; cinnolyl; quinoxalinyl, particularly 2- and 5-quinoxalinyl; quinazolinyl; phthalazinyl; naphthyridinyl, particularly 1,5- and 1,8-naphthyridinyl; 1,4-benzodioxanyl; coumaryl; dihydrocoumaryl; benzofuryl, particularly 3-, 4-, 5-, 6-, and 7-benzofuryl; 2,3-dihydrobenzofuryl; 1,2-benzisoxazoyl; benzothienyl, particularly 3-, 4-, 5-, 6-, and 7-benzothienyl; benzoxazolyl; benzothiazolyl, particularly 2- and 5-benzothiazolyl; purinyl; benzimidazolyl, particularly 2-benzimidazolyl; benztriazolyl; thioxanthinyl; carbazolyl; carbolinyl; acridinyl; pyrrolizidinyl; pyrrolo[2,3-b]pyridinyl, particularly 1H-pyrrolo[2,3-b]pyridine-5-yl; and quinolizidinyl. Particularly preferred are 4-indolyl, 5-indolyl, 6-indolyl, 1H-indazol-5-yl, and 1H-pyrrolo[2,3-b]pyridin-5-yl.

The term “heteroaryloxy,” by itself or in combination with another substituent, means, unless otherwise stated, a heteroaryl group connected to the rest of the molecule via an oxygen atom.

The term “heteroarylene,” by itself or in combination with another substituent, means, unless otherwise stated, a bivalent radical produced by removal of two hydrogen atoms from two different carbon atoms of a heteroaryl group.

The term “aryl(C₁-C₄)alkyl” means a functional group wherein a one to four carbon alkylene chain is attached to an aryl group, e.g., —CH₂—CH₂-phenyl. Examples may include benzyl. The term “heteroaryl(C₁-C₄)alkyl” means a functional group wherein a one to four carbon alkylene chain is attached to a heteroaryl group, e.g., —CH₂—CH₂-pyridyl. The term “heterocyclyl(C₁-C₄)alkyl” means a functional group wherein a one to four carbon alkylene chain is attached to a heterocyclyl group, e.g., —CH₂—CH₂-aziridine. The terms “aryl(C₁-C₄)alkylene” or “(C₁-C₄)alkylarylene” mean a bivalent radical produced by removal of two hydrogen atoms from two different carbon atoms of an aryl(C₁-C₄)alkyl group, preferably wherein one of the two different carbon atoms is in the (C₁-C₄)alkyl group and the other of the two different carbon atoms is in the aryl group. The term “(C₁-C₄)alkylaryl(C₁-C₄)alkylene” means a bivalent radical produced by removal of two hydrogen atoms from two different carbon atoms of a (C₁-C₄)alkylaryl(C₁-C₄)alkyl group, wherein one of the two different carbon atoms is in one of the (C₁-C₄)alkyl groups and the other of the two different carbon atoms is in the other of the (C₁-C₄)alkyl groups, e.g., —CH₂-phenyl-CH₂—. The terms “heteroaryl(C₁-C₄)alkylene” or “(C₁-C₄)alkylheteroarylene” mean a bivalent radical produced by removal of two hydrogen atoms from two different carbon atoms of a heteroaryl(C₁-C₄)alkyl group, preferably wherein one of the two different carbon atoms is in the (C₁-C₄)alkyl group and the other of the two different carbon atoms is in the heteroaryl group. The term “(C₁-C₄)alkylheteroaryl(C₁-C₄)alkylene” means a bivalent radical produced by removal of two hydrogen atoms form two different carbon atoms of a (C₁-C₄)alkylheteroaryl(C₁-C₄)alkyl group, wherein one of the two different carbon atoms is in one of the (C₁-C₄)alkyl groups and the other of the two different carbon atoms is in the other of the (C₁-C₄)alkyl groups, e.g., —CH₂-pyridinyl-CH₂—. The terms “heterocyclyl(C₁-C₄)alkylene” or “(C₁-C₄)alkylheterocyclylene” mean a bivalent radical produced by removal of two hydrogen atoms from two different carbon atoms of a heterocyclyl(C₁-C₄)alkyl group, preferably wherein one of the two different carbon atoms is in the (C₁-C₄)alkyl group and the other of the two different carbon atoms is in the heterocyclyl group. The term “(C₁-C₄)alkylheterocyclyl(C₁-C₄)alkylene” means a bivalent radical produced by removal of two hydrogen atoms from two different carbon atoms of a (C₁-C₄)alkylheterocyclyl(C₁-C₄)alkyl group, wherein one of the two different carbon atoms is in one of the (C₁-C₄)alkyl groups and the other of the two different carbon atoms is in the other of the (C₁-C₄)alkyl groups, e.g., —CH₂-aziridinyl-CH₂—.

The term “crown ether” refers to a cyclic compound that consists of a ring containing several ether groups. The most common crown ethers are cyclic oligomers of ethylene oxide, the repeating unit being ethyleneoxy, i.e., —CH₂CH₂O—. Important members of this series of crown ethers are the tetramer (n=4), the pentamer (n=5), and the hexamer (n=6). A crown ether is named as, for example, “15-crown-5.” The first number in a crown ether's name refers to the number of atoms in the entire cycle, and the second number refers to the number of those atoms that are evenly spaced oxygen atoms. Examples of crown ethers may include 12-crown-4, 15-crown-5, 18-crown-6, and dibenzo-18-crown-6, which have the following structural formulae:

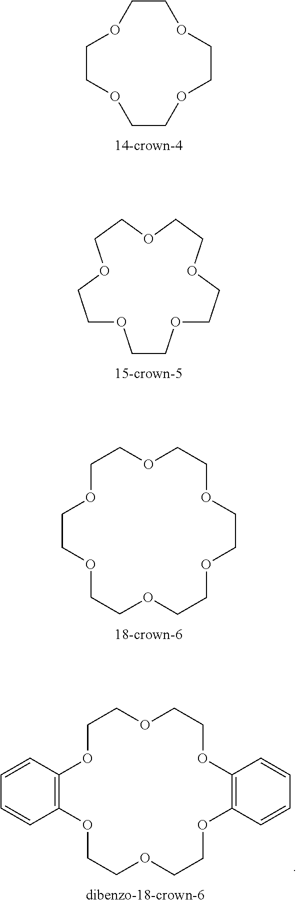 [SMILES: C1COCCOCCOCCO1 ; C1COCCOCCOCCOCCO1 ; C1COCCOCCOCCOCCOCCO1 ; c1ccc2c(c1)OCCOCCOc1ccccc1OCCOCCO2]

The term “aza-crown ether” refers to a nitrogen analog of a crown ether. The parent aza-crown ethers have the repeating unit —CH₂CH₂NH—. Examples of aza-crown ethers may include aza-15-crown-5 and aza-18-crown-6, which have the following structural formulae:

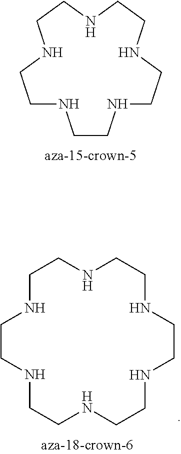

The term “salen ligand” refers to a class of tetradentate C₂-symmetric compounds which are structurally related to the classical salen ligand, primarily bis-Schiff bases, and synthesized from salicylaldehyde (i.e., “sal”) and ethylenediamine (i.e., “en”). Examples of a salen ligand may include salen, which has the structural formula:

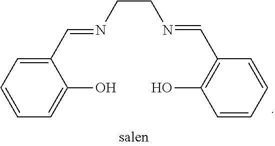 [SMILES: Oc1ccccc1/C=N/CC/N=C/c1ccccc1O]

As used herein, the term “durable” refers to the tendency of the atomic bonds of the durable phase of a copper-containing material to remain intact during and after interaction with a leachate. As used herein, the term “degradable” refers to the tendency of the atomic bonds of the degradable phase to break during and after interaction with one or more leachates.

As used herein, unless otherwise specified, the term “carrier” may refer to polymers, monomers, binders, solvents, or a combination thereof, as described herein. In a specific example, the carrier is a paint that is used for application to surfaces (which may include interior or exterior surfaces). The paint may be a dispersion of finely divided solids in a liquid medium (e.g., water, organic solvent, and/or inorganic solvent) that may be applied to a surface to form a film that adheres to the surface. Examples of solids used in paints may include pigments, fillers, extenders, driers, rheology modifiers, etc. In some examples, the paint may be a latex paint. Examples of solvent may include water and organic solvents.

As used herein, the term “secondary carbon” refers to a carbon atom of a compound or substituent group thereof that is covalently bonded to two other carbon atoms.

As used herein, the term “tertiary carbon” refers to a carbon atom of a compound or substituent group thereof that is covalently bonded to three other carbon atoms.

As used herein, the term “alpha (α) carbon” refers to a carbon atom in a compound that is covalently bonded to a functional group or to an atom other than a hydrogen or carbon atom.

As used herein, the term “beta (β) carbon” refers to a carbon atom in a carbon that is covalently bonded to an alpha carbon.

As used herein, the term “gamma (γ) carbon” refers to a carbon atom that is covalently bonded to a beta carbon but that is not an alpha carbon.

In an example, the present disclosure provides a biocidal composition, including a carrier, a copper-containing material, and a copper-coordinating additive. For example, the copper-containing material may include copper-containing glass, copper oxide, copper metal, copper salt (e.g., copper halide, copper acetate, or copper sulfate), or a combination thereof. In certain examples, the copper-containing material includes a plurality of copper-containing glass particles. In certain examples, a copper-coordinating additive is combined with a copper-containing material in a molar ratio of extractable copper in copper-containing material to copper-containing material of from 1:0.1 to 1:15. In other examples, the copper-coordinating additive is combined with the copper-containing material at a molar ratio of additive to copper-containing material and added to a carrier at a concentration of from 1 to 75 grams of copper-coordinating additive and the copper-containing material per gallon of carrier. In still other examples, the copper-containing material may be pre-treated with a pretreatment solution.

According to examples of the present disclosure, the biocidal composition may include a carrier, a copper-containing material that may have been pre-treated with a pretreatment solution, and a copper-coordinating additive. The biocidal composition may ultimately be a paint, a coating, an elastomeric coating, a caulk, a sealant, a floor polish, a fabric treatment, a stain, a clear coat, or a primer. The copper-containing material, which may be pretreated with a pretreatment solution, may be combined with a copper-coordinating additive and a carrier while stabilizing the color of the carrier when the copper-containing material is combined with the copper-coordinating additive and the carrier. Examples of the present disclosure may reduce changes in color of the carrier at the time of combining the copper-containing material with the copper-coordinating additive and the carrier and/or also reduce changes in the color of the carrier between a period of time after combining the copper-containing material with the copper-coordinating additive and the carrier and the final color of the carrier.

The effectiveness of a composition of the present disclosure as a biocidal composition may be measured as a function of the composition's logarithmic reduction. The composition's logarithmic reduction value may be relevant to its ability to kill a wide variety of biological organisms to which the composition is exposed, but may also allow the copper-containing material to act as a preservative for the composition during storage (e.g., in a container such as, but not limited to a tank, a can, a bucket, a drum, a bottle, or a tube). According to examples of the present disclosure, a logarithmic reduction of the biocidal composition may be at least about 2, at least about 3, at least about 4, at least about 5, at least about 6, at least about 7, at least about 8, at least about 9, at least about 10, in a range from about 1 to about 10, about 3 to about 7, about 4 to about 6, or less than, equal to, or greater than about 1, 2, 3, 4, 5, 6, 7, 8, 9, or about 10. The biocidal properties of the composition may make it effective for substantially killing a wide variety of biological organisms including bacteria, viruses, and fungi. Where the coating is configured to have biocidal properties with respect to bacteria, suitable examples of bacteria include Staphylococcus aureus, Enterobacter aerogenes, Pseudomonas aeruginosa, Methicillin Resistant Staphylococcus aureus, E. coli, and mixtures thereof. In some examples, the copper-containing material exhibits at least a 4 logarithmic reduction, a 5 logarithmic reduction, or even a 6 logarithmic reduction in the concentration of at least one of Staphylococcus aureus, Enterobacter aerogenes, Pseudomonas aeruginosa bacteria, Methicillin Resistant Staphylococcus aureus, and E. coli under the EPA test, or a 4 logarithmic reduction or greater (e.g., 5 logarithmic reduction or greater) under JIS Z 2801 (2000) testing conditions or under the Modified JIS Z 2801 Test for Bacteria. In one or more examples described herein, the copper-containing particles exhibit a 2 logarithmic reduction or greater, a 3 logarithmic reduction or greater, a 4 logarithmic reduction or greater, or a 5 logarithmic reduction or greater in Murine Novovirus under a Modified JIS Z 2801 for Viruses test. The procedure for the Modified JIS Z 2801 (2000) Test for Viruses is provided in International Patent Application Pub. No. 2021/055300 A1, COLOR STABILIZATION OF BIOCIDAL COATINGS, which is incorporated by reference herein in its entirety.

In some examples, the material may exhibit the logarithmic reductions described herein under one or more of the U.S. Environmental Protection Agency “Test Method of Efficacy of Copper Alloy as a Sanitizer” (2009) (also referred to herein as the “EPA Test”), the Modified Japanese Industrial Standard (JIS) Z 2801 Test for Bacteria and/or the Modified JIS Z2801 Test for Viruses, for a period of one month or greater or for a period of three months or greater. The one-month period or three-month period may commence at or after the application of the material to a surface as a layer. In such examples, the layer exhibits the logarithmic reductions described herein.

However, as described herein, it is possible to combine the copper-containing material with a copper-coordinating additive to limit the shift of the color of the biocidal composition from the color of a standard coating material (e.g., the material in the absence of the copper-containing material and the copper-coordinating additive). For example, it is possible to achieve a CIE L*a*b* ΔE* between the observed color and a standard of less than about 30, less than about 25, less than about 25, less than about 20, less than about 15, less than about 12, less than about 10, less than about 9, less than about 8, less than about 7, less than about 6, less than about 5, less than about 4, less than about 3, less than about 2, less than about 1, in a range of from about 1 to about 30, about 2 to about 25, about 5 to about 15, about 3 to about 8, about 4 to about 7, about 5 to about 6, less than, equal to, or greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30.

As understood, the CIE L*a*b* color space is a color scale for determining a color. The three coordinates (or dimensions/components) of CIE L*a*b* represent the lightness of the color (L*=0 indicates black and L*=100 indicates white), its position between red (sometimes referenced as magenta) and green (negative a* values indicate green while positive a* values indicate red) and its position between yellow and blue (negative b* values indicate blue and positive b* values indicate yellow). The L* component closely matches human perception of lightness. Related to the CIE L*a*b* color space, is the CIE L*C*h color space that is a cylindrical representation of the three perceptual color correlates: lightness, chroma, and hue. The axial component of CIE L*C*h is the same lightless attribute L* as CIE L*a*b*, the radial component is the chroma, and the angular component is hue. Using these color spaces, the difference, (e.g., a ΔE*) in color between a standard and observed color may be measured. In this manner, the extent to which the desired color of a coating is altered by the components therein may be measured.

The copper-containing glass particles may be a biocidal inorganic glass powder including copper particles. Although the individual particles of the copper-containing glass particles may be effective as a biocidal agent, a potential drawback may be that the copper offers numerous opportunities for ligands that are components of the carrier to bind thereto. Without wishing to be limited by theory, the copper-coordinating additives of the examples of the present disclosure may effectively compete with components of the carrier that may otherwise act as ligands to bind to copper so as to advantageously minimize color drift or accelerate reaching color endpoint.

The copper-containing glass particles may independently include a Cu metal, Cu¹⁺, Cu²⁺, or a combination of Cu¹⁺ of Cu²⁺. The combined total of the Cu species may be about 10 weight % or more of the copper-containing material. However, as will be discussed in more detail below, the amount of Cu²⁺ may be minimized or reduced such that the copper-containing glass particles may be substantially free of Cu²⁺. The copper may be non-complexed or may have a ligand bonded thereto to form a complex. The Cu¹⁺ ions may be present on or in the surface and/or the bulk of the copper-containing glass particles. The copper-containing glass particles may include copper-containing glass, copper (I) oxide, copper (I) halides, copper (I) carbonate, or a combination thereof. In some examples, the copper-containing glass particles may include only one of copper-containing glass, copper (I) oxide, copper (I) halides, or copper (I) carbonate. In some examples, the Cu¹⁺ ions may be present in a glass network and/or a glass matrix of the copper-containing glass particles. Where the Cu¹⁺ ions are present in the glass network, the Cu¹⁺ ions are atomically bonded to the atoms in the glass network. Where the Cu¹⁺ ions are present in the glass matrix, the Cu¹⁺ ions may be present in the form of Cu¹⁺ crystals that are dispersed in the glass matrix. In some examples, the Cu¹⁺ crystals include cuprite (Cu₂O). In some examples, where Cu¹⁺ crystals are present, the material may be referred to as a glass ceramic, which is intended to refer to a specific type of glass with crystals that may or may not be subjected to a traditional ceramming process by which one or more crystalline phases are introduced and/or generated in the glass. Where the Cu¹⁺ ions are present in a non-crystalline form, the material may be referred to as a copper-containing glass. In some examples, both Cu¹⁺ crystals and Cu¹⁺ ions not associated with a crystal are present in the copper-containing glasses described herein.

The copper-containing glasses may include a copper-containing oxide in an amount, in mole percent, in the range from about 10 to about 50, from about 10 to about 49, from about 10 to about 48, from about 10 to about 47, from about 10 to about 46, from about 10 to about 45, from about 10 to about 44, from about 10 to about 43, from about 10 to about 42, from about 10 to about 41, from about 10 to about 40, from about 10 to about 39, from about 10 to about 38, from about 10 to about 37, from about 10 to about 36, from about 10 to about 35, from about 10 to about 34, from about 10 to about 33, from about 10 to about 32, from about 10 to about 31, from about 10 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 11 to about 50, from about 12 to about 50, from about 13 to about 50, from about 14 to about 50, from about 15 to about 50, from about 16 to about 50, from about 17 to about 50, from about 18 to about 50, from about 19 to about 50, from about 20 to about 50, from about 10 to about 30, from about 11 to about 29, from about 12 to about 28, from about 13 to about 27, from about 14 to about 26, from about 15 to about 25, from about 16 to about 24, from about 17 to about 23, from about 18 to about 22, from about 19 to about 21, and all ranges and sub-ranges therebetween. According to examples of the present disclosure, the copper-containing oxide may be present in the copper-containing glasses in an amount of about 20 mole percent, about 25 mole percent, about 30 mole percent, or about 35 mole percent. The copper-containing oxide may include CuO, Cu₂O, and/or combinations thereof. The copper-containing glass particles may include cuprous oxide in an amount from 29.0 to 36.0 weight percent of the copper-containing glass particles. The copper-containing oxides in the copper-containing glasses form the Cu¹⁺ ions present in the resulting glass. Copper may be present in a glass composition and/or the glasses including a glass composition in various forms, including Cu⁰, Cu¹⁺, and Cu²⁺. Copper in the Cu⁰ or Cu¹⁺ forms provide antimicrobial activity. However, forming and maintaining these states of antimicrobial copper are difficult, and often, in known glass compositions, Cu²⁺ may be formed instead of the desired Cu⁰ or Cu¹⁺ ions.

The copper-containing glass portion of the individual particles of the copper-containing glass particles may be formed from a glass composition that may include, but is not limited to, in mole percent, SiO₂ in the range from about 30 to about 70, Al₂O₃ in the range form about 0 to about 20, a copper-containing oxide in the range from about 10 to about 50, CaO in the range from about 0 to about 15, MgO in the range from about 0 to about 15, P₂O₅ in the range from about 0 to about 25, B₂O₃ in the range from about 0 to about 25, K₂O in the range from about 0 to about 20, ZnO in the range from about 0 to about 5, Na₂O in the range from about 0 to about 20, and/or Fe₂O₃ in the range from about 0 to about 5, nanoparticles thereof, and/or a mixture thereof. In such examples, the amount of the copper-containing oxide is greater than the amount of Al₂O₃. In some examples, the glass composition may include a content of R₂O, where R may include K, Na, Li, Rb, Cs, and combinations thereof.

In some examples, the copper-containing glasses disclosed herein may be chemically strengthened via an ion exchange process in which the presence of a small amount of alkali oxide (such as Li₂O and Na₂O) is required to facilitate ion exchange with larger alkali ions (e.g., K¹⁺), for example exchanging smaller alkali ions from a copper-containing glass with larger alkali ions from a molten salt bath containing such larger alkali ions. Three types of ion exchange may generally be carried out. One such ion exchange includes a Na¹⁺-for-Li¹⁺ exchange, which results in a deep depth of layer but low compressive stress. Another such ion exchange includes a K¹⁺-for-Li¹⁺ exchange, which results in a small depth of layer but a relatively large compressive stress. A third such ion exchange includes a K¹⁺-for-Na¹⁺ exchange, which results in intermediate depth of layer and compressive stress. A sufficiently high concentration of the small alkali oxide in glass compositions may be necessary to produce a large compressive stress in the copper-containing glass including such glass compositions, because compressive stress is proportional to the number of alkali ions that are exchanged out of the copper-containing glass.

In one or more examples, the glass composition may include one or more divalent cation oxides, such as alkaline earth oxides and/or ZnO. Such divalent cation oxides may be included to improve the melting behavior of the glass compositions. With respect to ion exchange performance, the presence of divalent cations may act to decrease alkali mobility and thus, when larger divalent cation oxides are utilized, there may be a negative effect on ion exchange performance. Further, smaller divalent cation oxides generally help the compressive stress developed in an ion-exchanged glass more than the larger divalent cation oxides. Hence, divalent cation oxides such as MgO and ZnO may offer advantages with respect to improved stress relaxation, while minimizing the adverse effects on alkali diffusivity.

In one or more examples, the glass composition may include one or more colorants. Examples of such colorants may include NiO, TiO₂, Fe₂O₃, Cr₂O₃, Co₃O₄, and other known colorants. In some examples, the one or more colorants may be present in an amount in the range up to about 10 mol %. In some examples, the one or more colorants may be present in an amount in the range from about 0.01 mol % to about 10 mol %, from about 1 mol % to about 10 mol %, from about 2 to about 10 mol %, from about 5 mol % to about 10 mol %, from about 0.01 mol % to about 8 mol %, or from about 0.01 mol % to about 5 mol %.

The copper-containing glasses formed from the glass compositions may include a plurality of Cu¹⁺ ions. In some examples, such Cu¹⁺ ions form part of the glass network and may be characterized as a glass modifier. Without being bound by theory, where Cu¹⁺ ions are part of the glass network, it is believed that during typical glass formation processes, the cooling step of the molten glass occurs too rapidly to allow crystallization of the copper-containing oxide (e.g., Cu and/or Cu₂O). Thus, the Cu¹⁺ remains in an amorphous state and becomes part of the glass network. In some cases, the total amount of Cu¹⁺ ions, whether the Cu¹⁺ ions are in a crystalline phase or in the glass matrix, may be even higher, such as up to 40 mol %, up to 50 mol %, or up to 60 mol %.

In one or more examples, the copper-containing glasses formed from the glass compositions disclosed herein include Cu¹⁺ ions that are dispersed in the glass matrix as Cu¹⁺ crystals. In one or more examples, the Cu¹⁺ may be present in the form of cuprite. The cuprite present in the copper-containing glass may form a phase that is distinct form the glass matrix or glass phase. In other examples, the cuprite may form part of or may be associated with one or more glass phases (e.g., the durable phase described herein).

In some examples, the total amount of extractable copper by weight % in the copper-containing glass particles may be in the range from about 10 to about 100, from about 15 to about 100, from about 20 to about 100, from about 25 to about 100, from about 30 to about 100, from about 10 to about 95, from about 10 to about 90, from about 10 to about 85, from about 10 to about 80, from about 10 to about 75, from about 10 to about 70, from about 15 to about 70, from about 20 to about 70, from about 25 to about 70, from about 10 to about 65, from about 10 to about 60, from about 10 to about 55, from about 10 to about 50, from about 10 to about 45, from about 10 to about 40, from about 10 to about 35, from about 20 to about 50, from about 20 to about 45, from about 20 to about 40, from about 20 to about 35, from about 25 to about 35, from about 21 to about 40, from about 22 to about 40, from about 23 to about 40, from about 24 to about 40, from about 25 to about 40, from about 20 to about 39, from about 20 to about 38, from about 20 to about 37, from about 20 to about 36, from about 20 to about 35, from about 26 to about 34, from about 27 to about 33, from about 28 to about 32, from about 29 to about 31, and all ranges and sub-ranges therebetween; less than, equal to, or greater than about 5 weight %, 10, 15, 20, 25, 30, 35, 40, 45, 50, 55, 60, 65, 70, 75, or about 80 weight %. In one or more examples, the ratio of Cu¹⁺ ions to the total amount of extractable copper in the copper-containing glass particles is about 0.5 or greater, 0.55 or greater, 0.6 or greater, 0.65 or greater, 0.7 or greater, 0.75 or greater, 0.8 or greater, 0.85 or greater, 0.9 or greater, or even 1 or greater, and all ranges and sub-ranges therebetween.

According to some examples of the present disclosure, the copper-containing material and/or materials described herein leach the copper ions when exposed or in contact with a leachate. In one or more examples, the copper-containing material leach only copper ions when exposed to leachates, which may be a pretreatment solution according to the present disclosure, including water. The copper-containing material may include at least a first phase and a second phase. In one or more examples, the copper-containing material may include two or more phases wherein the phases differ based on the ability of the atomic bonds in the given phase to withstand interaction with a leachate. Specifically, the copper-containing material of one or more examples may include a first phase that may be described as a degradable phase and a second phase that may be described as a durable phase. In one or more examples, the durable phase includes SiO₂ and the degradable phase includes at least one of B₂O₃, P₂O₅, and R₂O (where R may include any one or more of K, Na, Li, Rb, and Cs). Without wishing to be bound by theory, it is believed that the components of the degradable phase (e.g., B₂O₃, P₂O₅, and/or R₂O) more readily interact with a leachate or a pretreatment solution and the bonds between these components to one another rand to other components in the copper-containing glass more readily break during and after the interaction with the leachate. Leachates may include water, acids or other similar materials. In one or more examples, the degradable phase withstands degradation for 1 week or longer, 1 month or longer, 3 months or longer, or even 6 months or longer. In some examples, longevity may be characterized as maintaining antimicrobial efficacy over a specific period of time. In one or more examples, either one or both of the durable phase and degradable phase may include cuprite. The cuprite in such examples may be dispersed in the respective phase or in both phases.

As discussed above, the copper-containing glass particles, which may have been pre-treated with a pretreatment solution, may be combined with a copper-coordinating additive. In an example, a copper-coordinating additive may be a compound of formula (I):

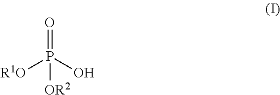

wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen.

Certain examples of compounds of formula (I) may include particular combinations of R¹ and R² such that the compounds of formula (I) complex with copper, but not as desirably or preferably as other particular combinations of R¹ and R² due to the combined effects of chemical phenomena understood by those skilled in the art, including, but not limited to, hydrophobicity, solubility, electronic effects, and/or steric effects resulting from the chemical structure of a particular compound of formula (I). In certain examples of compounds of formula (I), each of R¹ and R², independently, may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl.

Examples of compounds of formula (I) may include 2-ethylhexyl phosphate, bis(2-ethylhexyl)phosphate, methyl phosphate, dimethyl phosphate, phenyl phosphate, and diphenyl phosphate.

Without being bound by any particular theory, compounds of formula (I) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation. Further, compounds of formula (I) accelerate reaching color endpoint by enhancing the solubility of Cu¹⁺.

In another example, a copper-coordinating additive may be a compound of formula (II):

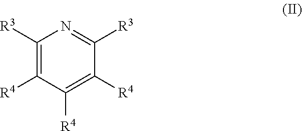

wherein each R³ is independently selected from the group consisting of hydrogen, (C₁-C₃₀)alkyl, (C₂-C₃₀)alkenyl, (C₂-C₃₀)alkynyl, aryl, heteroaryl, substituted or unsubstituted 2-pyridyl, heterocyclyl, aryl(C₁-C₄)alkyl, heteroaryl(C₁-C₄)alkyl, and heterocyclyl(C₁-C₄)alkyl;
the substituted 2-pyridyl is substituted with up to four substituents, each substituent independently selected from the group consisting of (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy; and
each R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

Certain examples of compounds of formula (II) may include particular combinations of R³ and R⁴ such that the compounds of formula (II) complex with copper, but not as desirably or preferably as other particular combinations of R³ and R⁴ due to the combined effects of chemical phenomena understood by those skilled in the art, including, but not limited to, hydrophobicity, solubility, electronic effects, and/or steric effects resulting from the chemical structure of a particular compound of formula (II). In certain examples of compounds of formula (II), each R³, independently, may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be unsubstituted 2-pyridyl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl. In certain examples of compounds of formula (II), each of up to four substituents of a substituted 2-pyridyl, independently, may not be (C₁-C₃₀)alkyl, and/or may not be (C₁-C₃₀)alkoxy, and/or may not be (C₂-C₃₀)alkenyl, and/or may not be (C₂-C₃₀)alkenoxy, and/or may not be (C₂-C₃₀)alkynyl, and/or may not be (C₂-C₃₀)alkynoxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy. In certain examples of compounds of formula (II), each R⁴, independently, may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl.

Examples of compounds of formula (II) may include 2,2′-bipyridine and terpyridine. 2,2′-Bipyridine has the structural formula:

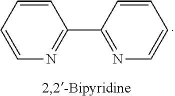 [SMILES: c1ccc(-c2ccccn2)nc1]

Terpyridine has the structural formula:

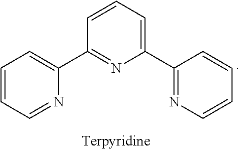 [SMILES: c1ccc(-c2cccc(-c3ccccn3)n2)nc1]

Without being bound by any particular theory, compounds of formula (II) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation.

In yet another example, a copper-coordinating additive may be a compound of formula (III):

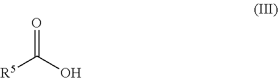

wherein R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, and —CO₂H.

Certain examples of compounds of formula (III) may complex with copper, but not as desirably or preferably as other examples of compounds of formula (III) due to the combined effects of chemical phenomena understood by those skilled in the art, including, but not limited to, hydrophobicity, solubility, electronic effects, and/or steric effects resulting from the chemical structure of a particular compound of formula (III). In certain examples of compounds of formula (III), R may not be unsubstituted (C₁-C₃₀)alkyl, and/or may not be unsubstituted (C₂-C₃₀)alkenyl, and/or may not be unsubstituted (C₂-C₃₀)alkynyl, and/or may not be unsubstituted aryl, and/or may not be unsubstituted heteroaryl, and/or may not be unsubstituted heterocyclyl, and/or may not be unsubstituted aryl(C₁-C₄)alkyl, and/or may not be unsubstituted heteroaryl(C₁-C₄)alkyl, and/or may not be unsubstituted heterocyclyl(C₁-C₄)alkyl. In certain examples of compounds of formula (III), R⁵ may not be substituted (C₁-C₃₀)alkyl, and/or may not be substituted (C₂-C₃₀)alkenyl, and/or may not be substituted (C₂-C₃₀)alkynyl, and/or may not be substituted aryl, and/or may not be substituted heteroaryl, and/or may not be substituted heterocyclyl, and/or may not be substituted aryl(C₁-C₄)alkyl, and/or may not be substituted heteroaryl(C₁-C₄)alkyl, and/or may not be substituted heterocyclyl(C₁-C₄)alkyl. In certain examples of compounds of formula (III), the one or more substituents, each, independently, may not be —OH, and/or may not be —NH₂, and/or may not be —SH, and/or may not be —CN, and/or may not be —C(O)NH₂, and/or may not be —CO₂H.

Examples of compounds of formula (III) may include citric acid, which has the structural formula:

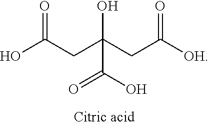 [SMILES: O=C(O)CC(O)(CC(=O)O)C(=O)O]

Without being bound by any particular theory, compounds of formula (III) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation. Further, compounds of formula (III) accelerate reaching color endpoint by enhancing the solubility of Cu¹⁺.

In yet another example, a copper-coordinating additive may be a compound of formula (IV):

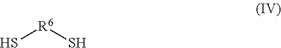

wherein, from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene;
the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkylene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
provided that the two thiol groups are not bonded to the same carbon.

Certain examples of compounds of formula (IV) may complex with copper, but not as desirably or preferably as other examples of compounds of formula (IV) due to the combined effects of chemical phenomena understood by those skilled in the art, including, but not limited to, hydrophobicity, solubility, electronic effects, and/or steric effects resulting from the chemical structure of a particular compound of formula (IV). In certain examples of compounds of formula (IV), R⁶ may not be (C₂-C₃₀)alkylene, and/or may not be (C₂-C₃₀)alkenylene, and/or may not be (C₂-C₃₀)alkynylene, and/or may not be aryl(C₁-C₄)alkylene, and/or may not be (C₁-C₄)alkylarylene, and/or may not be (C₁-C₄)alkylaryl(C₁-C₄)alkylene, and/or may not be heteroaryl(C₁-C₄)alkylene, and/or may not be (C₁-C₄)alkylheteroarylene, and/or may not be (C₁-C₄)alkylheteroaryl(C₁-C₄)alkylene, and/or may not be heterocyclyl(C₁-C₄)alkylene, and/or may not be (C₁-C₄)alkylheterocyclylene, and/or may not be (C₁-C₄)alkylheterocyclyl(C₁-C₄)alkylene. In certain examples of compounds of formula (IV), the one or more substituents, each, independently, may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy.

Without being bound by any particular theory, compounds of formula (IV) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation.

In yet another example, a copper-coordinating additive may be a compound of formula (V):

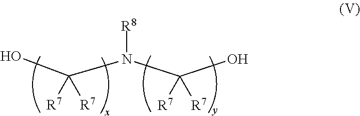

wherein each R⁷ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R⁸ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R⁷)₂)_{z}OH; and
each of x, y, and z is independently 2 or 3.

Certain examples of compounds of formula (V) may complex with copper, but not as desirably or preferably as other examples of compounds of formula (V) due to the combined effects of chemical phenomena understood by those skilled in the art, including, but not limited to, hydrophobicity, solubility, electronic effects, and/or steric effects resulting from the chemical structure of a particular compound of formula (V). In certain examples of compounds of formula (V), each R⁷, independently, may not be hydrogen, and/or may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy. In certain examples of compounds of formula (V), R⁸ may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl, and/or may not be —(C(R⁷)₂)_{z}OH. In certain examples of compounds of formula (V), each of x, y, and z, independently, may not be 2 or may not be 3.

Examples of compounds of formula (V) may include diethanolamine and triethanolamine. Diethanolamine has the structural formula:

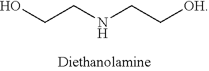

Triethanolamine has the structural formula:

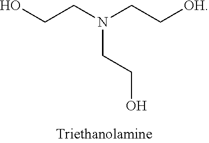

Without being bound by any particular theory, compounds of formula (V) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation.

In yet another example, a copper-coordinating additive may be a compound of formula (VI):

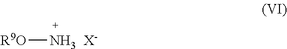

wherein X⁻ is selected from the group consisting of fluoride, chloride, bromide, iodide, hexafluorophosphate, sulfate, an alkylsulfonate, and an arylsulfonate; and
R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

Certain examples of compounds of formula (VI) may complex with copper, but not as desirably or preferably as other examples of compounds of formula (VI) due to the combined effects of chemical phenomena understood by those skilled in the art, including, but not limited to, hydrophobicity, solubility, electronic effects, and/or steric effects resulting from the chemical structure of a particular compound of formula (VI). In certain examples of compounds of formula (VI), X⁻ may not be fluoride, and/or may not be chloride, and/or may not be bromide, and/or may not be iodide, and/or may not be hexafluorophosphate, and/or may not be sulfate, and/or may not be an alkylsulfonate, and/or may not be an arylsulfonate. In certain examples of compounds of formula (VI), R⁹ may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl.

Without being bound by any particular theory, compounds of formula (VI) accelerate reaching color endpoint by enhancing the solubility of Cu¹⁺.

In yet another example, a copper-coordinating additive may be a compound of formula (VII):

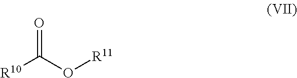

wherein each of R¹⁰ and R¹¹ is independently selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, —C(O)NHR¹¹, —C(O)NR¹¹₂, —CO₂H, and —CO₂R¹¹.

Certain examples of compounds of formula (VII) may complex with copper, but not as desirably or preferably as other examples of compounds of formula (VII) due to the combined effects of chemical phenomena understood by those skilled in the art, including, but not limited to, hydrophobicity, solubility, electronic effects, and/or steric effects resulting from the chemical structure of a particular compound of formula (VII). In certain examples of compounds of formula (VII), each R¹⁰ and R¹¹ independently may not be unsubstituted (C₁-C₃₀)alkyl, and/or may not be unsubstituted (C₂-C₃₀)alkenyl, and/or may not be unsubstituted (C₂-C₃₀)alkynyl, and/or may not be unsubstituted aryl, and/or may not be unsubstituted heteroaryl, and/or may not be unsubstituted heterocyclyl, and/or may not be unsubstituted aryl(C₁-C₄)alkyl, and/or may not be unsubstituted heteroaryl(C₁-C₄)alkyl, and/or may not be unsubstituted heterocyclyl(C₁-C₄)alkyl. In certain examples of compounds of formula (VII), each R¹⁰ and R¹¹ independently may not be substituted (C₁-C₃₀)alkyl, and/or may not be substituted (C₂-C₃₀)alkenyl, and/or may not be substituted (C₂-C₃₀)alkynyl, and/or may not be substituted aryl, and/or may not be substituted heteroaryl, and/or may not be substituted heterocyclyl, and/or may not be substituted aryl(C₁-C₄)alkyl, and/or may not be substituted heteroaryl(C₁-C₄)alkyl, and/or may not be substituted heterocyclyl(C₁-C₄)alkyl. In certain examples of compounds of formula (VII), the one or more substituents, each, independently, may not be —OH, and/or may not be —NH₂, and/or may not be —SH, and/or may not be —CN, and/or may not be —C(O)NH₂, and/or may not be —C(O)NHR¹¹, and/or may not be —C(O)NR¹², and/or may not be —CO₂H, and/or may not be —CO₂R¹¹.

Examples of compounds of formula (VII) may include triethyl citrate, which has the structural formula:

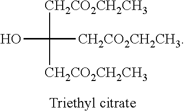

Without being bound by any particular theory, compounds of formula (VII) accelerate reaching color endpoint by enhancing the solubility of Cu¹⁺.

In yet another example, a copper-coordinating additive may be a compound of formula (VIII):

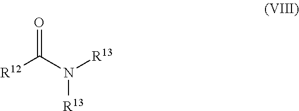

wherein R¹² is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
each R¹³ is independently selected from the group consisting of hydrogen, substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, —C(O)NHR¹³, —C(O)NR¹³₂, —CO₂H, and —CO₂R¹³.

Certain examples of compounds of formula (VIII) may include particular combinations of R¹² and R¹³ such that the compounds of formula (VIII) complex with copper, but not as desirably or preferably as other particular combinations of R¹² and R¹³ due to the combined effects of chemical phenomena understood by those skilled in the art, including, but not limited to, hydrophobicity, solubility, electronic effects, and/or steric effects resulting from the chemical structures of a particular compound of formula (VIII). In certain examples of compounds of formula (VIII), R¹² may not be substituted (C₁-C₃₀)alkyl, and/or may not be unsubstituted (C₁-C₃₀)alkyl, and/or may not be substituted (C₂-C₃₀)alkenyl, and/or may not be unsubstituted (C₂-C₃₀)alkenyl, and/or may not be substituted (C₂-C₃₀)alkynyl, and/or may not be unsubstituted (C₂-C₃₀)alkynyl, and/or may not be substituted aryl, and/or may not be unsubstituted aryl, and/or may not be substituted heteroaryl, and/or may not be unsubstituted heteroaryl, and/or may not be substituted heterocyclyl, and/or may not be unsubstituted heterocyclyl, and/or may not be substituted aryl(C₁-C₄)alkyl, and/or may not be unsubstituted aryl(C₁-C₄)alkyl, and/or may not be substituted heteroaryl(C₁-C₄)alkyl, and/or may not be unsubstituted heteroaryl(C₁-C₄)alkyl, and/or may not be substituted heterocyclyl(C₁-C₄)alkyl, and/or may not be unsubstituted heterocyclyl(C₁-C₄)alkyl. In certain examples of compounds of formula (VIII), each R¹³ independently may not be hydrogen, and/or may not be substituted (C₁-C₃₀)alkyl, and/or may not be unsubstituted (C₁-C₃₀)alkyl, and/or may not be substituted (C₂-C₃₀)alkenyl, and/or may not be unsubstituted (C₂-C₃₀)alkenyl, and/or may not be substituted (C₂-C₃₀)alkynyl, and/or may not be unsubstituted (C₂-C₃₀)alkynyl, and/or may not be substituted aryl, and/or may not be unsubstituted aryl, and/or may not be substituted heteroaryl, and/or may not be unsubstituted heteroaryl, and/or may not be substituted heterocyclyl, and/or may not be unsubstituted heterocyclyl, and/or may not be substituted aryl(C₁-C₄)alkyl, and/or may not be unsubstituted aryl(C₁-C₄)alkyl, and/or may not be substituted heteroaryl(C₁-C₄)alkyl, and/or may not be unsubstituted heteroaryl(C₁-C₄)alkyl, and/or may not be substituted heterocyclyl(C₁-C₄)alkyl, and/or may not be unsubstituted heterocyclyl(C₁-C₄)alkyl. In certain examples of compounds of formula (VIII), the one or more substituents, each, independently, may not be —OH, and/or may not be —NH₂, and/or may not be —SH, and/or may not be —CN, and/or may not be —C(O)NH₂, and/or may not be —C(O)NHR¹³, and/or may not be —C(O)NR¹³2, and/or may not be —CO₂H, and/or may not be —CO₂R¹³.

Without being bound by any particular theory, compounds of formula (VIII) accelerate color endpoint by extracting Cu¹⁺ from a copper-containing material as a pretreatment with a pretreatment solution.

In yet another example, a copper-coordinating additive may be a compound of formula (IX):

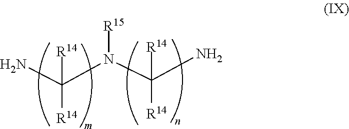

wherein each R¹⁴ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R¹⁵ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R¹⁴)₂)ₚNH₂; and
each of m, n, and p is independently 2 or 3.

Certain examples of compounds of formula (IX) may complex with copper, but not as desirably or preferably as other examples of compounds of formula (IX) due to the combined effects of chemical phenomena understood by those skilled in the art, including, but not limited to, hydrophobicity, solubility, electronic effects, and/or steric effects resulting from the chemical structure of a particular compound of formula (IX). In certain examples of compounds of formula (IX), each R¹⁴, independently, may not be hydrogen, and/or may not be (C₁-C₃₀)alkyl, and/or may not be (C₁-C₃₀)alkoxy, and/or may not be (C₂-C₃₀)alkenyl, and/or may not be (C₂-C₃₀)alkenyloxy, and/or may not be (C₂-C₃₀)alkynyl, and/or may not be (C₂-C₃₀)alkynyloxy, and/or may not be aryl, and/or may not be aryloxy, and/or may not be heteroaryl, and/or may not be heteroaryloxy, and/or may not be heterocyclyl, and/or may not be heterocyclyloxy, and/or may not be aryl(C₁-C₄)alkyl, and/or may not be aryl(C₁-C₄)alkoxy, and/or may not be heteroaryl(C₁-C₄)alkyl, and/or may not be heteroaryl(C₁-C₄)alkoxy, and/or may not be heterocyclyl(C₁-C₄)alkyl, and/or may not be heterocyclyl(C₁-C₄)alkoxy. In certain examples of compounds of formula (IX), R¹⁵ may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl, and/or may not be —(C(R¹⁵)₂)ₚNH₂. In certain examples of compounds of formula (IX), each of m, n, and p, independently, may not be 2 or may not be 3.

Without being bound by any particular theory, compounds of formula (IX) accelerate reaching color endpoint by enhancing the solubility of Cu¹⁺.

In yet another example, a copper-coordinating additive may be a compound of formula (X):

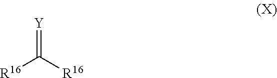

wherein Y is O or S;
each R¹⁶ is independently —OR¹⁷ or —N(R¹⁸)₂;
R¹⁷ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
each R¹⁸ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

Certain examples of compounds of formula (X) may complex with copper, but not as desirably or preferably as other examples of compounds of formula (X) due to the combined effects of chemical phenomena understood by those skilled in the art, including, but not limited to, hydrophobicity, solubility, electronic effects, and/or steric effects resulting from the chemical structure of a particular compound of formula (X). In certain examples of compounds of formula (X), Y may not be O or may not be S. In certain examples of compounds of formula (X), each R¹⁶ independently may not be —OR¹⁷ or may not be —N(R¹⁸)₂. In certain examples of compounds of formula (X), R¹⁷ may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl. In certain examples of compounds of formula (X), each R¹⁸, independently, may not be hydrogen, and/or may not be (C₁-C₃₀)alkyl, and/or may not be (C₂-C₃₀)alkenyl, and/or may not be (C₂-C₃₀)alkynyl, and/or may not be aryl, and/or may not be heteroaryl, and/or may not be heterocyclyl, and/or may not be aryl(C₁-C₄)alkyl, and/or may not be heteroaryl(C₁-C₄)alkyl, and/or may not be heterocyclyl(C₁-C₄)alkyl.

Without being bound by any particular theory, compounds of formula (X) accelerate reaching color endpoint by enhancing the solubility of Cu¹⁺.

In yet another example, a copper-coordinating additive may be a compound of formula (XI):

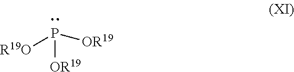

wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R¹⁹ are not simultaneously hydrogen.

Without being bound by any particular theory, compounds of formula (XI) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation. Without being bound by any particular theory, compounds of formula (XI) accelerate reaching color endpoint by enhancing the solubility of Cu¹⁺.

In yet another example, a copper-coordinating additive may be a compound of formula (XII):

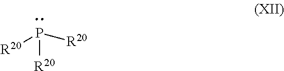

wherein each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

Without being bound by any particular theory, compounds of formula (XII) minimize color drift by reducing overall copper complex color and/or by favoring Cu¹⁺ tetrahedral geometry over Cu²⁺ octahedral geometry and/or by providing sterics and hydrophobicity to limit access of water to the copper ion and thereby inhibit oxidation. Without being bound by any particular theory, compounds of formula (XII) accelerate reaching color endpoint by enhancing the solubility of Cu¹⁺.

In yet another example, a copper-coordinating additive may be selected from the group consisting of a crown ether, an aza-crown ether, a salen ligand, and substituted derivatives thereof.

In some examples, the copper-containing material and copper-coordinating additive are present, combined, in an amount in the range of from about 0.01% weight/weight of the carrier to about 20% weight/weight of the carrier, including, but not limited to, from about 0.01% weight/weight of the carrier to about 19% weight/weight of the carrier, from about 0.01% weight/weight of the carrier to about 18% weight/weight of the carrier, from about 0.01% weight/weight of the carrier to about 17% weight/weight of the carrier, from about 0.01% weight/weight of the carrier to about 16% weight/weight of the carrier, from about 0.01% weight/weight of the carrier to about 15% weight/weight of the carrier, from about 0.01% weight/weight of the carrier to about 14% weight/weight of the carrier, from about 0.01% weight/weight of the carrier to about 13% weight/weight of the carrier, from about 0.01% weight/weight of the carrier to about 12% weight/weight of the carrier, from about 0.01% weight/weight of the carrier to about 11% weight/weight of the carrier, from about 0.01% weight/weight of the carrier to about 10% weight/weight of the carrier, from about 0.01% weight/weight of the carrier to about 9% weight/weight of the carrier, from about 0.01% weight/weight of the carrier to about 8% weight/weight of the carrier, from about 0.01% weight/weight of the carrier to about 7% weight/weight of the carrier, from about 0.01% weight/weight of the carrier to about 6% weight/weight of the carrier, from about 0.01% weight/weight of the carrier to about 5% weight/weight of the carrier, from about 0.01% weight/weight of the carrier to about 4.9% weight/of the carrier, from about 0.01% weight/weight of the carrier to about 4.8% weight/weight of the carrier, from about 0.01% weight/weight of the carrier to about 4.7% weight/weight of the carrier, from about 0.01% weight/weight of the carrier to about 4.6% weight/weight of the carrier, from about 0.01% weight/weight of the carrier to about 4.5% weight/weight of the carrier, from about 0.01% weight/weight of the carrier to about 4.4% weight/weight of the carrier, from about 0.01% weight/weight of the carrier to about 4.3% weight/weight of the carrier, from about 0.01% weight/weight of the carrier to about 4.2% weight/weight of the carrier, from about 0.01% weight/weight of the carrier to about 4.1% weight/weight of the carrier, from about 0.01% weight/weight of the carrier to about 4.0% weight/weight of the carrier, from about 0.01% weight/weight of the carrier to about 3.9% weight/weight of the carrier, from about 0.01% weight/weight of the carrier to about 3.8% weight/weight of the carrier, from about 0.01% weight/weight of the carrier to about 3.7% weight/weight of the carrier, from about 0.01% weight/weight of the carrier to about 3.6% weight/weight of the carrier, from about 0.01% weight/weight of the carrier to about 3.5% weight/weight of the carrier, from about 0.01% weight/weight of the carrier to about 3.4% weight/weight of the carrier, from about 0.01% weight/weight of the carrier to about 3.3% weight/weight of the carrier, from about 0.01% weight/weight of the carrier to about 3.2% weight/weight of the carrier, from about 0.01% weight/weight of the carrier to about 3.1% weight/weight of the carrier, from about 0.01% weight/weight of the carrier to about 3.0% weight/weight of the carrier, from about 0.01% weight/weight of the carrier to about 2.9% weight/weight of the carrier, from about 0.01% weight/weight of the carrier to about 2.8% weight/weight of the carrier, from about 0.01% weight/weight of the carrier to about 2.7% weight/weight of the carrier, from about 0.01% weight/weight of the carrier to about 2.6% weight/weight of the carrier, from about 0.01% weight/weight of the carrier to about 2.5% weight/weight of the carrier, from about 0.01% weight/weight of the carrier to about 2.4% weight/weight of the carrier, from about 0.01% weight/weight of the carrier to about 2.3% weight/weight of the carrier, from about 0.01% weight/weight of the carrier to about 2.2% weight/weight of the carrier, from about 0.01% weight/weight of the carrier to about 2.1% weight/weight of the carrier, from about 0.01% weight/weight of the carrier to about 2.0% weight/weight of the carrier, from about 0.01% weight/weight of the carrier to about 1.9% weight/weight of the carrier, from about 0.01% weight/weight of the carrier to about 1.8% weight/weight of the carrier, from about 0.01% weight/weight of the carrier to about 1.7% weight/weight of the carrier, from about 0.01% weight/weight of the carrier to about 1.6% weight/weight of the carrier, from about 0.01% weight/weight of the carrier to about 1.5% weight/weight of the carrier, from about 0.01% weight/weight of the carrier to about 1.4% weight/weight of the carrier, from about 0.01% weight/weight of the carrier to about 1.3% weight/weight of the carrier, from about 0.01% weight/weight of the carrier to about 1.2% weight/weight of the carrier, from about 0.01% weight/weight of the carrier to about 1.1% weight/weight of the carrier, from about 0.01% weight/weight of the carrier to about 1.0% weight/weight of the carrier, from about 0.01% weight/weight of the carrier to about 0.9% weight/weight of the carrier, from about 0.01% weight/weight of the carrier to about 0.8% weight/weight of the carrier, from about 0.01% weight/weight of the carrier to about 0.7% weight/weight of the carrier, from about 0.01% weight/weight of the carrier to about 0.6% weight/weight of the carrier, from about 0.01% weight/weight of the carrier to about 0.5% weight/weight of the carrier, from about 0.01% weight/weight of the carrier to about 0.4% weight/weight of the carrier, from about 0.01% weight/weight of the carrier to about 0.3% weight/weight of the carrier, from about 0.01% weight/weight of the carrier to about 0.2% weight/weight of the carrier, from about 0.01% weight/weight of the carrier to about 0.1% weight/weight of the carrier, from about 0.02% weight/weight of the carrier to about 5.0% weight/weight of the carrier, from about 0.03% weight/weight of the carrier to about 5.0% weight/weight of the carrier, from about 0.04% weight/weight of the carrier to about 5.0% weight/weight of the carrier, from about 0.05% weight/weight of the carrier to about 5.0% weight/weight of the carrier, from about 0.06% weight/weight of the carrier to about 5.0% weight/weight of the carrier, from about 0.07% weight/weight of the carrier to about 5.0% weight/weight of the carrier, from about 0.08% weight/weight of the carrier to about 5.0% weight/weight of the carrier, from about 0.09% weight/weight of the carrier to about 5.0% weight/weight of the carrier, from about 0.1% weight/weight of the carrier to about 5.0% weight/weight of the carrier, from about 0.2% weight/weight of the carrier to about 5.0% weight/weight of the carrier, from about 0.3% weight/weight of the carrier to about 5.0% weight/weight of the carrier, from about 0.4% weight/weight of the carrier to about 5.0% weight/weight of the carrier, from about 0.5% weight/weight of the carrier to about 5.0% weight/weight of the carrier, from about 0.6% weight/weight of the carrier to about 5.0% weight/weight of the carrier, from about 0.7% weight/weight of the carrier to about 5.0% weight/weight of the carrier, from about 0.8% weight/weight of the carrier to about 5.0% weight/weight of the carrier, from about 0.9% weight/weight of the carrier to about 5.0% weight/weight of the carrier, from about 1.0% weight/weight of the carrier to about 5.0% weight/weight of the carrier, from about 6% weight/weight of the carrier to about 20% weight/weight of the carrier, from about 7% weight/weight of the carrier to about 20% weight/weight of the carrier, from about 8% weight/weight of the carrier to about 20% weight/weight of the carrier, from about 9% weight/weight of the carrier to about 20% weight/weight of the carrier, from about 10% weight/weight of the carrier to about 20% weight/weight of the carrier, from about 11% weight/weight of the carrier to about 20% weight/weight of the carrier, from about 12% weight/weight of the carrier to about 20% weight/weight of the carrier, from about 13% weight/weight of the carrier to about 20% weight/weight of the carrier, from about 14% weight/weight of the carrier to about 20% weight/weight of the carrier, from about 15% weight/weight of the carrier to about 20% weight/weight of the carrier, from about 16% weight/weight of the carrier to about 20% weight/weight of the carrier, from about 17% weight/weight of the carrier to about 20% weight/weight of the carrier, from about 18% weight/weight of the carrier to about 20% weight/weight of the carrier, or from about 19% weight/weight of the carrier to about 20% weight/weight of the carrier.

In one or more examples, the copper-containing material and copper-coordinating additive are present, combined, in an amount of about 150 grams per gallon of carrier or less, about 125 g/gallon of carrier or less, about 75 g/gallon of carrier or less, or about 50 g/gallon of carrier or less.

In some examples, the copper-containing material and copper-coordinating additive are present, combined, in an amount in the range of from about 1 g/gallon of carrier to about 150 g/gallon of carrier, from about 1 g/gallon of carrier to about 125 g/gallon of carrier, from about 1 g/gallon of carrier to about 100 g/gallon of carrier, from about 1 g/gallon of carrier to about 75 g/gallon of carrier, from about 1 g/gallon of carrier to about 50 g/gallon of carrier, from about 1 g/gallon of carrier to about 40 g/gallon of carrier, from about 1 g/gallon of carrier to about 30 g/gallon of carrier, from about 1 g/gallon of carrier to about 20 g/gallon of carrier, from about 1 g/gallon of carrier to about 10 g/gallon of carrier, from about 2 g/gallon of carrier to about 150 g/gallon of carrier, from about 2 g/gallon of carrier to about 125 g/gallon of carrier, from about 2 g/gallon of carrier to about 100 g/gallon of carrier, from about 2 g/gallon of carrier to about 75 g/gallon of carrier, from about 2 g/gallon of carrier to about 50 g/gallon of carrier, from about 3 g/gallon of carrier to about 150 g/gallon of carrier, from about 3 g/gallon of carrier to about 125 g/gallon of carrier, from about 3 g/gallon of carrier to about 100 g/gallon of carrier, from about 3 g/gallon of carrier to about 75 g/gallon of carrier, from about 3 g/gallon of carrier to about 50 g/gallon of carrier, from about 4 g/gallon of carrier to about 150 g/gallon of carrier, from about 4 g/gallon of carrier to about 125 g/gallon of carrier, from about 4 g/gallon of carrier to about 100 g/gallon of carrier, from about 4 g/gallon of carrier to about 75 g/gallon of carrier, from about 4 g/gallon of carrier to about 50 g/gallon of carrier, from about 4 g/gallon of carrier to about 40 g/gallon of carrier, from about 4 g/gallon of carrier to about 30 g/gallon of carrier, from about 4 g/gallon of carrier to about 20 g/gallon of carrier, from about 4 g/gallon of carrier to about 10 g/gallon of carrier, from about 5 g/gallon of carrier to about 150 g/gallon of carrier, from about 5 g/gallon of carrier to about 125 g/gallon of carrier, from about 5 g/gallon of carrier to about 100 g/gallon of carrier, from about 5 g/gallon of carrier to about 75 g/gallon of carrier, from about 5 g/gallon of carrier to about 50 g/gallon of carrier, from about 10 g/gallon of carrier to about 150 g/gallon of carrier, from about 10 g/gallon of carrier to about 125 g/gallon of carrier, from about 10 g/gallon of carrier to about 100 g/gallon of carrier, from about 10 g/gallon of carrier to about 75 g/gallon of carrier, from about 10 g/gallon of carrier to about 50 g/gallon of carrier, from about 15 g/gallon of carrier to about 150 g/gallon of carrier, from about 15 g/gallon of carrier to about 125 g/gallon of carrier, from about 15 g/gallon of carrier to about 100 g/gallon of carrier, from about 15 g/gallon of carrier to about 75 g/gallon of carrier, from about 15 g/gallon of carrier to about 50 g/gallon of carrier, from about 20 g/gallon of carrier to about 150 g/gallon of carrier, from about 20 g/gallon of carrier to about 125 g/gallon of carrier, from about 20 g/gallon of carrier to about 100 g/gallon of carrier, from about 20 g/gallon of carrier to about 75 g/gallon of carrier, from about 20 g/gallon of carrier to about 50 g/gallon of carrier, from about 30 g/gallon of carrier to about 150 g/gallon of carrier, from about 30 g/gallon of carrier to about 125 g/gallon of carrier, from about 30 g/gallon of carrier to about 100 g/gallon of carrier, from about 30 g/gallon of carrier to about 75 g/gallon of carrier, from about 30 g/gallon of carrier to about 50 g/gallon of carrier, from about 50 g/gallon of carrier to about 150 g/gallon of carrier, from about 50 g/gallon of carrier to about 125 g/gallon of carrier, from about 50 g/gallon of carrier to about 100 g/gallon of carrier, from about 50 g/gallon of carrier to about 75 g/gallon of carrier, from about 6 g/gallon of carrier to about 75 g/gallon of carrier, from about 6 g/gallon of carrier to about 50 g/gallon of carrier, from about 7 g/gallon of carrier about 75 g/gallon of carrier, from about 7 g/gallon of carrier to about 50 g/gallon of carrier, from about 8 g/gallon of carrier to about 75 g/gallon of carrier, from about 8 g/gallon of carrier to about 50 g/gallon of carrier, from about 9 g/gallon of carrier to about 75 g/gallon of carrier, from about 9 g/gallon of carrier to about 50 g/gallon of carrier, from about 10 g/gallon of carrier to about 60 g/gallon of carrier, from about 10 g/gallon of carrier to about 40 g/gallon of carrier, from about 10 g/gallon of carrier to about 20 g/gallon of carrier, from about 20 g/gallon of carrier to about 40 g/gallon of carrier, from about 20 g/gallon of carrier to about 30 g/gallon of carrier, from about 35 g/gallon of carrier to about 50 g/gallon of carrier, or from about 40 g/gallon of carrier to about 50 g/gallon of carrier.

In some examples, the molar ratio of the extractable copper in the copper-containing material to the copper-coordinating additive may be from 1:1 to 1:50, from 1:1 to 1:49, from 1:1 to 1:48, from 1:1 to 1:47, from 1:1 to 1:46, from 1:1 to 1:45, from 1:1 to 1:44, from 1:1 to 1:43, from 1:1 to 1:42, from 1:1 to 1:41, from 1:1 to 1:40, from 1:1 to 1:39, from 1:1 to 1:38, from 1:1 to 1:37, from 1:1 to 1:36, from 1:1 to 1:35, from 1:1 to 1:34, from 1:1 to 1:33, from 1:1 to 1:32, from 1:1 to 1:31, from 1:1 to 1:30, from 1:1 to 1:29, from 1:1 to 1:28, from 1:1 to 1:27, from 1:1 to 1:26, from 1:1 to 1:25, from 1:1 to 1:24, from 1:1 to 1:23, from 1:1 to 1:22, from 1:1 to 1:21, from 1:1 to 1:20, from 1:1 to 1:19, from 1:1 to 1:18, from 1:1 to 1:17, from 1:1 to 1:16, from 1:1 to 1:15, from 1:1 to 1:14.9, from 1:1 to 1:14.8, from 1:1 to 1:14.7, from 1:1 to 1:14.6, from 1:1 to 1:14.5, from 1:1 to 1:14.4, from 1:1 to 1:14.3, from 1:1 to 1:14.2, from 1:1 to 1:14.1, from 1:1 to 1:14.0, from 1:1 to 1:13.9, from 1:1 to 1:13.8, from 1:1 to 1:13.7, from 1:1 to 1:13.6, from 1:1 to 1:13.5, from 1:1 to 1:13.4, from 1:1 to 1:13.3, from 1:1 to 1:13.2, from 1:1 to 1:13.1, from 1:1 to 1:13.0, from 1:1 to 1:12.9, from 1:1 to 1:12.8, from 1:1 to 1:12.7, from 1:1 to 1:12.6, from 1:1 to 1:12.5, from 1:1 to 1:12.4, from 1:1 to 1:12.3, from 1:1 to 1:12.2, from 1:1 to 1:12.1, from 1:1 to 1:12.0, from 1:1 to 1:11.9, from 1:1 to 1:11.8, from 1:1 to 1:11.7, from 1:1 to 1:11.6, from 1:1 to 1:11.5, from 1:1 to 1:11.4, from 1:1 to 1:11.3, from 1:1 to 1:11.2, from 1:1 to 1:11.1, from 1:1 to 1:11.0, from 1:1 to 1:10.9, from 1:1 to 1:10.8, from 1:1 to 1:10.7, from 1:1 to 1:10.6, from 1:1 to 1:10.5, from 1:1 to 1:10.4, from 1:1 to 1:10.3, from 1:1 to 1:10.2, from 1:1 to 1:10.1, from 1:1 to 1.10.0, from 1:1 to 1:9.9, from 1:1 to 1:9.8, from 1:1 to 1:9.7, from 1:1 to 1:9.6, from 1:1 to 1:9.5, from 1:1 to 1:9.4, from 1:1 to 1:9.3, from 1:1 to 1:9.2, from 1:1 to 1:9.1, from 1.1 to 1:9.0, from 1:1 to 1:8.9, from 1:1 to 1:8.8, from 1:1 to 1:8.7, from 1:1 to 1:8.6, from 1:1 to 1:8.5, from 1:1 to 1:8.4, from 1:1 to 1:8.3, from 1:1 to 1:8.2, from 1:1 to 1:8.1, from 1:1 to 1:8.0, from 1:1 to 1:7.9, from 1:1 to 1:7.8, from 1:1 to 1:7.7, from 1:1 to 1:7.6, from 1:1 to 1:7.5, from 1:1 to 1:7.4, from 1:1 to 1:7.3, from 1:1 to 1:7.2, from 1:1 to 1:7.1, from 1:1 to 1:7.0, from 1:1 to 1:6.9, from 1:1 to 1:6.8, from 1:1 to 1:6.7, from 1:1 to 1:6.6, from 1:1 to 1:6.5, from 1:1 to 1:6.4, from 1:1 to 1:6.3, from 1:1 to 1:6.2, from 1:1 to 1:6.1, from 1:1 to 1:6.0, from 1:1 to 1:5.9, from 1:1 to 1:5.8, from 1:1 to 1:5.7, from 1:1 to 1:5.6, from 1:1 to 1:5.5, from 1:1 to 1:5.4, from 1:1 to 1:5.3, from 1:1 to 1:5.2, from 1:1 to 1:5.1, from 1:1 to 1:5.0, from 1:1 to 1:4.9, from 1:1 to 1:4.8, from 1:1 to 1:4.7, from 1:1 to 1:4.6, from 1:1 to 1:4.5, from 1:1 to 1:4.4, from 1:1 to 1:4.3, from 1:1 to 1:4.2, from 1:1 to 1:4.1, from 1:1 to 1:4.0, from 1:1 to 1:3.9, from 1:1 to 1:3.8, from 1:1 to 1:3.7, from 1:1 to 1:3.6, from 1:1 to 1:3.5, from 1:1 to 1:3.4, from 1:1 to 1:3.3, from 1:1 to 1:3.2, from 1:1 to 1:3.1, from 1:1 to 1:3.0, from 1:1 to 1:2.9, from 1:1 to 1:2.8, from 1:1 to 1:2.7, from 1:1 to 1:2.6, from 1:1 to 1:2.5, from 1:1 to 1:2.4, from 1:1 to 1:2.3, from 1:1 to 1:2.2, from 1:1 to 1:2.1, from 1:1 to 1:2.0, from 1:1 to 1:1.9, from 1:1 to 1:1.8, from 1:1 to 1:1.7, from 1:1 to 1:1.6, from 1:1 to 1:1.5, from 1:1 to 1:1.4, from 1:1 to 1:1.3, from 1:1 to 1:1.2, from 1:1 to 1:1.1, from 1:1 to 1:0.9, from 1:1 to 1:0.8, from 1:1 to 1:0.7, from 1:1 to 1:0.6, from 1:1 to 1:0.5, from 1:1 to 1:0.4, from 1:1 to 1:0.3, from 1:1 to 1:0.2, from 1:1 to 1:0.1, from 50:1 to 1:1, from 49:1 to 1:1, from 48:1 to 1:1, from 47:1 to 1:1, from 46:1 to 1:1, from 45:1 to 1:1, from 44:1 to 1:1, from 43:1 to 1:1, from 42:1 to 1:1, from 41:1 to 1:1, from 40:1 to 1:1, from 39:1 to 1:1, from 38:1 to 1:1, from 37:1 to 1:1, from 36:1 to 1:1, from 35:1 to 1:1, from 34:1 to 1:1, from 33:1 to 1:1, from 32:1 to 1:1, from 31:1 to 1:1, from 30:1 to 1:1, from 29:1 to 1:1, from 28:1 to 1:1, from 27:1 to 1:1, from 26:1 to 1:1, from 25:1 to 1:1, from 24:1 to 1:1, from 23:1 to 1:1, from 22:1 to 1:1, from 21:1 to 1:1, from 20:1 to 1:1, from 19:1 to 1:1, from 18:1 to 1:1, from 17:1 to 1:1, from 16:1 to 1:1, from 15:1 to 1:1, from 14.9:1 to 1:1, from 14.8:1 to 1:1, from 14.7:1 to 1:1, from 14.6:1 to 1:1, from 14.5:1 to 1:1, from 14.4:1 to 1:1, from 14.3:1 to 1:1, from 14.2:1 to 1:1, from 14.1:1 to 1:1, from 14.0:1 to 1:1, from 13.9:1 to 1:1, from 13.8:1 to 1:1, from 13.7:1 to 1:1, from 13.6:1 to 1:1, from 13.5:1 to 1:1, from 13.4:1 to 1:1, from 13.3:1 to 1:1, from 13.2:1 to 1:1, from 13.1:1 to 1:1, from 13.0:1 to 1:1, from 12.9:1 to 1:1, from 12.8:1 to 1:1, from 12.7:1 to 1:1, from 12.6:1 to 1:1, from 12.5:1 to 1:1, from 12.4:1 to 1:1, from 12.3:1 to 1:1, from 12.2:1 to 1:1, from 12.1:1 to 1:1, from 12.0:1 to 1:1, from 11.9:1 to 1:1, from 11.8:1 to 1:1, from 11.7:1 to 1:1, from 11.6:1 to 1:1, from 11.5:1 to 1:1, from 11.4:1 to 1:1, from 11.3:1 to 1:1, from 11.2:1 to 1:1, from 11.1:1 to 1:1, from 11.0:1 to 1:1, from 10.9:1 to 1:1, from 10.8:1 to 1:1, from 10.7:1 to 1:1, from 10.6:1 to 1:1, from 10.5:1 to 1:1, from 10.4:1 to 1:1, from 10.3:1 to 1:1, from 10.2:1 to 1:1, from 10.1:1 to 1:1, from 10.0:1 to 1:1, from 9.9:1 to 1:1, from 9.8:1 to 1:1, from 9.7:1 to 1:1, from 9.6:1 to 1:1, from 9.5:1 to 1:1, from 9.4:1 to 1:1, from 9.3:1 to 1:1, from 9.2:1 to 1:1, from 9.1:1 to 1:1, from 9.0:1 to 1:1, from 8.9:1 to 1:1, from 8.8:1 to 1:1, from 8.7:1 to 1:1, from 8.6:1 to 1:1, from 8.5:1 to 1:1, from 8.4:1 to 1:1, from 8.3:1 to 1:1, from 8.2:1 to 1:1, from 8.1:1 to 1:1, from 8.0:1 to 1:1, from 7.9:1 to 1:1, from 7.8:1 to 1:1, from 7.7:1 to 1:1, from 7.6:1 to 1:1, from 7.5:1 to 1:1, from 7.4:1 to 1:1, from 7.3:1 to 1:1, from 7.2:1 to 1:1, from 7.1 to 1:1, from 7.0 to 1:1, from 6.9:1 to 1:1, from 6.8:1 to 1:1, from 6.7:1 to 1:1, from 6.6:1 to 1:1, from 6.5:1 to 1:1, from 6.4:1 to 1:1, from 6.3:1 to 1:1, from 6.2:1 to 1:1, from 6.1:1 to 1:1, from 6.0:1 to 1:1, from 5.9:1 to 1:1, from 5.8:1 to 1:1, from 5.7:1 to 1:1, from 5.6:1 to 1:1, from 5.5:1 to 1:1, from 5.4:1 to 1:1, from 5.3:1 to 1:1, from 5.2:1 to 1:1, from 5.1:1 to 1:1, from 5.0:1 to 1:1, from 4.9:1 to 1:1, from 4.8:1 to 1:1, from 4.7:1 to 1:1, from 4.6:1 to 1:1, from 4.5:1 to 1:1, from 4.4:1 to 1:1, from 4.3:1 to 1:1, from 4.2:1 to 1:1, from 4.1:1 to 1:1, from 4.0:1 to 1:1, from 3.9:1 to 1:1, from 3.8:1 to 1:1, from 3.7:1 to 1:1, from 3.6:1 to 1:1, from 3.5:1 to 1:1, from 3.4:1 to 1:1, from 3.3:1 to 1:1, from 3.2:1 to 1:1, from 3.1:1 to 1:1, from 3.0:1 to 1:1, from 2.9:1 to 1:1, from 2.8:1 to 1:1, to 2.7:1 to 1:1, from 2.6:1 to 1:1, from 2.5:1 to 1:1, from 2.4:1 to 1:1, from 2.3:1 to 1:1, from 2.2:1 to 1:1, from 2.1:1 to 1:1, from 2.0:1 to 1:1, from 1.9:1 to 1:1, from 1.8:1 to 1:1, from 1.7:1 to 1:1, from 1.6:1 to 1:1, from 1.5:1 to 1:1, from 1.4:1 to 1:1, from 1.3:1 to 1:1, from 1.2:1 to 1:1, from 1.1:1 to 1:1, from 0.9:1 to 1:1, from 0.8:1 to 1:1, from 0.7:1 to 1:1, from 0.6:1 to 1:1, from 0.5:1 to 1:1, from 0.4:1 to 1:1, from 0.3:1 to 1:1, from 0.2:1 to 1:1, or from 0.1:1 to 1:1.

Upon combination of the copper-containing material and the copper-coordinating additive with a carrier, as described herein, the composition or resulting material may be formed into a desired article or be applied to a surface. Where the composition includes paint, the paint may be applied to a surface as a layer. Examples of such articles that may be formed using the composition described herein include housings for electronic devices (e.g., mobile phones, smart phones, tablets, video players, information terminal devices, laptop computers, etc.), architectural structures (e.g., countertops, walls, trim, ceilings, floors, exterior facades, and trim), appliances (e.g., cooktops, refrigerator and dishwasher doors, etc.), information displays (e.g., whiteboards), and automotive components (e.g., dashboard panels, windshields, window components, etc.).

The compositions described herein may include pigments to impart color. Accordingly, the coatings or layers made from such compositions may exhibit a wide variety of colors, depending on the carrier color, mixture of carriers, and amount of particle loading. Moreover, the compositions and/or coatings described herein showed no adverse effect to paint adhesion as measured by ASTM D4541. In some instances, the adhesion of the composition or coating to an underlying substrate was greater than the cohesive strength of the substrate. In other words, in testing, the adhesion between the coating and the substrate was so strong that the underlying substrate failed before the coating was separated from the surface of the substrate.

One or more examples of the compositions may include the copper-containing material, which may be pre-treated with a pretreatment solution, a copper-coordinating additive, and a carrier with a loading level of the copper-containing material such that the material exhibits resistance or preservation against the presence or growth of foulants. Foulants include fungi, bacteria, viruses, mold, mildew, algae, and combinations thereof. In some instances, the presence of foulants in materials, such as paints, varnishes, and the like may cause color changes to the composition, may degrade the integrity of the composition, and may negatively affect various properties of the composition. By including a minimum loading of copper-containing material (e.g., about 5 weight % or less, about 4 weight % or less, about 3 weight % or less, about 2 weight percent or less, or about 1 weight % or less) and copper-coordinating additive to the carrier, the foulants may be eliminated or reduced. In some instances, the compositions need not include certain components, when fouling is eliminated or reduced. Thus, the formulations used in one or more examples of the compositions described herein may have more flexibility and variations than previously possible, when used in known compositions that do not include the copper-containing material.

According to examples of the present disclosure, the biocidal composition may include a carrier, a copper-coordinating additive, and a copper-containing material that has been pre-treated with a pretreatment solution prior to combining the copper-containing material with the copper-coordinating additive and the carrier. A copper-containing material that has been pretreated with a pretreatment solution may be referred to as “treated copper-containing material.” The treated copper-containing material may be present in the pretreatment solution (e.g., dissolved and/or suspended therein), which may then be combined with the copper-coordinating additive and the carrier, optionally without an intermediate step to separate the treated copper-containing material from the pretreatment solution.

In some examples, the pretreatment solution may contain an ammonia-based material, examples of which may include ammonia and ammonium buffers. For example, the pretreatment solution may include ammonium chloride and/or ammonium phosphate. The ammonium buffers may be made using any suitable material or combination of materials to provide an ammonium buffer having the desired pH, examples of which include ammonium phosphate monobasic, ammonium phosphate dibasic, monoammonium phosphate (NH₄H₂PO₄), ammonium carbonate, and ammonium hydroxide.

In some examples, the pretreatment solution may contain an ammonia-based and/or amine-based solution having a pH of from 8 to about 12, from about 8 to about 11, from about 8 to about 10, from about 8 to about 9, from about 9 to about 12, from about 9 to about 11, from about 9 to about 10, from about 10 to about 12.

In some examples, the pretreatment solution may contain a group (I) hydroxide and/or a group (II) hydroxide. In some examples, the pretreatment solution may contain a hard base, examples of which include potassium hydroxide and sodium hydroxide. The group (I) hydroxide, group (II) hydroxides, and/or hard base may be used alone or in combination with other materials to provide a pretreatment solution adapted to react with copper when used to treat the copper-containing material. In some examples, the group (I) hydroxides, group (II) hydroxides, and/or hard base are used to form a pre-treatment solution having a pH of at least 9.

In some examples, the pretreatment solution may be an alkaline buffer containing one or more components that provide a desired pH and/or a desired chemical group (e.g., an amine-based or ammonium-based group). Examples of suitable alkaline buffers include phosphate buffers, borate buffers, ammonium buffers, carbonate buffers, and combinations thereof. For example, the alkaline buffer may include ammonium phosphate monobasic, potassium phosphate monobasic, ammonium phosphate dibasic, monoammonium phosphate (NH₄H₂PO₄), ammonium carbonate, ammonium hydroxide, boric acid, sodium borate, potassium chloride, sodium hydroxide, dihydrogen potassium phosphate, sodium phosphate dibasic, sodium phosphate monobasic, sodium phosphate tribasic, potassium phosphate tribasic, phosphoric acid, potassium phosphate dibasic, potassium phosphate monobasic, sodium carbonate, ammonium carbonate, potassium bicarbonate, sodium bicarbonate, and ammonium bicarbonate. In one example, the alkaline buffer may contain dihydrogen potassium phosphate and sodium phosphate dibasic. In another example, the alkaline buffer may contain potassium phosphate monobasic and sodium hydroxide. In yet another example, the alkaline buffer may contain boric acid, potassium chloride, and sodium hydroxide. In yet another example, the alkaline buffer may contain ammonium chloride, ammonium phosphate monobasic, and potassium phosphate monobasic. In some examples, the alkaline buffer has a pH of at least 9. For example, the alkaline buffer may have a pH of at least 9, at least 9.5, at least 10, at least 10.5, or at least 11. In some examples, the alkaline buffer may have a pH of from about 9 to about 12, from about 9.5 to about 12, from about 10 to about 12, from about 10.5 to about 12, from about 11 to about 12, from about 9 to about 11.5, from about 9.5 to about 11.5, from about 10 to about 11.5, from about 10.5 to about 11.5, from about 11 to about 11.5, from about 9 to about 11, from about 9.5 to about 11, from about 10 to about 11, from about 10.5 to about 11, from about 9 to about 10.5, from about 9.5 to about 10.5, from about 10 to about 10.5, from about 9 to about 10, or from about 9.5 to about 10.

The pretreatment solution may have a pH of between about 7 and about 12. For example, the pretreatment solution may have a pH of between about 8 and about 12, or between about 8.5 and about 10.5. In some examples, the pretreatment solution may have a pH of from about 7 to about 12, from about 7 to about 11.5, from about 7 to about 11, from about 7 to about 10.5, from about 7 to about 10, from about 7 to about 9.5, from about 7 to about 9, from about 7 to about 8, from about 7.5 to about 12, from about 7.5 to about 11.5, from about 7.5 to about 11, from about 7.5 to about 10.5, from about 7.5 to about 10, from about 7.5 to about 9.5, from about 7.5 to about 9, from about 7.5 to about 8, from about 8 to about 12, from about 8 to about 11.5, from about 8 to about 11, from about 8 to about 10.5, from about 8 to about 10, from about 8 to about 9.5, from about 8 to about 9, from about 8.5 to about 12, from about 8.5 to about 11.5, from about 8.5 to about 11, from about 8.5 to about 10.5, from about 8.5 to about 10, from about 8.5 to about 9.5, from about 8.5 to about 9, from about 9 to about 12, from about 9 to about 11.5, from about 9 to about 11, from about 9 to about 10.5, from about 9 to about 10, from about 9 to about 9.5, from about 9.5 to about 12, from about 9.5 to about 11.5, from about 9.5 to about 11, from about 9.5 to about 10.5, from about 9.5 to about 10, from about 10 to about 12, from about 10 to about 11.5, or from about 10 to about 11.

In some examples, an amount and/or a pH of the pretreatment solution may be selected such that a pH of the combined mixture of the carrier and the copper-coordinating additive and the treated copper-containing material (e.g., the copper-containing material that has been already been treated with the pretreatment solution) is within a predetermined range of an initial pH of the carrier (e.g., the pH of the carrier prior to combining with the treated copper-containing material). For example, in some examples, an amount and/or a pH of the pretreatment solution used to treat the copper-containing material may be selected such that the pH of the mixture of the carrier and the copper-coordinating additive and the treated copper-containing material is within ±1 units of the initial pH of the carrier. In some examples, an amount and/or a pH of the pretreatment solution used to treat the copper-containing material may be selected such that the pH of the mixture of the carrier and the copper-coordinating additive and the treated copper-containing material is within ±0.5, or even ±0.3 units of the initial pH of the carrier. Without wishing to be limited by any theory, it is believed that in some applications, the addition of a solution or a suspension of treated copper-containing material that significantly affects the total volume and/or pH of the carrier may result in an undesirable change in one or more characteristics of the carrier. For example, when the carrier is a paint, large changes in volume and/or pH following the addition of the treated copper-containing material may undesirably affect other components of the paint or properties of the paint, such as the color or dispersion of one or more materials in the paint (e.g., pigment dispersion).

The copper-containing material may be treated in the pretreatment solution for any amount of time, for example, between about 5 minutes and about 24 hours, or between about 1 hour and about 12 hours, and all ranges and sub-ranges therebetween. In some examples, the copper-containing material may be pretreated in the pretreatment solution for greater than 5 minutes, greater than 10 minutes, greater than 1 hour, greater than 2 hours, greater than 5 hours, greater than 10 hours, greater than 15 hours, greater than 20 hours, greater than 24 hours, or greater than 48 hours. For example, the copper-containing material may be pretreated in the pretreatment solution for from about 5 minutes to about 72 hours, from about 5 minutes to about 48 hours, from about 5 minutes to about 36 hours, from about 5 minutes to about 24 hours, from about 5 minutes to about 20 hours, from about 5 minutes to about 10 hours, from about 5 minutes to about 5 hours, from about 5 minutes to about 2 hours, from about 10 minutes to about 72 hours, from about 10 minutes to about 48 hours, from about 10 minutes to about 36 hours, from about 10 minutes to about 24 hours, from about 10 minutes to about 20 hours, from about 10 minutes to about 10 hours, from about 10 minutes to about 5 hours, from about 10 minutes to about 2 hours, from about 60 minutes to about 72 hours, from about 60 minutes to about 48 hours, from about 60 minutes to about 36 hours, from about 60 minutes to about 24 hours, from about 60 minutes to about 20 hours, from about 60 minutes to about 10 hours, from about 60 minutes to about 5 hours, from about 60 minutes to about 2 hours, from about 2 hours to about 72 hours, from about 2 hours to about 48 hours, from about 2 hours to about 36 hours, from about 2 hours to about 24 hours, from about 2 hours to about 20 hours, from about 2 hours to about 10 hours, from about 2 hours to about 5 hours, from about 5 hours to about 72 hours, from about 5 hours to about 48 hours, from about 5 hours to about 36 hours, from about 5 hours to about 24 hours, from about 5 hours to about 20 hours, from about 5 hours to about 10 hours, from about 10 hours to about 72 hours, from about 10 hours to about 48 hours, from about 10 hours to about 36 hours, from about 10 hours to about 24 hours, from about 10 hours to about 20 hours, from about 20 hours to about 72 hours, from about 20 hours to about 48 hours, from about 20 hours to about 36 hours, from about 20 hours to about 24 hours, from about 24 hours to about 72 hours, or from about 24 hours to about 48 hours. In some examples, the copper-containing material may be treated in the pretreatment solution for a predetermined period of time and then immediately combined with the carrier and the copper-coordinating additive. In other examples, the copper-containing material may be treated in the pretreatment solution for a minimum period of time and immediately combined with the carrier and copper-coordinating additive and/or stored for a period of time before combining with the carrier and copper-coordinating additive. In some examples, the mixture of the treated copper-containing material and the pretreatment solution may be combined directly with the carrier and the copper-coordinating additive without an intermediate step to separate the treated copper-containing material from the pretreatment solution. In some examples, following the pretreatment period, the mixture of the treated copper-containing material and the pretreatment solution may be combined with one or more additional materials (e.g., a solvent or additional buffer) prior to combining the mixture with the carrier and the copper-coordinating additive.

Without wishing to be bound by any particular theory, it is believed that as portions of the copper-containing material dissolve during or after being combined with a carrier and the copper-coordinating additive, more of the compositional components of the copper-containing material are released and become available to interact with the components of the carrier and the copper-coordinating additive. Some of these dissolved components, such as copper ions, may cause changes in a color of the carrier at the time of combining the treated copper-containing material and the copper-coordinating additive and the carrier and/or for a predetermined period of time after combining the treated copper-containing material, the copper-coordinating additive, and the carrier.

Without wishing to be limited by any theory, it is believed that treated copper-containing material that have been pre-treated with a pretreatment solution as described herein may provide complexing or precipitating agents that, when combined with a carrier and a copper-coordinating additive, may reduce or eliminate the formation of copper-based complexes that would otherwise cause changes to the color of the carrier or may produce a color that does not change substantially. As one example, when a copper-containing material is pretreated with monoammonium phosphate, a copper-based complex of Cu(H₂PO₄)₂ and/or Cu(H₂PO₄)⁻² may be formed, which stabilizes the copper ions released from the copper-containing material and may prevent formation of other copper-based complexes that would otherwise cause changes to the color of the carrier. It is also believed that a copper-containing material, when combined with a carrier and a copper-coordinating additive, may reduce or eliminate the formation of copper-based complexes that would otherwise cause changes to the color of the carrier or may produce a color that does not change substantially.

In some examples, the formation of a colored solution and/or a precipitate when the copper-containing material or the treated copper-containing material is combined with the copper-coordinating additive may be indicative of an ability of the copper-containing material and the copper-coordinating additive to stabilize the color of the carrier compared to the copper-containing material absent the copper-coordinating additive. Stabilizing the color of the carrier may include decreasing a shift in color of the carrier after mixing and/or decreasing a drift in a color of the carrier over time after mixing and/or increasing a rate of color change such that the color of the mixture stabilizes more quickly (which may involve a large initial change in color). For example, in paint applications, when copper is added to the paint, the copper may affect the color of the paint when initially mixed and/or may affect the color of the paint over time as it is stored and/or after use. In some examples, the copper-containing material combined with the copper-coordinating additive results in a decrease in the color change of the mixture, an initial color change and/or over time, compared to a copper-containing material absent the copper-coordinating additive. In some examples, pretreating the copper-containing material with a pretreatment solution before combining with the copper-coordinating additive and a paint may accelerate the color change of the paint. Accelerating the color change of the paint during the manufacturing process sf the paint may allow the manufacturer to account for the color change induced by the treated copper-containing material and the copper-coordinating additive and thus facilitate providing a final product having a desired color and improved color stability over time. Thus, in some examples, an acceleration in the color change of the carrier when combined with the treated copper-containing material and the copper-coordinating additive may be utilized by manufacturers to account for the color change and adjust accordingly during the manufacturing process. In addition, in some examples, the majority of the color change occurs during the manufacturing process and thus the final paint product may have improved color stability during storage and/or after use. In other examples, the treated copper-containing material and the copper-coordinating additive may result in a decrease in the color change of the carrier and/or an increase in the stability of the color of the carrier over time as compared to the copper-containing material absent the copper-coordinating additive.

In an example, a method of minimizing a color change in a biocidal material is provided, including: combining a copper-containing material including from 10 to 70 weight % of an amount of extractable copper with an amount of copper-coordinating additive, in a molar ratio of the amount of extractable copper to the amount of copper-coordinating additive of from 1:0.1 to 1:25 to form a copper-containing mixture; and combining the copper-containing mixture with a carrier to form the biocidal material; wherein a concentration of the copper-containing material and the copper-coordinating additive of the copper-containing mixture in the carrier is from 0.01% weight/weight of the carrier to 5% weight/weight of the carrier; and wherein the color change in the biocidal material is minimized relative to a change in color of a mixture of the carrier and the copper-containing material in the absence of the copper-coordinating additive. In another example, a method of minimizing a color change in a carrier of an initial color is provided, wherein the copper-containing material comprises from 25 to 50 weight % of the amount of extractable copper. In yet another example, a method of minimizing a color change in a biocidal material is provided, wherein the copper-coordinating additive is a compound of formula (I), (II), (III), (IV), (V), (XI), or (XII), or a crown ether, an aza-crown ether, or salen. In yet another example, a method of minimizing a color change in a biocidal material is provided, wherein the copper-coordinating additive is a compound selected from the group consisting of 2-ethylhexyl phosphate, bis(2-ethylhexyl)phosphate, methyl phosphate, dimethyl phosphate, phenyl phosphate, diphenyl phosphate, 2,2′-bipyridine, terpyridine, citric acid, diethanolamine, triethanolamine, 14-crown-4, 15-crown-5, 18-crown-6, dibenzo-18-crown-6, aza-15-crown-5, aza-18-crown-6, and salen. In yet another example, a method of minimizing a color change in a biocidal material is provided, wherein the composition demonstrates a greater than 3 logarithmic reduction in a concentration of a bacterial selected from the group consisting of Staphylococcus aureus, Enterobacter aerogenes, Pseudomonas aeruginosa, Methicillin Resistant Staphylococcus aureus, E. coli, and mixtures thereof. In yet another example, a method of minimizing a color change in a biocidal material is provided, wherein a CIE ΔE* value of the biocidal material is less than about 10, as measured according to formula (XIII):

$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$

wherein L*, a*, and b* are the CIE L*, a*, and b* values of the biocidal material and the L*_{control}, a*_{control}, and b*control are the CIE L*, a*, and b* values of the carrier.

In an example, a method of accelerating a color endpoint in a biocidal material is provided, including: combining a copper-containing material including from 10 to 70 weight % of an amount of extractable copper with an amount of copper-coordinating additive, in a molar ratio of the amount of extractable copper to the amount of copper-coordinating additive of from 1:0.1 to 1:25 to form a copper-coordinating mixture; and combining the copper-containing mixture with a carrier to form the biocidal material; wherein a concentration of the copper-containing material and the copper-coordinating additive of the copper-containing mixture in the carrier is from 0.01% weight/weight of the carrier to 5% weight/weight of the carrier; and wherein a CIE ΔE* value of the biocidal material is less than about 10, as measured according to formula (XIII):

$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$

wherein L*, a*, and b* are the CIE L*, a*, and b* values of the color endpoint and the L*_{control}, a*_{control}, and b*_{control} are the initial CIE L*, a*, and b* values of the biocidal material; and wherein the color endpoint in the biocidal material is accelerated relative to a change in color to a color endpoint of a mixture of the carrier and the copper-containing material in the absence of the copper-coordinating additive. In another example, a method of accelerating a color endpoint in a biocidal material is provided, wherein the copper-containing material comprises from 25 to 50 weight % of the amount of extractable copper. In yet another example, a method of accelerating a color endpoint in a biocidal material is provided, wherein the copper-coordinating additive is a compound of formula (I), (III), (VI), (VII), (IX), (X), (XI), or (XII), or a crown ether, an aza-crown ether, or salen. In yet another example, a method of accelerating a color endpoint in a biocidal material is provided, wherein the copper-coordinating additive is a compound selected from the group consisting of 2-ethylhexyl phosphate, bis(2-ethylhexyl)phosphate, methyl phosphate, dimethyl phosphate, phenyl phosphate, diphenyl phosphate, citric acid, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen. In yet another example a method of accelerating a color endpoint in a biocidal material is provided, wherein the composition demonstrates a greater than 3 logarithmic reduction in a concentration of a bacterial selected from the group consisting of Staphylococcus aureus, Enterobacter aerogenes, Pseudomonas aeruginosa, Methicillin Resistant Staphylococcus aureus, E. coli, and mixtures thereof. In yet another example, a method of accelerating a color endpoint in a biocidal material is provided, wherein the method further includes: treating the copper-containing material with a pretreatment solution prior to the combining with the amount of copper-coordinating additive. In yet another example, a method of accelerating a color endpoint in a biocidal material is provided, wherein the copper-coordinating additive is a compound of formula (VIII).

The compositions and methods described above may be better understood in connection with the following Examples. In addition, the following non-limiting examples are an illustration. The illustrated methods are applicable to other examples of biocidal compositions of the present disclosure. The procedures described as general methods describe what is believed will be typically effective to prepare the compositions indicated. However, the person skilled in the art will appreciate that it may be necessary to vary the procedures for any given example of the present disclosure, e.g., vary the order or steps and/or the chemical reagents used.

### Examples

As used herein, unless otherwise specified, the term “color shift,” is used to refer to the change of the color of the carrier upon addition of the copper-containing material and/or the chemical additive and compares the color of the mixed carrier and the copper-containing material and/or the chemical additive to the color of the carrier in the absence of the copper-containing material and/or the chemical additive (control). The term “color drift” is used to refer to the change of the color of the carrier at a predetermined time after addition of the copper-containing material and/or the chemical additive and compares the color of the carrier mixed with the copper-containing material and/or the chemical additive after a predetermined time period to the color of the carrier upon initially being mixed with the copper-containing material and/or the chemical additive (time=0). Color shift and color drift may be reported using ΔE*. Color shift and color drift may be reported in terms of ΔE_{c}* and ΔE₀* according to formulae (XIII) and (XIV), respectively.

$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$

$$and$$

$$Δ {E}_{0}^{*} = \sqrt{( {( {L}^{*} - {L}_{0}^{*} )}^{2} + {( {a}^{*} - {a}_{0}^{*} )}^{2} + {( {b}^{*} - {b}_{0}^{*} )}^{2} )} \qquad ( XIV )$$

wherein L*, a*, and b* are the CIE L*, a*, and b* values of the mixed carrier material, L*_{control}, a*_{control}, and b*_{control} are the CIE L*, a*, and b* values of the carrier in the absence of the copper-containing material and/or the chemical additive, and L*o, a*o, and b*o are the CIE L*, a*, and b* values of the mixed carrier material at the time of mixing (time=0).

In some examples, color drift may be reported in terms of an LCh⁰ factor. For example, a percent change of the coordinates L*, C*, and h⁰ per day may be calculated as the difference between the coordinates measured at the time of adding the copper-containing material and/or the chemical additive to the carrier products and the same coordinates measured at some predetermined time period (e.g., time (t)=72 hours) after adding the copper-containing material and/or the chemical additive to the carrier products to arrive at values for the percent change of the components per day dL*, dC*, and dh⁰. Formulae (XV)—(XVII) may be used to determine dL*, dC*, and dh⁰, respectively:

$${dL}^{*} = ( ( {L}_{t}^{*} - {L}_{0}^{*} ) \cdot 24 / ( t \cdot {L}_{0}^{*} ) ) \qquad ( XV )$$

$${dC}^{*} = ( ( {C}_{t}^{*} - {C}_{0}^{*} ) \cdot 24 ) / ( t \cdot {C}_{0}^{*} ) ) \qquad ( XVI )$$

$${dh}^{0} = ( ( {h}_{t}^{0} - {h}_{0}^{0} ) \cdot 24 ) / ( t \cdot {h}_{0}^{0} ) ) \qquad ( XVII )$$

wherein Lₜ*, Cₜ*, and h⁰ₜ are the CIE L*, C*, and h⁰₀ values of the mixed carrier material at a predetermined time period after mixing and L₀*, C₀*, and h⁰₀ are the CIE L*, C*, and h⁰ values of the mixed carrier material at the time of mixing (time=0).

Color drift may be reported in terms of an LCh⁰ factor according to formula (XVIII):

$$L C {h}^{0} = \sqrt{( {( {dL}^{*} )}^{2} + {( {dC}^{*} )}^{2} + {( d {h}^{0} )}^{2} )} \qquad ( XVIII )$$

wherein dL*, dC*, and dh⁰ are determined according to formulae (XV)-(XVII) above.

Representative preparation of biocidal composition samples. In the following examples, a copper-containing material is understood to include extractable copper in an amount from 10 weight % to 70 weight %.

A copper-containing material (0.504 grams) were mixed with hydroxylamine hydrochloride (0.155 grams, 2.231 mmol) in 2 mL water thoroughly, and allowed to mix for 1 hour until copper was extracted from the copper-containing material and a hydroxylamine-copper complex formed. The mixture was sonicated for 20 to 30 seconds. 50 grams of Control B paint was added to the mixture and agitated with an overhead mixer at 980 rpm for 2 minutes. A drawdown sample was used with a 7 mil (0.007″) wet film applicator, which represents the “before peroxide” comparison example. 2 milliliters of hydrogen peroxide (3%) was added to the paint mixture and stirred until well-mixed. After two hours, a drawdown sample with a 7 mil (0.007″) wet film applicator, which represents the “after peroxide” comparison example.

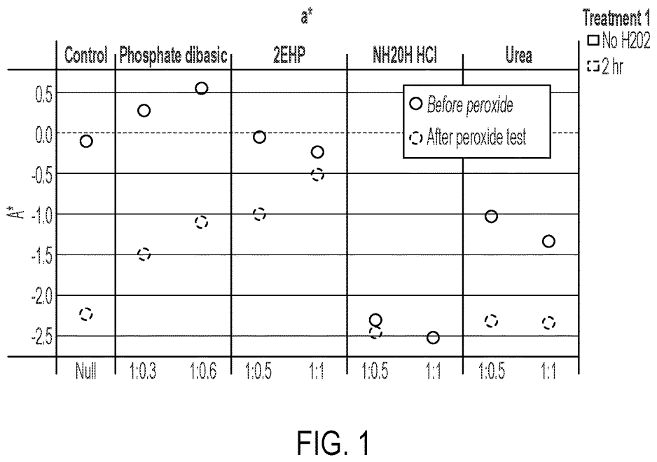

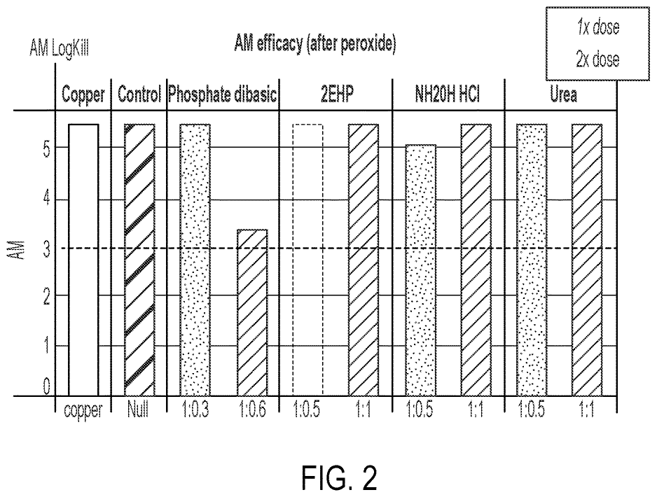

The above procedure was performed using the copper-containing material in 1:0.3 and 1:0.6 molar ratios of extractable copper, in the copper-containing material, to phosphate dibasic, in 1:0.5 and 1:1 molar ratios of extractable copper, in the copper-containing material, to 2-ethylhexylphosphate (2EHP), in 1:0.5 and 1:1 molar ratios of extractable copper, in the copper-containing material, to hydroxylamine hydrochloride, and in 1:0.5 and 1:1 molar ratios of extractable copper, in the copper-containing material, to urea. As shown in FIG. 1, total drift in color may be estimated by the gap between paint color before and paint color after peroxide testing. The control (paint dosed with the copper-containing material) results in an a* drift of ˜−2.25 and an endpoint of ˜2.25. Copper-coordinating additives that reduced color drift included phosphate dibasic (−1.75, with endpoint ˜−1.5) and 2EHP (−0.25 to −1 of drift, and endpoint of −0.5 to −1). Hydroxylamine hydrochloride and urea did not change the endpoint a*, but reduced drift to ˜0 for hydroxylamine hydrochloride and ˜−1 for urea. As shown in FIG. 2, copper-coordinating additives do not impact antimicrobial efficacy with the exception of 1:0.6 molar ratio of extractable copper, in the copper-containing material, to phosphate dibasic. All other samples demonstrate antimicrobial efficacy similar to the antimicrobial efficacy of the control sample (the copper-containing material-dosed paint, 50 g/gallon, no copper-coordinating additives).

Color measurements were performed with a paint film (cured for three days) using an X-Rite VS450 Non-Contact Color Measurement Instrument Spectrophotometer. Three spots of each paint film were measured, and the average reported.

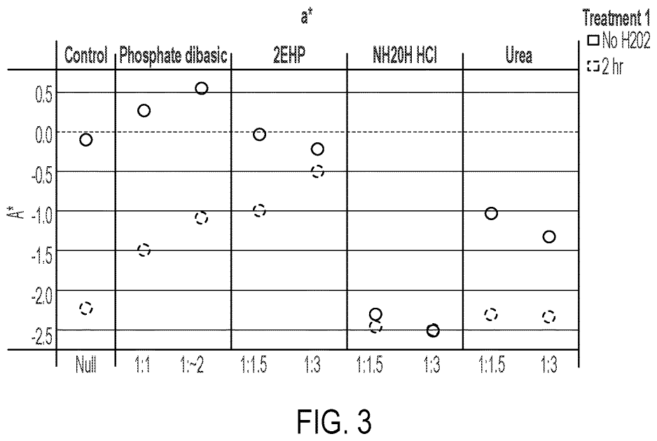

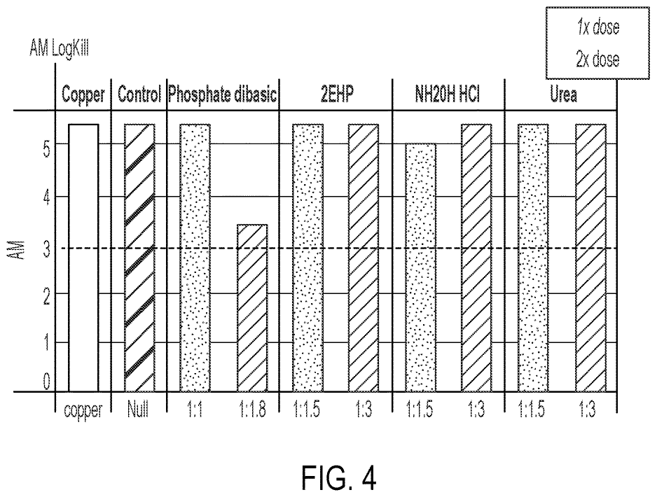

Similar experiments were performed in which each of phosphate dibasic, 2EHP, hydroxylamine hydrochloride, and urea were added to water and neutralized to a pH of 7. Subsequently, a copper-containing material was added to each neutral solution to prepare samples for color testing with 1:1 and 1:2 molar ratios of extractable copper, in the copper-containing material, to phosphate dibasic, 1:1.5 and 1:3 molar ratios of extractable copper, in the copper-containing material, to 2EHP, 1:1.5 and 1:3 molar ratios of extractable copper, in the copper-containing material, to hydroxylamine hydrochloride, and 1:1.5 and 1:3 molar ratios of extractable copper, in the copper-containing material, to urea. By changing the preparation method slightly, it was found that drift in color was reduced significantly both for 2EHP and for hydroxylamine hydrochloride, as shown in FIG. 3. Further, despite the modified preparation method, antimicrobial efficacy of the test compositions was not impacted, as shown in FIG. 4.

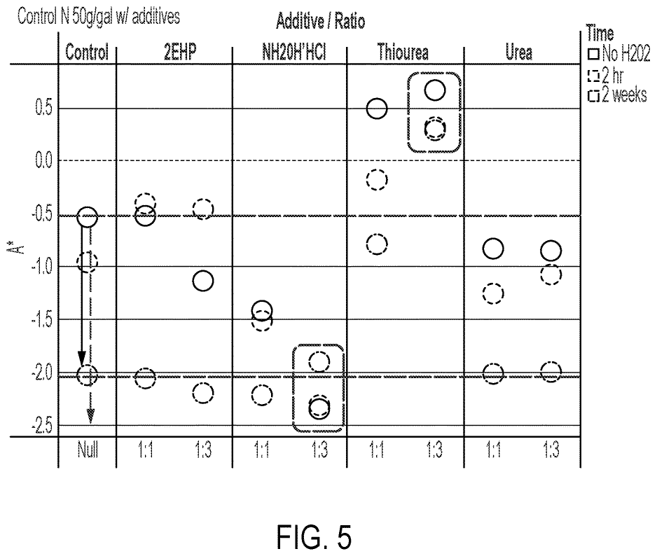

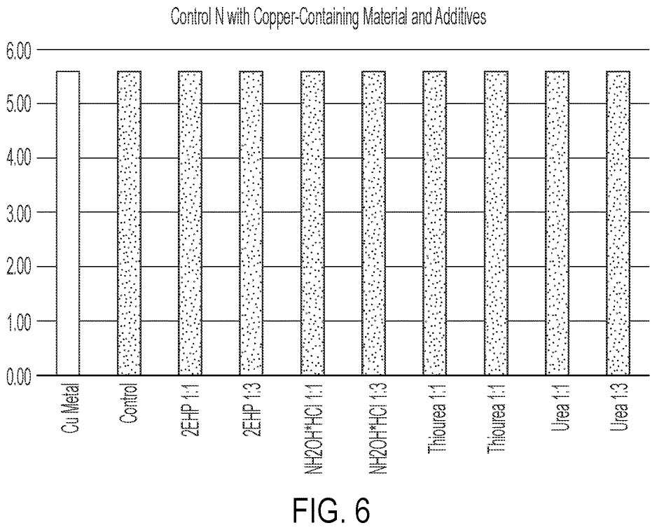

Experiments were performed using control paint samples, in which each of 2EHP, hydroxylamine hydrochloride, thiourea, and urea were separately added to volumes of water and neutralized to a pH of 7. Subsequently, a copper-containing material was added to each neutral solution to prepare samples for color testing with 1:1 and 1:3 molar ratios of extractable copper, in the copper-containing material, to 2EHP, 1:1 and 1:3 molar ratios of extractable copper, in the copper-containing material, to hydroxylamine hydrochloride, 1:1 and 1:3 molar ratios of extractable copper, in the copper-containing material, to thiourea, and 1:1 and 1:3 molar ratios of extractable copper, in the copper-containing material, to urea. The mixtures were then each combined as above with 50 grams of control paint sample. As shown in FIG. 5, hydroxylamine hydrochloride minimized color drift by accelerating to endpoint quickly, whereas thiourea reduced total color drift, but changed the endpoint color to a higher a* value. 2-Ethylhexylphosphate did not minimize drift as demonstrated in control paint samples, however there was some reduction in drift for 1:3 molar ratio relative to 1:1 molar ratio. As shown in FIG. 6, all copper-coordinating additive loadings demonstrated antimicrobial efficacies of greater than 5 logarithmic reduction.

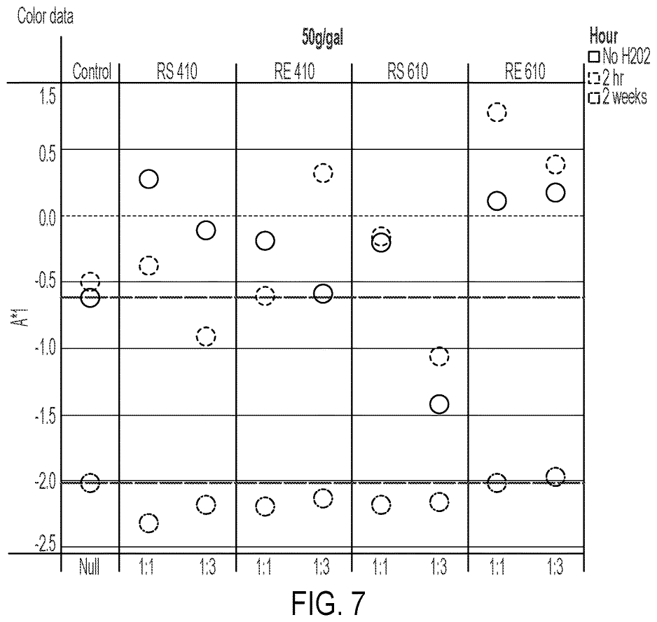

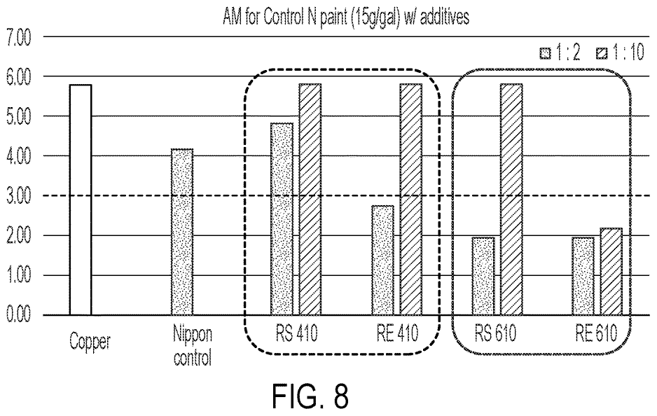

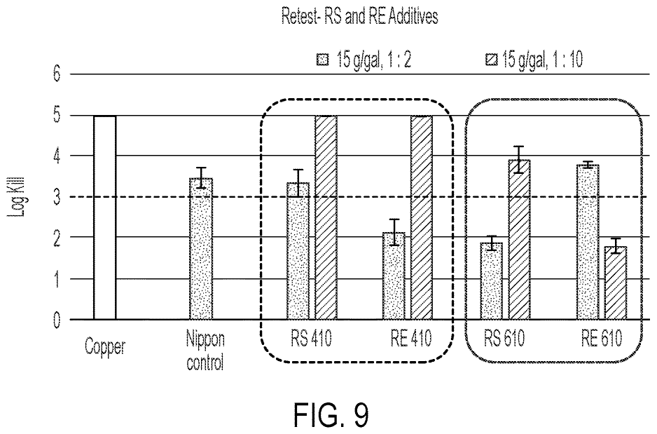

Each of RS 410, RE 410, RS 610, and RE 610 were separately added to volumes of water and neutralized to a pH of 7. Subsequently, a copper-containing material was added to each neutral solution to prepare samples for color testing with 1:1 and 1:3 molar ratios of extractable copper, in the copper-containing material, to each of RS 410, RE 410, RS 610, and RE 610. RS 410 and RS 610 are copper-coordinating additives of formula (I) that are available from Solvay©, which are polyethylene glycol tridecyl ether phosphate. RE 410 and RE 610 are copper-coordinating additives of formula (I) that are available from Solvay©, which are Poly(oxy-1,2-ethane-di-yl), α-(nonylphenyl)-ω-hydroxy-, branched, phosphates. RE 410 and RS 410 contain less moles of ethylene oxide than RE 610 and RS 610, and therefore RE 410 and RS 410 have lower molecular weights. The mixtures were then each combined as above with 50 grams of control paint samples. As shown in FIG. 7 the RS 410, RE 410, RS 610, and RE 610 esters did not minimize color drift. Separately, the copper-containing material and copper-coordinating additive mixtures were combined with 15 grams of paint. As shown in FIGS. 8 and 9, the antimicrobial efficacy test was repeated on the RS 410, RE 410, RS 610, and RE 610 phosphate esters, and the RS 410 and RE 410 series at 1:10 ratio outperformed the control paint samples in terms of antimicrobial efficacy and demonstrated full antimicrobial kill.

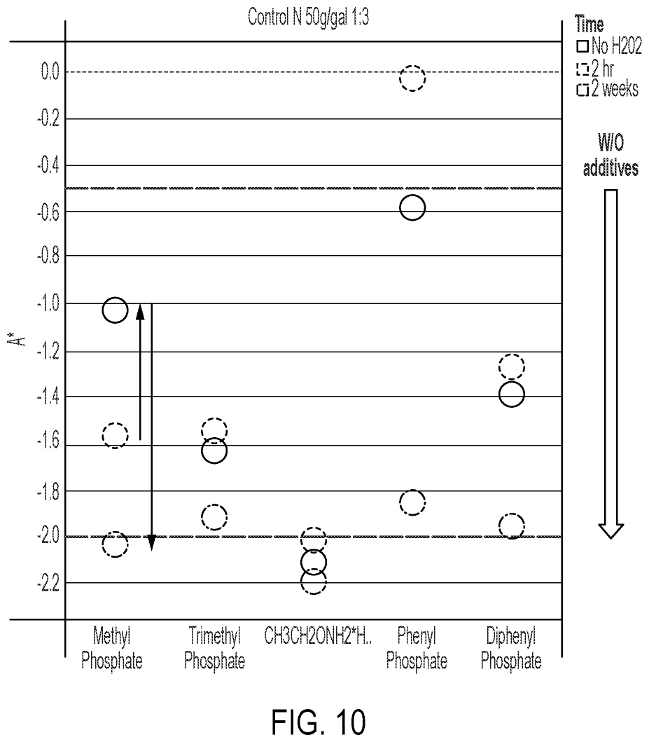

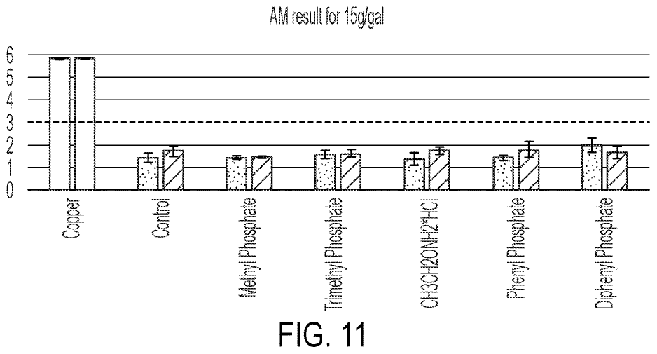

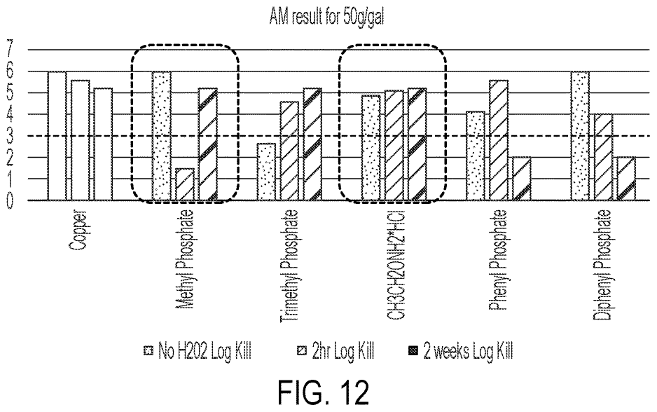

Each of methyl phosphate, trimethyl phosphate, ethoxyamine hydrochloride, phenyl phosphate, and diphenyl phosphate were separately added to volumes of water and neutralized to a pH of 7. Subsequently, a copper-containing material was added to each neutral solution to prepare samples for color testing with 1:3 molar ratios of extractable copper, in the copper-containing material, to each of methyl phosphate, trimethyl phosphate, ethoxyamine hydrochloride, phenyl phosphate, and diphenyl phosphate. The mixtures were then each combined as above with 50 grams of control paint samples. As shown in FIG. 10, each of methyl phosphate, trimethyl phosphate, diphenyl phosphate, and ethoxyamine hydrochloride accelerated color shift to endpoint, minimizing color drift. As shown in FIG. 11, the control paint samples including the copper-containing material and copper-coordinating additives demonstrated lower antimicrobial efficacy of ˜1.5-2 logarithmic reduction at concentrations of 15 g of 1:3 molar ratio of extractable copper to copper-coordinating additive per gallon of control paint sample. By contrast, as shown in FIG. 12, methylphospahte and ethoxyamine hydrochloride demonstrated minimal impact on antimicrobial efficacy at concentrations of 50 g of 1:3 molar ratio of extractable copper to copper-coordinating additive per gallon of control paint samples.

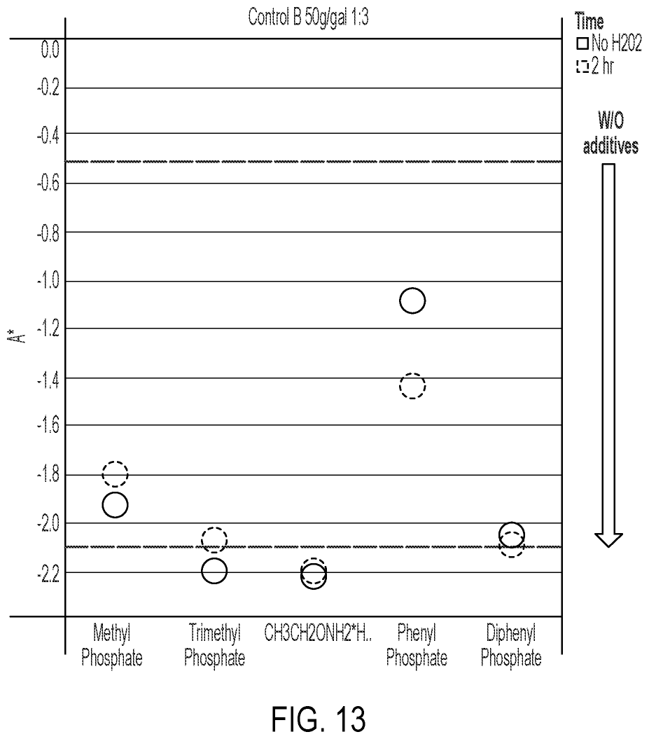

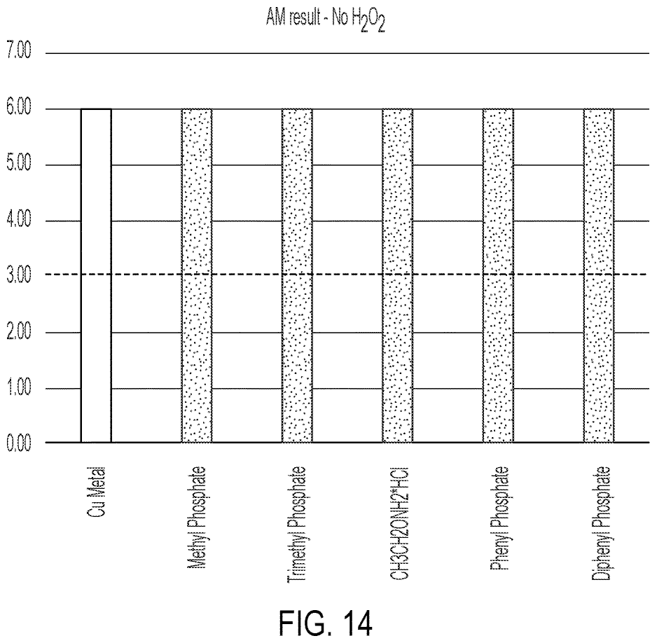

Color testing samples with 1:3 molar ratios of extractable copper, in the copper-containing material, to each of methyl phosphate, trimethyl phosphate, ethoxyamine hydrochloride, phenyl phosphate, and diphenyl phosphate were prepared, and each mixture was added to 50 grams of control paint samples. As shown in FIG. 13, all copper-coordinating additives except for phenyl phosphate accelerated color shift to endpoint. Further, as shown in FIG. 14, all copper-coordinating additives exhibited antimicrobial efficacies of greater than 5 logarithmic reduction.

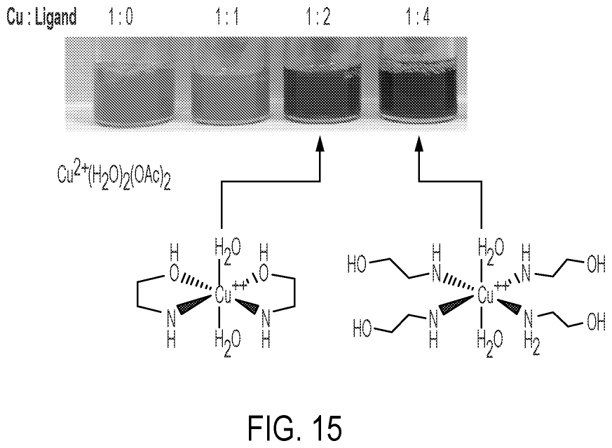

FIG. 15 illustrates the drift in blue color resulting from an increase in the ratio of the number of ligand compounds complexed to a copper atom in control paint samples relative to copper, from a 0:1 ligand compound to copper atom ratio on the far left, to a 1:1 ligand compound to copper atom ratio on the center left, to a 2:1 ligand compound to copper atom ratio on the center right, to a 4:1 ligand compound to copper atom ratio on the far right.

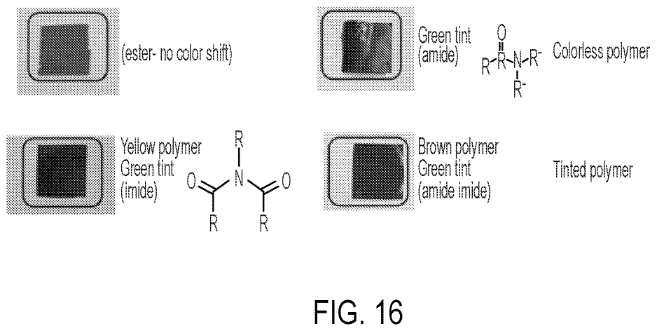

FIG. 16 illustrates the differences in color of colorless polymers poly(methyl methacrylate) (PMMA, 15.84 weight %; 3.6 weight % copper-containing material; no color shift) and Nylon 6 (15 weight %; 3.6 weight % copper-containing material; green tint) and tinted polymers polyether imide (15 weight %, yellow polymer; 3.6 weight % copper-containing material; green tint) and Torlon (polyamideimide, 15 weight %, brown polymer; 3.6 weight % copper-containing material; green tint).

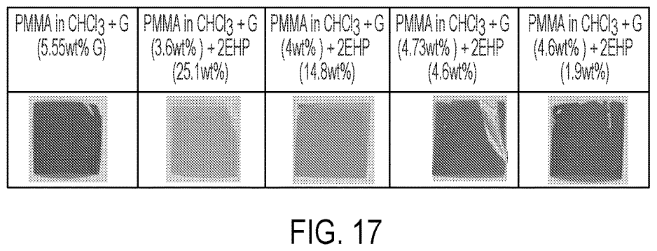

FIG. 17 illustrates the change in color of PMMA in chloroform in non-latex control paint samples, with decreasing weight % amounts of 2EHP, of 25.1 weight %, 14.8 weight %, 4.6 weight %, and 1.9 weight %, and as compared to a control of PMMA in chloroform dosed with a copper-containing material. The color shift demonstrated the impact of the amount of phosphate copper-coordinating additive on overall color in non-latex control paint samples.

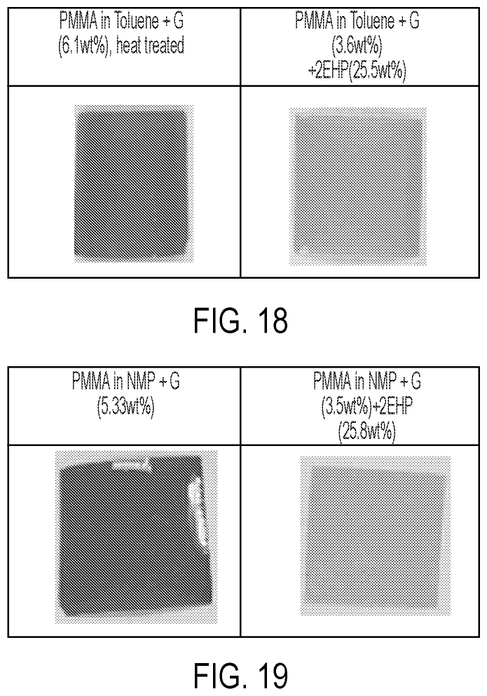

FIG. 18 illustrates the change in color of PMMA in chloroform in non-latex paint, with 25.5 weight % 2EHP as compared to a control of heat-treated PMMA in toluene dosed with a copper-containing material. The color shift demonstrated the impact of phosphate copper-coordinating additive on overall color in non-latex control paint samples.

FIG. 19 illustrates the change in color of PMMA in NMP in non-latex control paint samples, with 25.8 weight % 2EHP as compared to a control of PMMA in NMP dosed with a copper-containing material. The color shift demonstrated the impact of phosphate copper-coordinating additive on overall color in non-latex control paint samples.

The above data demonstrate that minimizing color drift and accelerating color change to endpoint were effective strategies in control paint samples. Thiourea as copper-coordinating additive increased the a* beyond the original paint composition, and hydroxylamine hydrochloride and other examples of additives accelerated color endpoints and reduced color shifts by starting with more negative a* values. In certain control paint samples, copper-coordinating additives generally did not negatively impact antimicrobial efficacies. For other control paint samples, additives impacted antimicrobial efficacy at 50 g per gallon loading, but not at 15 g per gallon loading.

Without being bound by theory, it is believed that species including Cu¹⁺ may have greater antimicrobial efficacy. Further, it is believed that Cu²⁺ is a more energetically favorable oxidation state than Cu¹⁺, but Cu²⁺ may produce color and may have lower antimicrobial efficacy. Thus, it is believed that while species including Cu²⁺ may be generally more stable, species including Cu¹⁺ are favored for function and color in the examples of compositions and methods of the present disclosure.

Consequently, without being bound by theory, it is believed that additives that are reducing agents may be effective in reversing color production due to Cu²⁺ complexes that have already formed, by reducing the Cu²⁺ in the complexes to Cu¹⁺. Alternatively, it is believed that antioxidants may be effective in scavenging oxidants, so as to minimize further color change.

In an example, an additive that is a reducing agent and/or an antioxidant may be a compound of formula (XII):

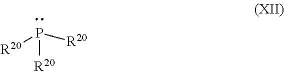

wherein each R²⁰ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl; provided that all R²⁰ are not simultaneously hydrogen; and provided that at least one R²⁰ includes one or more heteroatoms selected from N, O, and S replacing the beta-carbon or gamma-carbon, and/or one or more heteroatoms selected from N, O, and S substituted for hydrogens on the alpha-carbon, beta-carbon, or gamma-carbon; or an alpha-carbon of at least one R²⁰ is a secondary carbon or a tertiary carbon.

In another example, an additive that is a reducing agent and/or an antioxidant may be a compound of formula (XIX):

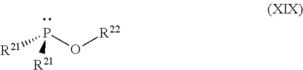

wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that both R²¹ are not simultaneously hydrogen; and optionally wherein the alpha-carbon of at least one R²¹ is a secondary or tertiary carbon; and R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl, optionally wherein the alpha-carbon of R²² is a secondary or tertiary carbon.

In yet another example, an additive that is a reducing agent and/or an antioxidant may be a compound of formula (XX):

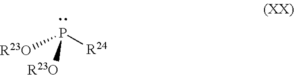

wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl, optionally wherein the alpha-carbon of at least one R²³ is a secondary or tertiary carbon; provided that both R²³ are not simultaneously hydrogen; and R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl, optionally wherein the alpha-carbon of R²⁴ is a secondary or tertiary carbon.

In yet another example, an additive that is a reducing agent and/or an antioxidant may be a compound of formula (XI):

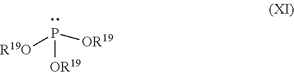

wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and provided that all R¹⁹ are not simultaneously hydrogen; and optionally wherein the alpha-carbon of at least one R¹⁹ is a secondary or tertiary carbon.

In yet another example, an additive that is a reducing agent and/or an antioxidant may be a compound formula (VI):

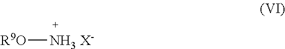

wherein X⁻ is selected from the group consisting of fluoride, chloride, bromide, iodide, hexafluorophosphate, sulfate, an alkylsulfonate, and an arylsulfonate; and R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

In yet another example, an additive that is a reducing agent and/or an antioxidant may be ascorbic acid or a compound of formula (XXI):

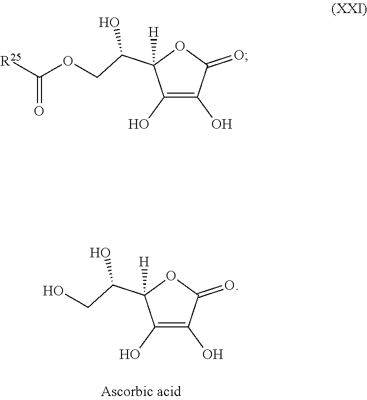

wherein R²⁵ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl.

In yet another example, an additive that is a reducing agent and/or an antioxidant may be zinc of any oxidation state.

In yet another example, an additive that is a reducing agent and/or an antioxidant may be a thiol selected from the group consisting of (C₁-C₃₀)alkylthiol, (C₂-C₃₀)alkenylthiol, (C₂-C₃₀)alkynylthiol, arylthiol, heteroarylthiol, heterocyclylthiol, aryl(C₁-C₄)alkylthiol, heteroaryl(C₁-C₄)alkylthiol, and heterocyclyl(C₁-C₄)alkylthiol.

In yet another example, an additive that is a reducing agent and/or an antioxidant may be a compound of formula (IV):

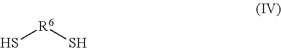

wherein, from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁—C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene; the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy; provided that the two thiol groups are not bonded to the same carbon.

Without being bound by theory, it is believed that an additive that is sterically hindered may inhibit oxidation of Cu¹⁺ by limiting accessibility to the Cu¹⁺ site in Cu(I) complexes, but to do so such an additive has to be competitive with other ligands with respect to the strength of binding to the Cu¹⁺ site and such an additive has to favor Cu¹⁺ when complexed so that maintaining the Cu¹⁺ becomes energetically favorable to oxidation.

Without being bound by theory, it is believed that an additive that is a reducing agent and/or an antioxidant also may be an oxidation inhibitor so as to not only reverse the oxidation of Cu¹⁺ to Cu²⁺ but also to maintain the reduced state as long as possible.

In an example, an additive that is an oxidation inhibitor may be a compound of formula (XII):

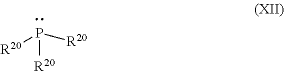

wherein each R²⁰ is independently selected form the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl; provided that all R²⁰ are not simultaneously hydrogen, and that an alpha-carbon of at least one R²⁰ is a secondary carbon or a tertiary carbon.

In another example, an additive that is an oxidation inhibitor may be a compound of formula (XIX):

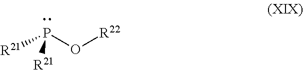

wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that both R²¹ are not simultaneously hydrogen, and provided that the alpha-carbon of at least one R²¹ and/or R²² is a secondary or tertiary carbon.

In yet another example, an additive that is an oxidation inhibitor may be a compound of formula (XX):

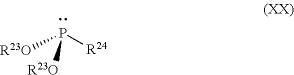

wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl; and R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that the alpha-carbon of at least one R²³ and/or R²³ is a secondary or tertiary carbon.

In yet another example, an additive that is an oxidation inhibitor may be a compound of formula (XI):

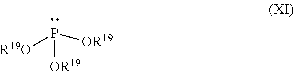

wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and provided that all R¹⁹ are not simultaneously hydrogen and that the alpha-carbon of at least one R¹⁹ is a secondary or tertiary carbon.

In yet another example, an additive that is an oxidation inhibitor may be a compound of formula (VI):

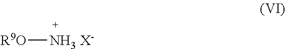

wherein X⁻ is selected from the group consisting of fluoride, chloride, bromide, iodide, hexafluorophosphate, sulfate, an alkylsulfonate, and an arylsulfonate; and R⁹ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl; provided that the alpha-carbon of R⁹ is a secondary or tertiary carbon.

In yet another example, an additive that is an oxidation inhibitor may be a compound of formula (XXI):

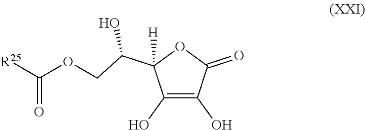

wherein R²⁵ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl; provided that the alpha-carbon of R²⁵ is a secondary or tertiary carbon.

In yet another example, an additive that is an oxidation inhibitor may be a compound of formula (I):

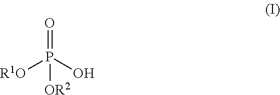

wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that both of R¹ and R² are not simultaneously hydrogen and that the alpha-carbon of at least one of R¹ and R² is a secondary or tertiary carbon.

In yet another example, an additive that is an oxidation inhibitor may be a compound of formula (XXII):

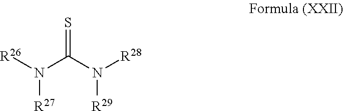

wherein each of R²⁶, R²⁷, R²⁸, and R²⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; optionally wherein the alpha-carbon of at least one of R²⁶, R²⁷, R²⁸, and R²⁹ is a secondary or tertiary carbon.

In yet another example, an additive that is an oxidation inhibitor may be a compound of formula (XXIII):

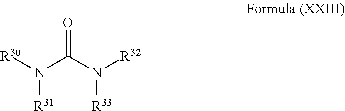

wherein each of R³⁰, R³, R³², and R³³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; optionally wherein the alpha-carbon of at least one of R³⁰, R³, R³², and R³³ is a secondary or tertiary carbon.

In yet another example, an additive that is an oxidation inhibitor may be a nitrile compound selected from the group consisting of a (C₁-C₃₀)alkylnitrile, a (C₂-C₃₀)alkenylnitrile, a (C₂-C₃₀)alkynylnitrile, an arylnitrile, a heteroarylnitrile, a heterocyclylnitrile, an aryl(C₁-C₄)alkylnitrile, a heteroaryl(C₁-C₄)alkylnitrile, and a heterocyclyl(C₁-C₄)alkylnitrile; optionally wherein the alpha-carbon is a secondary or tertiary carbon.

In yet another example, an additive that is an oxidation inhibitor may be a substituted or unsubstituted compound of formula (XXIV):

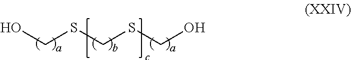

wherein a may be an integer from 1 to 4; b may be an integer from 1 to 4, and c may be an integer from 0 to 3; and wherein a substituted compound of formula (XXIV) includes one or more carbons substituted with one or more substituents selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy.

In yet another example, an additive that is an oxidation inhibitor may be a compound of formula (VII):

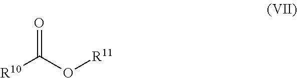

wherein each of R¹⁰ and R¹¹ is independently selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that the alpha carbon of at least one of R¹⁰ and R¹¹ is a secondary or tertiary carbon.

In yet another example, an additive that is an oxidation inhibitor may be a compound selected from benzotriazole, an amino acid, and a surfactant. Examples of surfactants may include sodium stearate, 4-(5-dodecyl)benzenesulfonate, docusate, alkyl ether phosphates, and benzalkonium chloride.

In yet another example, an additive that is an oxidation inhibitor may be a compound including an imidazole group or a reduced imidazole group. Examples may include benzimidazole, imidazole, or 2-imidazoline.

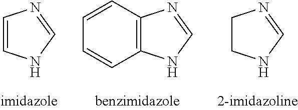

In yet another example, an additive that is an oxidation inhibitor may be a soft base. Soft bases may include species that are characterized by large radii, intermediate electronegativities, and high polarizabilities. Examples of soft bases may include H⁻, CO, PR₃, C₆H₆, and SCN⁻.

In yet another example, an additive that is an oxidation inhibitor may be a compound of formula (XXV):

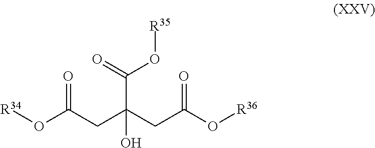

wherein each of R³⁴, R³⁵, and R³⁶ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that R³⁴, R³⁵, and R³⁶ are not simultaneously hydrogen; and optionally wherein the alpha-carbon of at least one of R³⁴, R³⁵, and R³⁶ is a secondary or tertiary carbon.

In yet another example, an additive that is an oxidation inhibitor may be a compound of formula (XXVI):

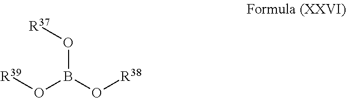

wherein each of R³⁷, R³⁸, and R³⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; provided that R³⁷, R³⁸, and R³⁹ are not simultaneously hydrogen; and optionally wherein the alpha-carbon of at least one of R³⁷, R³⁸, and R³⁹ is a secondary or tertiary carbon.

Copper-coordinating additives may need to be introduced into a carrier to mitigate the color change based on the type of the carrier. Color drift kinetics and overall total drift (magnitude and hue) may be different depending on the carrier formulation and the starting color. It is believed that components in a carrier may change dissolution and oxidation behavior of copper, or be very competitive ligand for coordinating to copper. If a component in a carrier inhibits dissolution and/or oxidation, color drift may still happen, but it is expected that the kinetics will be much slower, as appears to be the case in some control paint sample. If a carrier includes components that are either more strongly binding ligands to copper than the current additive options or that are more intensely colored, more strongly binding or multivalent additives may be required. It is expected that screening carriers based on the dissolution kinetics, oxidation behavior of copper, and color endpoint and gauging ligand strength by use of different types of additives will be helpful to calibrate copper-coordinating additive to carrier type.

Although the present disclosure has been described with reference to examples and the accompanying figures and charts, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a composition, comprising: a carrier; a copper-containing material in the carrier, wherein the copper-containing materials comprises from 10 to 100 weight % of an amount of extractable copper; and a copper-coordinating additive in the carrier, in a molar ratio of the amount of extractable copper to an amount of the copper-coordinating additive of from 1:0.1 to 1:25, wherein a concentration of the copper-containing material and the copper-coordinating additive in the carrier is from 0.01% weight/weight of the carrier to 5% weight/weight of the carrier.

A second aspect relates to the composition of aspect 1, wherein the copper-containing material comprises from 25 to 50 weight % of the amount of extractable copper.

A third aspect relates to the composition of any preceding aspect, the copper-coordinating additive is a compound of formula (I), (II), (III), (IV), (V), (XI), or (XII):

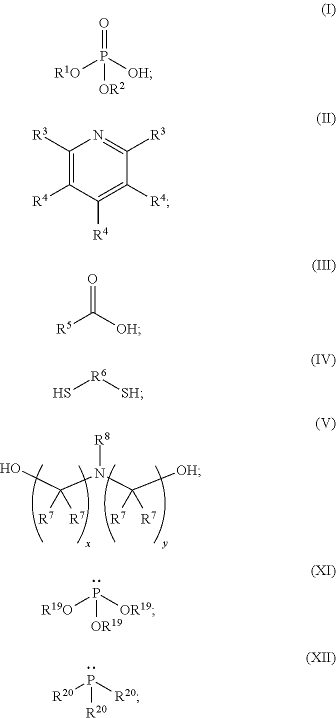

wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
each R³ is independently selected from the group consisting of hydrogen, (C₁-C₃₀)alkyl, (C₂-C₃₀)alkenyl, (C₂-C₃₀)alkynyl, aryl, heteroaryl, substituted or unsubstituted 2-pyridyl, heterocyclyl, aryl(C₁-C₄)alkyl, heteroaryl(C₁-C₄)alkyl, and heterocyclyl(C₁-C₄)alkyl;
the substituted 2-pyridyl is substituted with up to four substituents, each substituent independently selected from the group consisting of (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
each R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, and —CO₂H;
from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene;
the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkylene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
provided that the two thiol groups in formula (IV) are not bonded to the same carbon;
each R⁷ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R⁸ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R⁷)₂)_{z}OH;
each of x, y, and z is independently 2 or 3;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

A fourth aspect relates to the composition of any one of aspects 1 to 2, wherein the copper-coordinating additive is a compound of formula (I), (III), (VI), (VII), (IX), (X), (XI), or (II):

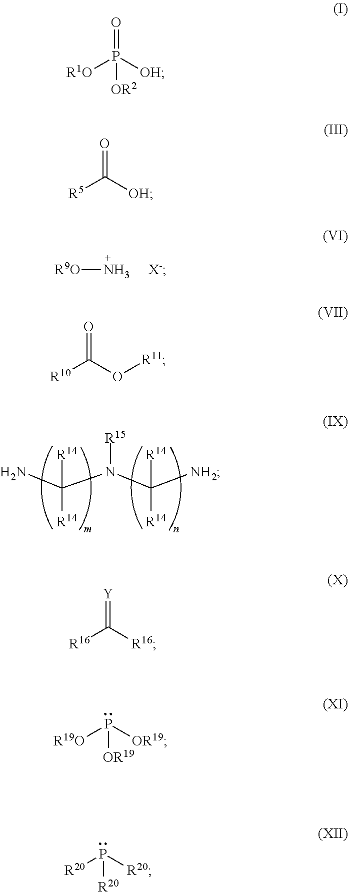

wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
R is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (III) are substituted with one or more substituents each of which is independently selected from the group consisting of —OH, —NH₂, —SH, —CN, —C(O)NH₂, and —CO₂H;
X⁻ is selected from the group consisting of fluoride, chloride, bromide, iodide, hexafluorophosphate, sulfate, an alkylsulfonate, and an arylsulfonate;
R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each of R¹⁰ and R¹¹ is independently selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (VII) are substituted with one or more substituents each of which is independently selected from the group consisting of —OH, —NH₂, —SH, —CN, —C(O)NH₂, —C(O)NHR¹¹, —C(O)NR¹¹₂, —CO₂H, and —CO₂R¹¹;
each R¹⁴ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R¹¹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R¹⁴)₂)ₚNH₂;
each of m, n, and p is independently 2 or 3;
Y is O or S;
each R¹⁶ is independently —OR¹⁷ or —N(R¹⁸)₂;
R¹⁷ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
each R¹⁸ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

A fifth aspect relates to the composition of any one of aspects 1 to 2, wherein the copper-coordinating additive is a compound of formula (VIII):

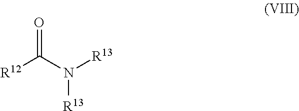

wherein R¹² is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
each R¹³ is independently selected from the group consisting of hydrogen, substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, —C(O)NHR¹³, —C(O)NR¹³₂, —CO₂H, and —CO₂R¹³; and
wherein the composition further comprises a pretreatment solution.

A sixth aspect relates to the composition of any preceding aspect, wherein the copper-coordinating additive is a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, 2,2′-bipyridine, terpyridine, citric acid, diethanolamine, triethanolamine, hydroxyamine hydrochloride, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen.

A seventh aspect relates to the composition of any preceding aspect, wherein the composition demonstrates a greater than 3 logarithmic reduction in a concentration of a bacteria selected from the group consisting of Staphylococcus aureus, Enterobacter aerogenes, Pseudomonas aeruginosa, Methicillin Resistant Staphylococcus aureus, E. coli, and mixtures thereof.

An eighth aspect relates to the composition of aspect 1, wherein the copper-coordinating additive is a thiol, zinc, or ascorbic acid, or a compound of formula (IV), (VI), (XI), (XII), (XIX), (XX), or (XXI):

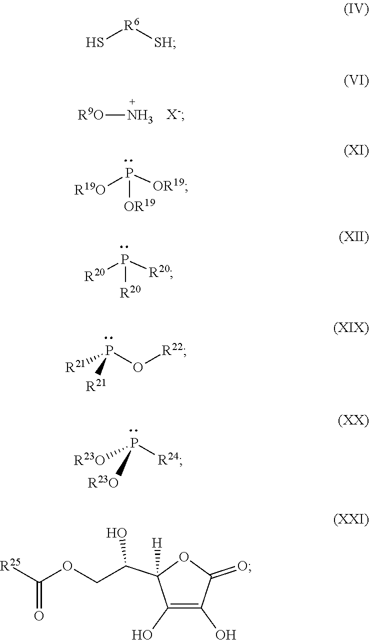

wherein X⁻ is selected from the group consisting of fluoride, chloride, bromide, iodide, hexafluorophosphate, sulfate, an alkylsulfonate, and an arylsulfonate;
wherein, from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene; the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
wherein R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
wherein R²⁵ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
optionally wherein the alpha-carbon of at least one R¹⁹ is a secondary or tertiary carbon;
optionally wherein the alpha-carbon of at least one R²¹ is a secondary or tertiary carbon; optionally wherein the alpha-carbon of R²² is a secondary or tertiary carbon;
optionally wherein the alpha-carbon of at least one R²³ is a secondary or tertiary carbon; and
optionally wherein the alpha-carbon of R²⁴ is a secondary or tertiary carbon;
provided that all R¹⁹ are not simultaneously hydrogen;
provided that all R²⁰ are not simultaneously hydrogen;
provided that at least one R²⁰ includes one or more heteroatoms selected from N, O, and S replacing the beta-carbon or gamma-carbon, and/or one or more heteroatoms selected from N, O, and S substituted for hydrogens on the alpha-carbon, beta-carbon, or gamma-carbon; or an alpha-carbon of at least one R²⁰ is a secondary carbon or a tertiary carbon;
provided that both R²¹ are not simultaneously hydrogen;
provided that both R³ are not simultaneously hydrogen; and
provided that R⁶ has a structure such that the two thiol groups are not bonded to the same carbon.

A ninth aspect relates to the composition of aspect 1, wherein the copper-coordinating additive is a soft base, benzotriazole, an amino acid, a surfactant, a compound comprising an imidazole or a reduced imidazole group, a nitrile compound, or a compound of formula (I), (VI), (VII), (XI), (XII), (XIX), (XX), (XXI), (XXII), (XXIII), (XXIV), (XXV), or (XXVI):

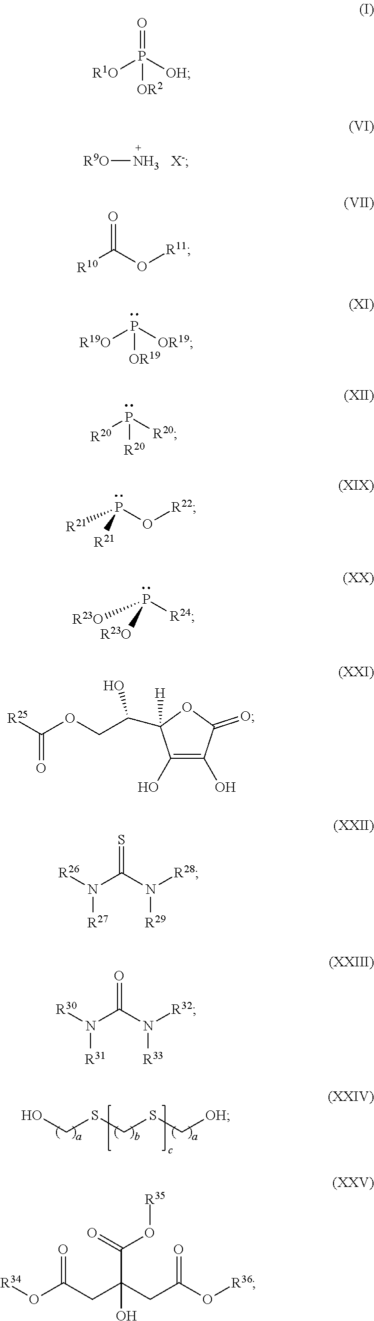

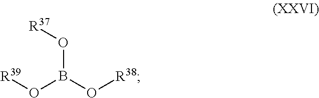

wherein X⁻ is selected from the group consisting of fluoride, chloride, bromide, iodide, hexafluorophosphate, sulfate, an alkylsulfonate, and an arylsulfonate;
wherein a is an integer from 1 to 4;
wherein b is an integer from 1 to 4,
wherein c is an integer from 0 to 3;
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R⁹ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R¹⁰ and R¹¹ is independently selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected form the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; wherein R²⁵ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R²⁶, R²⁷, R²⁸, and R²⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁰, R³¹, R³², and R³³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁴, R, and R³⁶ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁷, R³⁸, and R³⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; wherein the nitrile compound is selected from the group consisting of a (C₁-C₃₀)alkylnitrile, a (C₂-C₃₀)alkenylnitrile, a (C₂-C₃₀)alkynylnitrile, an arylnitrile, a heteroarylnitrile, a heterocyclylnitrile, an aryl(C₁-C₄)alkylnitrile, a heteroaryl(C₁-C₄)alkylnitrile, and a heterocyclyl(C₁-C₄)alkylnitrile; and
wherein a substituted compound of formula (XXIV) includes one or more carbons substituted with one or more substituents selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
optionally wherein the alpha-carbon of at least one of R²⁶, R²⁷, R²⁸, and R²⁹ is a secondary or tertiary carbon;
optionally wherein the alpha-carbon of at least one of R³⁰, R³¹, R³², and R³³ is a secondary or tertiary carbon;
optionally wherein the alpha-carbon of at least one of R³⁴, R³⁵, and R³⁶ is a secondary or tertiary carbon;
optionally wherein the alpha-carbon of at least one of R³⁷, R³⁸, and R³⁹ is a secondary or tertiary carbon; and
optionally wherein the alpha-carbon of the nitrile compound is a secondary or tertiary carbon;
provided that both of R¹ and R² are not simultaneously hydrogen and that the alpha-carbon of at least one of R¹ and R² is a secondary or tertiary carbon;
provided that the alpha-carbon of R⁹ is a secondary or tertiary carbon;
provided that the alpha carbon of at least one of R¹⁰ and R¹¹ is a secondary or tertiary carbon;
provided that all R¹⁹ are not simultaneously hydrogen and that the alpha-carbon of at least one R¹⁹ is a secondary or tertiary carbon;
provided that all R²⁰ are not simultaneously hydrogen, and that an alpha-carbon of at least one R²⁰ is a secondary carbon or a tertiary carbon;
provided that both R²¹ are not simultaneously hydrogen;
provided that the alpha-carbon of at least one R²¹ and/or R²² is a secondary or tertiary carbon;
provided that the alpha-carbon of at least one R²³ and/or R²³ is a secondary or tertiary carbon;
provided that the alpha-carbon of R^{W} is a secondary or tertiary carbon;
provided that R³⁴, R³, and R³⁶ are not simultaneously hydrogen; and
provided that R³⁷, R³⁸, and R³⁹ are not simultaneously hydrogen.

A tenth aspect relates to a method of minimizing a color change in a biocidal material, comprising: combining a copper-containing material comprising from 10 to 100 weight % of an amount of extractable copper with an amount of copper-coordinating additive, in a molar ratio of the amount of extractable copper to the amount of copper-coordinating additive of from 1:0.1 to 1:25 to form a copper-containing mixture; and combining the copper-containing mixture with a carrier to form the biocidal material, wherein a concentration of the copper-containing material and the copper-coordinating additive of the copper-containing mixture in the carrier is from 0.01% weight/weight of the carrier to 5% weight/weight of the carrier; and wherein the color change in the biocidal material is minimized relative to a change in color of a mixture of the carrier and the copper-containing material in the absence of the copper-coordinating additive.

An eleventh aspect relates to the method of aspect 10, wherein the copper-containing material comprises from 25 to 50 weight % of the amount of extractable copper.

A twelfth aspect relates to the method of aspects 10 or 11, wherein the copper-coordinating additive is a compound of formula (I), (II), (III), (IV), (V), (XI), or (XII):

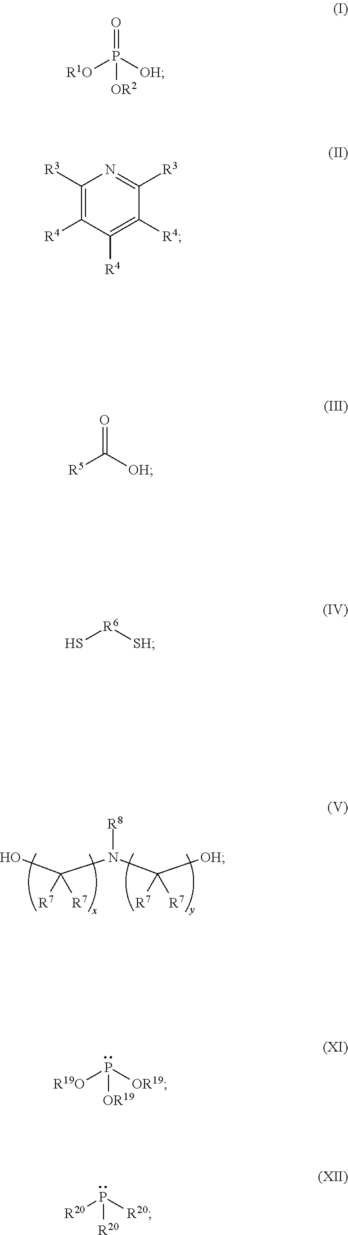

wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
each R³ is independently selected from the group consisting of hydrogen, (C₁-C₃₀)alkyl, (C₂-C₃₀)alkenyl, (C₂-C₃₀)alkynyl, aryl, heteroaryl, substituted or unsubstituted 2-pyridyl, heterocyclyl, aryl(C₁-C₄)alkyl, heteroaryl(C₁-C₄)alkyl, and heterocyclyl(C₁-C₄)alkyl;
the substituted 2-pyridyl is substituted with up to four substituents, each substituent independently selected from the group consisting of (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
each R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, and —CO₂H;
from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene;
the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkylene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
provided that the two thiol groups in formula (IV) are not bonded to the same carbon;
each R⁷ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R⁸ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R⁷)₂)_{z}OH;
each of x, y, and z is independently 2 or 3;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

A thirteenth aspect relates to the method of aspect 1, wherein the copper-coordinating additive is a thiol, zinc, or ascorbic acid, or a compound of formula (IV), (VI), (XI), (XII), (XIX), (XX), or (XXI):

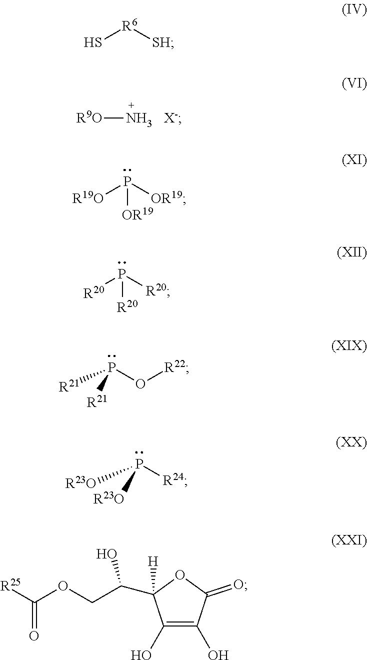

wherein X⁻ is selected from the group consisting of fluoride, chloride, bromide, iodide, hexafluorophosphate, sulfate, an alkylsulfonate, and an arylsulfonate;
wherein, from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene; the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
wherein R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
wherein R²⁵ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
optionally wherein the alpha-carbon of at least one R¹⁹ is a secondary or tertiary carbon;
optionally wherein the alpha-carbon of at least one R²¹ is a secondary or tertiary carbon; optionally wherein the alpha-carbon of R²² is a secondary or tertiary carbon;
optionally wherein the alpha-carbon of at least one R²³ is a secondary or tertiary carbon; and
optionally wherein the alpha-carbon of R²⁴ is a secondary or tertiary carbon;
provided that all R¹⁹ are not simultaneously hydrogen;
provided that all R²⁰ are not simultaneously hydrogen;
provided that at least one R²⁰ includes one or more heteroatoms selected from N, O, and S replacing the beta-carbon or gamma-carbon, and/or one or more heteroatoms selected from N, O, and S substituted for hydrogens on the alpha-carbon, beta-carbon, or gamma-carbon; or an alpha-carbon of at least one R²⁰ is a secondary carbon or a tertiary carbon;
provided that both R²¹ are not simultaneously hydrogen;
provided that both R²³ are not simultaneously hydrogen; and
provided that R⁶ has a structure such that the two thiol groups are not bonded to the same carbon.

A fourteenth aspect relates to the method of aspect 10, wherein the copper-coordinating additive is a soft base, benzotriazole, an amino acid, a surfactant, a compound comprising an imidazole or a reduced imidazole group, a nitrile compound, or a compound of formula (I), (VI), (VII), (XI), (XII), (XIX), (XX), (XXI), (XXII), (XXIII), (XXIV), (XXV), or (XXVI):

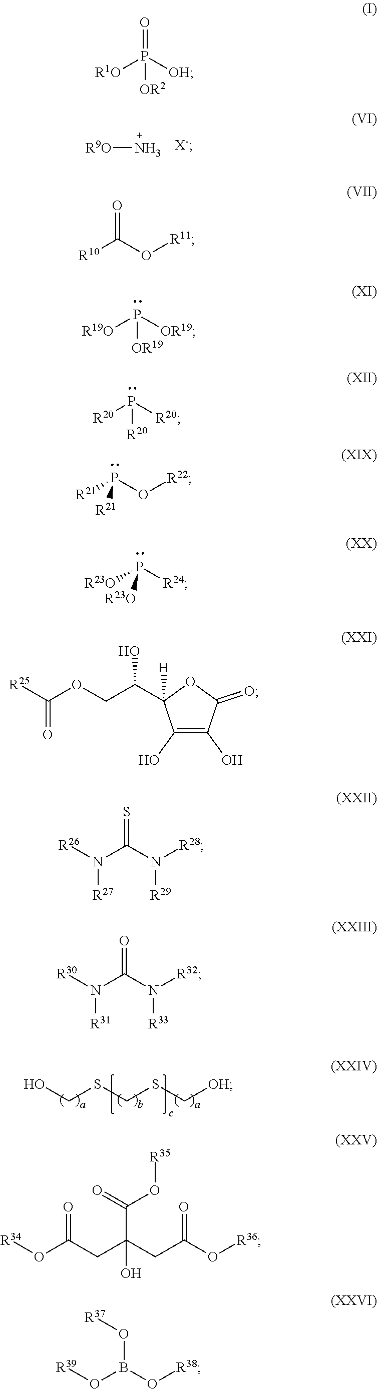

wherein X⁻ is selected from the group consisting of fluoride, chloride, bromide, iodide, hexafluorophosphate, sulfate, an alkylsulfonate, and an arylsulfonate;
wherein a is an integer from 1 to 4;
wherein b is an integer from 1 to 4,
wherein c is an integer from 0 to 3;
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R⁹ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R¹⁰ and R¹¹ is independently selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected form the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁵ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R²⁶, R²⁷, R²⁸, and R²⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁰, R³¹, R³², and R³³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁴, R, and R³⁶ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁷, R³⁸, and R³⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein the nitrile compound is selected from the group consisting of a (C₁-C₃₀)alkylnitrile, a (C₂-C₃₀)alkenylnitrile, a (C₂-C₃₀)alkynylnitrile, an arylnitrile, a heteroarylnitrile, a heterocyclylnitrile, an aryl(C₁-C₄)alkylnitrile, a heteroaryl(C₁-C₄)alkylnitrile, and a heterocyclyl(C₁-C₄)alkylnitrile; and
wherein a substituted compound of formula (XXIV) includes one or more carbons substituted with one or more substituents selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
optionally wherein the alpha-carbon of at least one of R²⁶, R²⁷, R²⁸, and R²⁹ is a secondary or tertiary carbon;
optionally wherein the alpha-carbon of at least one of R³⁰, R³¹, R³², and R³³ is a secondary or tertiary carbon;
optionally wherein the alpha-carbon of at least one of R³⁴, R³, and R³⁶ is a secondary or tertiary carbon;
optionally wherein the alpha-carbon of at least one of R³⁷, R³⁸, and R³⁹ is a secondary or tertiary carbon; and
optionally wherein the alpha-carbon of the nitrile compound is a secondary or tertiary carbon;
provided that both of R¹ and R² are not simultaneously hydrogen and that the alpha-carbon of at least one of R¹ and R² is a secondary or tertiary carbon;
provided that the alpha-carbon of R⁹ is a secondary or tertiary carbon;
provided that the alpha carbon of at least one of R¹⁰ and R¹¹ is a secondary or tertiary carbon;
provided that all R¹⁹ are not simultaneously hydrogen and that the alpha-carbon of at least one R¹⁹ is a secondary or tertiary carbon;
provided that all R²⁰ are not simultaneously hydrogen, and that an alpha-carbon of at least one R²⁰ is a secondary carbon or a tertiary carbon;
provided that both R²¹ are not simultaneously hydrogen;
provided that the alpha-carbon of at least one R²¹ and/or R²² is a secondary or tertiary carbon;
provided that the alpha-carbon of at least one R²³ and/or R²³ is a secondary or tertiary carbon;
provided that the alpha-carbon of R^{W} is a secondary or tertiary carbon;
provided that R³⁴, R³⁵, and R³⁶ are not simultaneously hydrogen; and
provided that R³⁷, R³⁸, and R³⁹ are not simultaneously hydrogen.

A fifteenth aspect relates to the method of any one of aspects 10 to 12, wherein the copper-coordinating additive is a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, 2,2′-bipyridine, terpyridine, citric acid, diethanolamine, triethanolamine, 14-crown-4, 15-crown-5, 18-crown-6, dibenzo-18-crown-6, aza-15-crown-5, aza-18-crown-6, and salen.

A sixteenth aspect relates to the method of aspects 10 to 15, wherein the biocidal material demonstrates a greater than 3 logarithmic reduction in a concentration of a bacteria selected from the group consisting of Staphylococcus aureus, Enterobacter aerogenes, Pseudomonas aeruginosa, Methicillin Resistant Staphylococcus aureus, E. coli, and mixtures thereof.

A seventeenth aspect relates to the method of aspects 10 to 16, wherein a CIE ΔE* value of the biocidal material is less than about 10, as measured according to formula (XIII):

$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$

wherein L*, a*, and b* are the CIE L*, a*, and b* values of the biocidal material and the L*_{control}, a*_{control}, and b*_{control} are the CIE L*, a*, and b* values of the carrier.

An eighteenth aspect relates to a method of accelerating to a color endpoint in a biocidal material, comprising combining a copper-containing material comprising from 10 to 100 weight % of an amount of extractable copper with an amount of copper-coordinating additive, in a molar ratio of the amount of extractable copper to the amount of copper-coordinating additive of from 1:0.1 to 1:25 to form a copper-coordinating mixture; and combining the copper-containing mixture with a carrier to form the biocidal material; wherein a concentration of the copper-containing material and the copper-coordinating additive of the copper-containing mixture in the carrier is from 0.01% weight/weight of the carrier to 5% weight/weight of the carrier; wherein a CIE ΔE* value of the biocidal material is less than about 10, as measured according to formula (XII):

$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$

wherein L*, a*, and b* are the CIE L*, a*, and b* values of the color endpoint and the L*_{control}, a*_{control}, and b*_{control} are the initial CIE L*, a*, and b* values of the biocidal material; and wherein the color endpoint in the biocidal material is accelerated relative to a change in color to a color endpoint of a mixture of the carrier and the copper-containing material in the absence of the copper-coordinating additive.

A nineteenth aspect relates to the method of aspect 18, wherein the copper-containing material comprises from 25 to 50 weight % of the amount of extractable copper.

A twentieth aspect relates to the method of aspects 18 or 19, wherein the copper-coordinating additive is a compound of formula (I), (III), (VI), (VII), (IX), (X), (XI), or (XII):

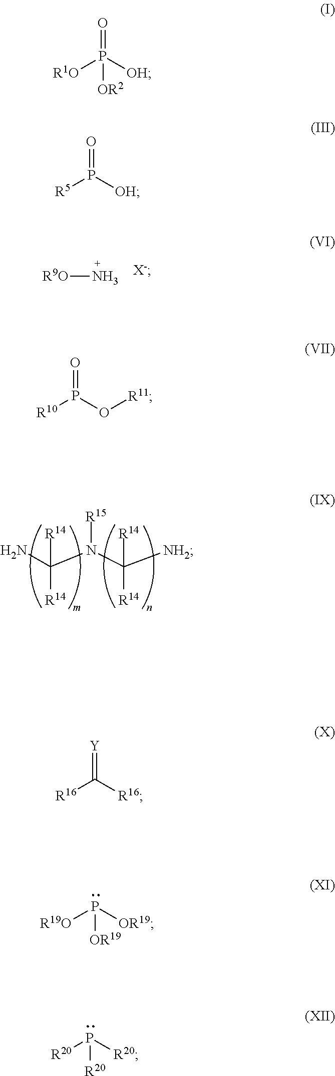

wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (III) are substituted with one or more substituents each of which is independently selected from the group consisting of —OH, —NH₂, —SH, —CN, —C(O)NH₂, and —CO₂H;
X⁻ is selected from the group consisting of fluoride, chloride, bromide, iodide, hexafluorophosphate, sulfate, an alkylsulfonate, and an arylsulfonate;
R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each of R¹⁰ and R¹¹ is independently selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (VII) are substituted with one or more substituents each of which is independently selected from the group consisting of —OH, —NH₂, —SH, —CN, —C(O)NH₂, —C(O)NHR¹¹, —C(O)NR¹¹2, —CO₂H, and —CO₂R¹¹;
each R¹⁴ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R¹⁵ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R¹⁴)₂)ₚNH₂;
each of m, n, and p is independently 2 or 3;
Y is O or S;
each R¹⁶ is independently —OR¹⁷ or —N(R¹⁸)₂;
R¹⁷ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each R¹⁸ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

A twenty-first aspect relates to the method of aspects 18 to 20, wherein the copper-coordinating additive is a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, citric acid, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen.

A twenty-second aspect relates to the method of aspects 18 to 21, wherein the biocidal material demonstrates a greater than 3 logarithmic reduction in a concentration of a bacterial selected from the group consisting of Staphylococcus aureus, Enterobacter aerogenes, Pseudomonas aeruginosa, Methicillin Resistant Staphylococcus aureus, E. coli, and mixtures thereof.

A twenty-third aspect relates to the method of aspects 18 to 22, wherein the method further comprises: treating the copper-containing material with a pretreatment solution prior to the combining with the amount of copper-coordinating additive.

A twenty-fourth aspect relates to the method of aspects 18 to 23, wherein the copper-coordinating additive is a compound of formula (VIII):

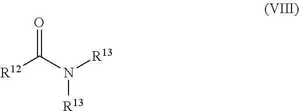

wherein R¹² is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
each R¹³ is independently selected from the group consisting of hydrogen, substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, —C(O)NHR¹³, —C(O)NR¹³2, —CO₂H, and —CO₂R¹³.

In addition to the features mentioned in each of the independent aspects enumerated above, some examples may show, alone or in combination, the optional features mentioned in the dependent aspects and/or as disclosed in the description above and shown in the figures.

1. A biocidal composition, comprising:
a carrier;
a copper-containing material in the carrier, wherein the copper-containing materials comprises from 10 to 100 weight % of an amount of extractable copper; and
a copper-coordinating additive in the carrier, in a molar ratio of the amount of extractable copper to an amount of the copper-coordinating additive of from 1:0.1 to 1:25,
wherein a concentration of the copper-containing material and the copper-coordinating additive in the carrier is from 0.01% weight/weight of the carrier to 5% weight/weight of the carrier.

2. The composition of claim 1, wherein the copper-containing material comprises from 25 to 50 weight % of the amount of extractable copper.

3. The composition of claim 1, wherein the copper-coordinating additive is a compound of formula (I), (II), (III), (IV), (V), (XI), or (XII): 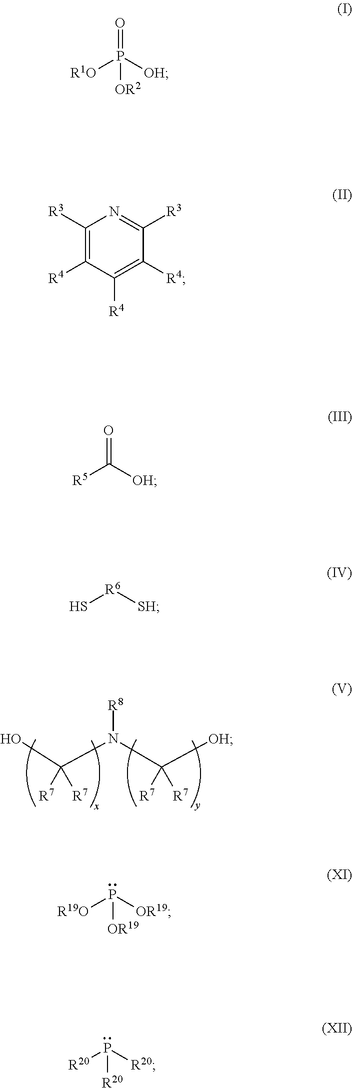
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
each R³ is independently selected from the group consisting of hydrogen, (C₁-C₃₀)alkyl, (C₂-C₃₀)alkenyl, (C₂-C₃₀)alkynyl, aryl, heteroaryl, substituted or unsubstituted 2-pyridyl, heterocyclyl, aryl(C₁-C₄)alkyl, heteroaryl(C₁-C₄)alkyl, and heterocyclyl(C₁-C₄)alkyl;
the substituted 2-pyridyl is substituted with up to four substituents, each substituent independently selected from the group consisting of (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
each R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, and —CO₂H;
from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene;
the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkylene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
provided that the two thiol groups in formula (IV) are not bonded to the same carbon;
each R⁷ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R⁸ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R⁷)₂)_{z}OH;
each of x, y, and z is independently 2 or 3;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

4. The composition of claim 1, wherein the copper-coordinating additive is a compound of formula (I), (III), (VI), (VII), (IX), (X), (XI), or (II): 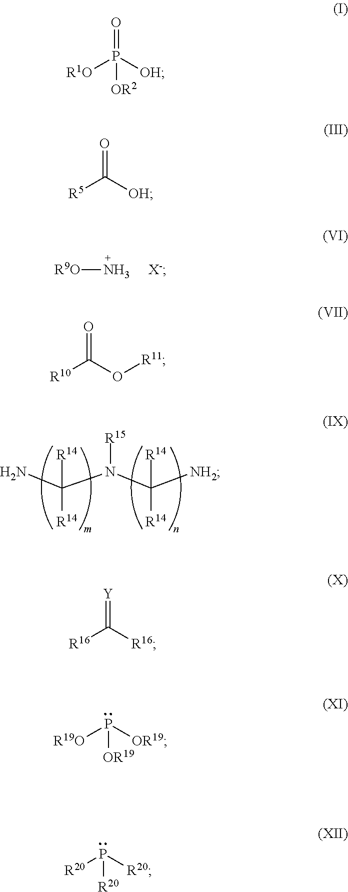
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (III) are substituted with one or more substituents each of which is independently selected from the group consisting of —OH, —NH₂, —SH, —CN, —C(O)NH₂, and —CO₂H;
X⁻ is selected from the group consisting of fluoride, chloride, bromide, iodide, hexafluorophosphate, sulfate, an alkylsulfonate, and an arylsulfonate;
R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each of R¹⁰ and R¹¹ is independently selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (VII) are substituted with one or more substituents each of which is independently selected from the group consisting of —OH, —NH₂, —SH, —CN, —C(O)NH₂, —C(O)NHR¹¹, —C(O)NR¹², —CO₂H, and —CO₂R¹¹;
each R¹⁴ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R¹⁵ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R¹⁴)₂)ₚNH₂;
each of m, n, and p is independently 2 or 3;
Y is O or S;
each R¹⁶ is independently —OR¹⁷ or —N(R¹⁸)₂;
R¹⁷ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
each R¹⁸ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

5. The composition of claim 1, wherein the copper-coordinating additive is a compound of formula (VIII): 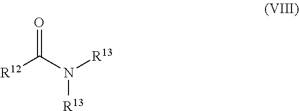
wherein R¹² is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
each R¹³ is independently selected from the group consisting of hydrogen, substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, —C(O)NHR¹³, —C(O)NR¹³₂, —CO₂H, and —CO₂R¹³; and
wherein the composition further comprises a pretreatment solution.

6. The composition of claim 1, wherein the copper-coordinating additive is a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, 2,2′-bipyridine, terpyridine, citric acid, diethanolamine, triethanolamine, hydroxyamine hydrochloride, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen.

7. The composition of claim 1, wherein the composition demonstrates a greater than 3 logarithmic reduction in a concentration of a bacteria selected from the group consisting of Staphylococcus aureus, Enterobacter aerogenes, Pseudomonas aeruginosa, Methicillin Resistant Staphylococcus aureus, E. coli, and mixtures thereof.

8. The composition of claim 1, wherein the copper-coordinating additive is a thiol, zinc, or ascorbic acid, or a compound of formula (IV), (VI), (XI), (XII), (XIX), (XX), or (XXI): 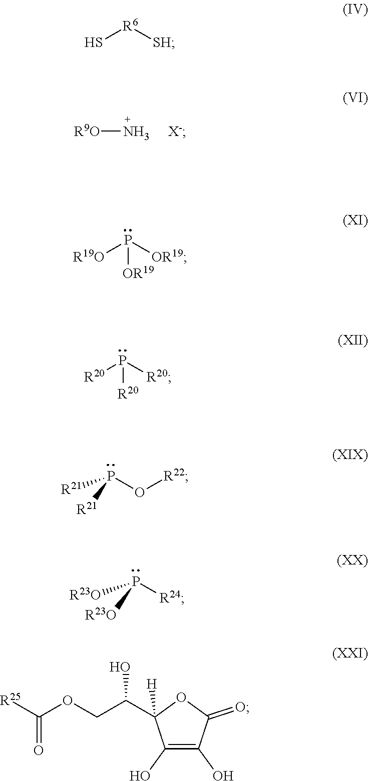
wherein X⁻ is selected from the group consisting of fluoride, chloride, bromide, iodide, hexafluorophosphate, sulfate, an alkylsulfonate, and an arylsulfonate;
R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R⁵ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
wherein, from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene; the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
optionally wherein the alpha-carbon of at least one R¹⁹ is a secondary or tertiary carbon;
optionally wherein the alpha-carbon of at least one R²¹ is a secondary or tertiary carbon; optionally wherein the alpha-carbon of R²² is a secondary or tertiary carbon;
optionally wherein the alpha-carbon of at least one R²³ is a secondary or tertiary carbon; and
optionally wherein the alpha-carbon of R²⁴ is a secondary or tertiary carbon;
provided that all R¹⁹ are not simultaneously hydrogen;
provided that all R²⁰ are not simultaneously hydrogen;
provided that at least one R²⁰ includes one or more heteroatoms selected from N, O, and S replacing the beta-carbon or gamma-carbon, and/or one or more heteroatoms selected from N, O, and S substituted for hydrogens on the alpha-carbon, beta-carbon, or gamma-carbon; or an alpha-carbon of at least one R²⁰ is a secondary carbon or a tertiary carbon;
provided that both R²¹ are not simultaneously hydrogen;
provided that both R²³ are not simultaneously hydrogen; and
provided that R⁶ has a structure such that the two thiol groups are not bonded to the same carbon.

9. The composition of claim 1, wherein the copper-coordinating additive is a soft base, benzotriazole, an amino acid, a surfactant, a compound comprising an imidazole or a reduced imidazole group, a nitrile compound, or a compound of formula (I), (VI), (VII), (XI), (XII), (XIX), (XX), (XXI), (XXII), (XXIII), (XXIV), (XXV), or (XXVI): 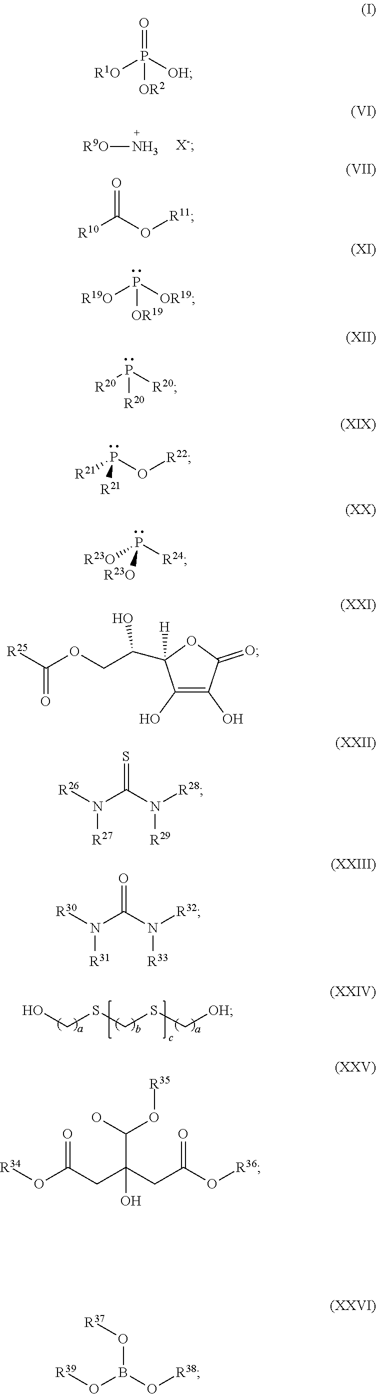
wherein X⁻ is selected from the group consisting of fluoride, chloride, bromide, iodide, hexafluorophosphate, sulfate, an alkylsulfonate, and an arylsulfonate;
wherein a is an integer from 1 to 4;
wherein b is an integer from 1 to 4,
wherein c is an integer from 0 to 3;
wherein each of R¹ and R² is independently selected from the group consisting of hydrogen, (C₁-C_{3M})alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R⁹ is selected from the group consisting of (C₁-C_{3M})alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R¹⁰ and R¹¹ is independently selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected form the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁵ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R²⁶, R²⁷, R²⁸, and R²⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁰, R³¹, R³², and R³³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁴, R³⁵, and R³⁶ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁷, R³⁸, and R³⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein the nitrile compound is selected from the group consisting of a (C₁-C₃₀)alkylnitrile, a (C₂-C₃₀)alkenylnitrile, a (C₂-C₃₀)alkynylnitrile, an arylnitrile, a heteroarylnitrile, a heterocyclylnitrile, an aryl(C₁-C₄)alkylnitrile, a heteroaryl(C₁-C₄)alkylnitrile, and a heterocyclyl(C₁-C₄)alkylnitrile; and
wherein a substituted compound of formula (XXIV) includes one or more carbons substituted with one or more substituents selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
optionally wherein the alpha-carbon of at least one of R²⁶, R²⁷, R²⁸, and R²⁹ is a secondary or tertiary carbon;
optionally wherein the alpha-carbon of at least one of R³⁰, R³¹, R³², and R³³ is a secondary or tertiary carbon;
optionally wherein the alpha-carbon of at least one of R³⁴, R³⁵, and R³⁶ is a secondary or tertiary carbon;
optionally wherein the alpha-carbon of at least one of R³⁷, R³⁸, and R³⁹ is a secondary or tertiary carbon; and
optionally wherein the alpha-carbon of the nitrile compound is a secondary or tertiary carbon;
provided that both of R¹ and R² are not simultaneously hydrogen and that the alpha-carbon of at least one of R¹ and R² is a secondary or tertiary carbon;
provided that the alpha-carbon of R⁹ is a secondary or tertiary carbon;
provided that the alpha carbon of at least one of R¹⁰ and R¹¹ is a secondary or tertiary carbon;
provided that all R¹⁹ are not simultaneously hydrogen and that the alpha-carbon of at least one R¹⁹ is a secondary or tertiary carbon;
provided that all R²⁰ are not simultaneously hydrogen, and that an alpha-carbon of at least one R²⁰ is a secondary carbon or a tertiary carbon;
provided that both R²¹ are not simultaneously hydrogen;
provided that the alpha-carbon of at least one R¹ and/or R²² is a secondary or tertiary carbon;
provided that the alpha-carbon of at least one R²³ and/or R²³ is a secondary or tertiary carbon;
provided that the alpha-carbon of R² is a secondary or tertiary carbon;
provided that R³⁴, R³⁵, and R³⁶ are not simultaneously hydrogen; and
provided that R³⁷, R³⁸, and R³⁹ are not simultaneously hydrogen.

10. A method of minimizing a color change in a biocidal material, comprising:
combining a copper-containing material comprising from 10 to 100 weight % of an amount of extractable copper with an amount of copper-coordinating additive, in a molar ratio of the amount of extractable copper to the amount of copper-coordinating additive of from 1:0.1 to 1:25 to form a copper-containing mixture; and
combining the copper-containing mixture with a carrier to form the biocidal material,
wherein a concentration of the copper-containing material and the copper-coordinating additive of the copper-containing mixture in the carrier is from 0.01% weight/weight of the carrier to 5% weight/weight of the carrier; and
wherein the color change in the biocidal material is minimized relative to a change in color of a mixture of the carrier and the copper-containing material in the absence of the copper-coordinating additive.

11. The method of claim 10, wherein the copper-containing material comprises from 25 to 50 weight % of the amount of extractable copper.

12. The method of claim 10, wherein the copper-coordinating additive is a compound of formula (I), (II), (III), (IV), (V), (XI), or (XII): 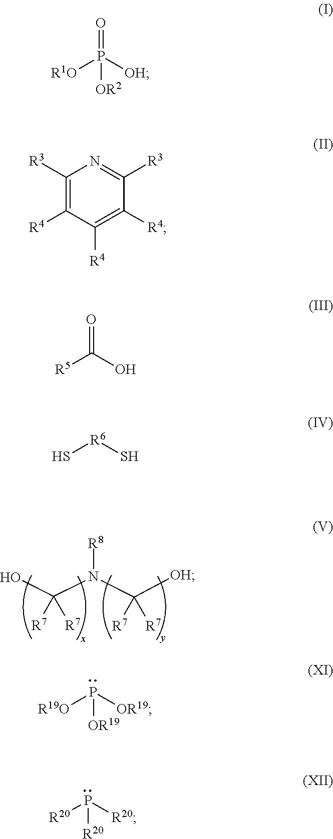
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
each R³ is independently selected from the group consisting of hydrogen, (C₁-C₃₀)alkyl, (C₂-C₃₀)alkenyl, (C₂-C₃₀)alkynyl, aryl, heteroaryl, substituted or unsubstituted 2-pyridyl, heterocyclyl, aryl(C₁-C₄)alkyl, heteroaryl(C₁-C₄)alkyl, and heterocyclyl(C₁-C₄)alkyl;
the substituted 2-pyridyl is substituted with up to four substituents, each substituent independently selected from the group consisting of (C₁-C₃₀)alkyl, (C₁-C₃₀)alkoxy, (C₂-C₃₀)alkenyl, (C₂-C₃₀)alkenoxy, (C₂-C₃₀)alkynyl, (C₂-C₃₀)alkynoxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
each R⁴ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SH, —CN, —C(O)NH₂, and —CO₂H;
from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene;
the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkylene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
provided that the two thiol groups in formula (IV) are not bonded to the same carbon;
each R⁷ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂—C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R⁸ is selected from the group consisting of hydrogen, (C₁-C_{3M})alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R⁷)₂)_{z}OH;
each of x, y, and z is independently 2 or 3;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
provided that all R²⁰ are not simultaneously hydrogen.

13. The method of claim 10, wherein the copper-coordinating additive is a thiol, zinc, or ascorbic acid, or a compound of formula (IV), (VI), (XI), (XII), (XIX), (XX), or (XXI): 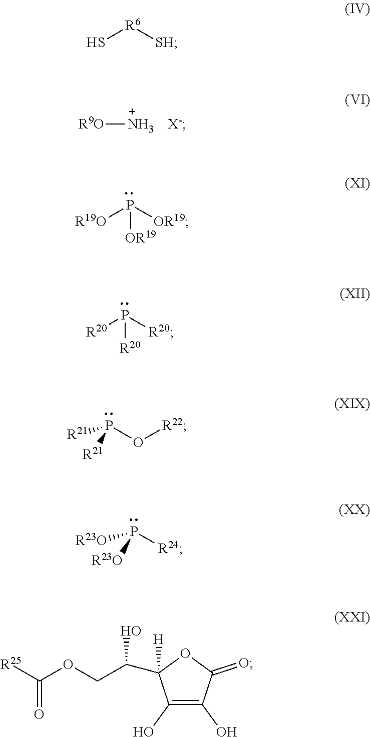
wherein X⁻ is selected from the group consisting of fluoride, chloride, bromide, iodide, hexafluorophosphate, sulfate, an alkylsulfonate, and an arylsulfonate;
R⁹ is selected from the group consisting of hydrogen, (C₁-C_{3M})alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃M)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected from the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃M)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C_{3M})alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃M)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁵ is selected from the group consisting of (C₁-C_{3M})alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl; and
wherein, from S to S, R⁶ is selected from the group consisting of substituted or unsubstituted (C₂-C₃₀)alkylene, substituted or unsubstituted (C₂-C₃₀)alkenylene, substituted or unsubstituted (C₂-C₃₀)alkynylene, substituted or unsubstituted aryl(C₁-C₄)alkylene, substituted or unsubstituted (C₁-C₄)alkylarylene, substituted or unsubstituted (C₁-C₄)alkylaryl(C₁-C₄)alkylene, substituted or unsubstituted heteroaryl(C₁-C₄)alkylene, substituted or unsubstituted (C₁-C₄)alkylheteroarylene, substituted or unsubstituted (C₁-C₄)alkylheteroaryl(C₁-C₄)alkylene, substituted or unsubstituted heterocyclyl(C₁-C₄)alkylene, substituted or unsubstituted (C₁-C₄)alkylheterocyclylene, and substituted or unsubstituted (C₁-C₄)alkylheterocyclyl(C₁-C₄)alkylene; the substituted (C₂-C₃₀)alkylene, substituted (C₂-C₃₀)alkenylene, substituted (C₂-C₃₀)alkynylene, substituted aryl(C₁-C₄)alkylene, substituted (C₁-C₄)alkylarylene, substituted (C₁-C₄)alkylaryl(C₁-C₄)alkene, substituted heteroaryl(C₁-C₄)alkylene, substituted (C₁-C₄)alkylheteroarylene, substituted (C₁-C₄)alkylheteroaryl(C₁-C₄)alkylene, substituted heterocyclyl(C₁-C₄)alkylene, substituted (C₁-C₄)alkylheterocyclylene, and substituted (C₁-C₄)alkylheterocyclyl(C₁-C₄)alkylene are substituted with one or more substituents each independently selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
optionally wherein the alpha-carbon of at least one R¹⁹ is a secondary or tertiary carbon;
optionally wherein the alpha-carbon of at least one R²¹ is a secondary or tertiary carbon; optionally wherein the alpha-carbon of R²² is a secondary or tertiary carbon;
optionally wherein the alpha-carbon of at least one R²³ is a secondary or tertiary carbon; and
optionally wherein the alpha-carbon of R²⁴ is a secondary or tertiary carbon;
provided that all R¹⁹ are not simultaneously hydrogen;
provided that all R²⁰ are not simultaneously hydrogen;
provided that at least one R²⁰ includes one or more heteroatoms selected from N, O, and S replacing the beta-carbon or gamma-carbon, and/or one or more heteroatoms selected from N, O, and S substituted for hydrogens on the alpha-carbon, beta-carbon, or gamma-carbon; or an alpha-carbon of at least one R²⁰ is a secondary carbon or a tertiary carbon;
provided that both R²¹ are not simultaneously hydrogen;
provided that both R²³ are not simultaneously hydrogen; and
provided that R⁶ has a structure such that the two thiol groups are not bonded to the same carbon.

14. The method of claim 10, wherein the copper-coordinating additive is a soft base, benzotriazole, an amino acid, a surfactant, a compound comprising an imidazole or a reduced imidazole group, a nitrile compound, or a compound of formula (I), (VI), (VII), (XI), (XII), (XIX), (XX), (XXI), (XXII), (XXIII), (XXIV), (XXV), or (XXVI): 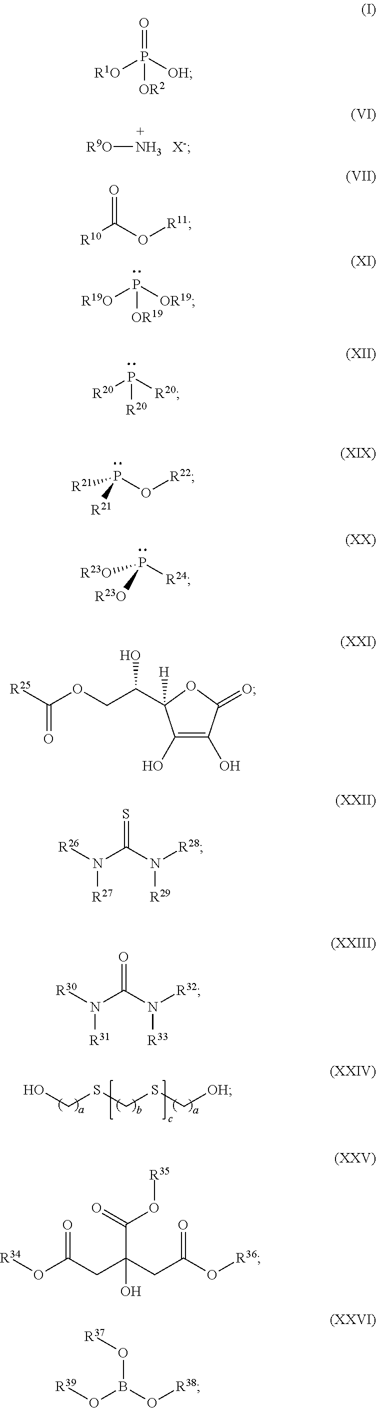
wherein X⁻ is selected from the group consisting of fluoride, chloride, bromide, iodide, hexafluorophosphate, sulfate, an alkylsulfonate, and an arylsulfonate;
wherein a is an integer from 1 to 4;
wherein b is an integer from 1 to 4,
wherein c is an integer from 0 to 3;
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R⁹ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R¹⁰ and R¹¹ is independently selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²⁰ is independently selected form the group consisting of hydrogen, (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each R²¹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²² is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each R²³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl;
wherein R²⁴ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein R²⁵ is selected from the group consisting of (C₁-C₃₀)alkyl, (C₂-C₃₀)alkenyl, (C₂-C₃₀)alkynyl, aryl(C₁-C₄)alkyl, heteroaryl(C₁-C₄)alkyl, and heterocyclyl(C₁-C₄)alkyl;
wherein each of R²⁶, R²⁷, R²⁸, and R²⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁰, R³¹, R³², and R³³ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁴, R³⁵, and R³⁶ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein each of R³⁷, R³⁸, and R³⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
wherein the nitrile compound is selected from the group consisting of a (C₁-C₃₀)alkylnitrile, a (C₂-C₃₀)alkenylnitrile, a (C₂-C₃₀)alkynylnitrile, an arylnitrile, a heteroarylnitrile, a heterocyclylnitrile, an aryl(C₁-C₄)alkylnitrile, a heteroaryl(C₁-C₄)alkylnitrile, and a heterocyclyl(C₁-C₄)alkylnitrile; and
wherein a substituted compound of formula (XXIV) includes one or more carbons substituted with one or more substituents selected from the group consisting of (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
optionally wherein the alpha-carbon of at least one of R²⁶, R²⁷, R²⁸, and R²⁹ is a secondary or tertiary carbon;
optionally wherein the alpha-carbon of at least one of R³⁰, R³¹, R³², and R³³ is a secondary or tertiary carbon;
optionally wherein the alpha-carbon of at least one of R³⁴, R³⁵, and R³⁶ is a secondary or tertiary carbon;
optionally wherein the alpha-carbon of at least one of R³⁷, R³⁸, and R³⁹ is a secondary or tertiary carbon; and
optionally wherein the alpha-carbon of the nitrile compound is a secondary or tertiary carbon;
provided that both of R¹ and R² are not simultaneously hydrogen and that the alpha-carbon of at least one of R¹ and R² is a secondary or tertiary carbon;
provided that the alpha-carbon of R⁹ is a secondary or tertiary carbon;
provided that the alpha carbon of at least one of R¹⁰ and R¹¹ is a secondary or tertiary carbon;
provided that all R¹⁹ are not simultaneously hydrogen and that the alpha-carbon of at least one R¹⁹ is a secondary or tertiary carbon;
provided that all R²⁰ are not simultaneously hydrogen, and that an alpha-carbon of at least one R²⁰ is a secondary carbon or a tertiary carbon;
provided that both R²¹ are not simultaneously hydrogen;
provided that the alpha-carbon of at least one R²¹ and/or R²² is a secondary or tertiary carbon;
provided that the alpha-carbon of at least one R²³ and/or R²³ is a secondary or tertiary carbon;
provided that the alpha-carbon of R²⁵ is a secondary or tertiary carbon;
provided that R³⁴, R³⁵, and R³⁶ are not simultaneously hydrogen; and
provided that R³⁷, R³⁸, and R³⁹ are not simultaneously hydrogen.

15. The method of claim 10, wherein the copper-coordinating additive is a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, 2,2′-bipyridine, terpyridine, citric acid, diethanolamine, triethanolamine, 14-crown-4, 15-crown-5, 18-crown-6, dibenzo-18-crown-6, aza-15-crown-5, aza-18-crown-6, and salen.

16. The method of claim 10, wherein the biocidal material demonstrates a greater than 3 logarithmic reduction in a concentration of a bacteria selected from the group consisting of Staphylococcus aureus, Enterobacter aerogenes, Pseudomonas aeruginosa, Methicillin Resistant Staphylococcus aureus, E. coli, and mixtures thereof.

17. The method of claim 10, wherein a CIE ΔE* value of the biocidal material is less than about 10, as measured according to formula (XIII):
$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$
wherein L*, a*, and b* are the CIE L*, a*, and b* values of the biocidal material and the L*_{control}, a*_{control}, and b*_{control} are the CIE L*, a*, and b* values of the carrier.

18. A method of accelerating to a color endpoint in a biocidal material, comprising:
combining a copper-containing material comprising from 10 to 100 weight % of an amount of extractable copper with an amount of copper-coordinating additive, in a molar ratio of the amount of extractable copper to the amount of copper-coordinating additive of from 1:0.1 to 1:25 to form a copper-coordinating mixture; and
combining the copper-containing mixture with a carrier to form the biocidal material;
wherein a concentration of the copper-containing material and the copper-coordinating additive of the copper-containing mixture in the carrier is from 0.01% weight/weight of the carrier to 5% weight/weight of the cater;
wherein a CIE ΔE* value of the biocidal material is less than about 10, as measured according to formula (XII):
$$Δ {E}_{C}^{*} = \sqrt{( {( {L}^{*} - {L}_{c ontrol}^{*} )}^{2} + {( {a}^{*} - {a}_{control}^{*} )}^{2} + {( {b}^{*} - {b}_{c ontrol}^{*} )}^{2} )} \qquad ( XIII )$$
wherein L*, a*, and b* are the CIE L*, a*, and b* values of the color endpoint and the L*_{control}, a*_{control}, and b*_{control} are the initial CIE L*, a*, and b* values of the biocidal material;
wherein the color endpoint in the biocidal material is accelerated relative to a change in color to a color endpoint of a mixture of the carrier and the copper-containing material in the absence of the copper-coordinating additive,
wherein the copper-containing material comprises from 25 to 50 weight % of the amount of extractable copper; and
wherein the biocidal material demonstrates a greater than 3 logarithmic reduction in a concentration of a bacterial selected from the group consisting of Staphvlococcus aureus, Enterobacter aerogenes, Pseudomonas aeruginosa, Methicillin Resistant Staphylococcus aureus, E. coli, and mixtures thereof.

19. (canceled)

20. The method of claim 18, wherein the copper-coordinating additive is a compound of formula (I), (III), (VI), (VII), (IX), (X), (XI), or (XII): 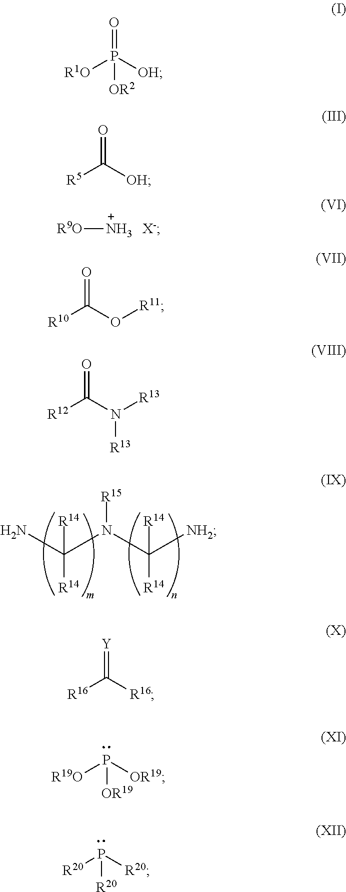
wherein each of R¹ and R² is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that both of R¹ and R² are not simultaneously hydrogen;
R⁵ is selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (III) are substituted with one or more substituents each of which is independently selected from the group consisting of —OH, —NH₂, —SH, —CN, —C(O)NH₂, and —CO₂H;
X⁻ is selected from the group consisting of fluoride, chloride, bromide, iodide, hexafluorophosphate, sulfate, an alkylsulfonate, and an arylsulfonate;
R⁹ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each of R¹⁰ and R¹¹ is independently selected from the group consisting of substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl;
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl in formula (VII) are substituted with one or more substituents each of which is independently selected from the group consisting of —OH, —NH₂, —SH, —CN, —C(O)NH₂, —C(O)NHR¹¹, —C(O)NR¹², —CO₂H, and —CO₂R¹¹;
each R¹⁴ is independently selected from the group consisting of hydrogen, (C₁-C₃₀)alkyl, (C₁-C₃₀)alkoxy, (C₂-C₃₀)alkenyl, (C₂-C₃₀)alkenyloxy, (C₂-C₃₀)alkynyl, (C₂-C₃₀)alkynyloxy, aryl, aryloxy, heteroaryl, heteroaryloxy, heterocyclyl, heterocyclyloxy, aryl(C₁-C₄)alkyl, aryl(C₁-C₄)alkoxy, heteroaryl(C₁-C₄)alkyl, heteroaryl(C₁-C₄)alkoxy, heterocyclyl(C₁-C₄)alkyl, and heterocyclyl(C₁-C₄)alkoxy;
R¹⁵ is selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, heterocyclyl(C₁-C₄)alkyl, and —(C(R¹⁴)₂)ₚNH₂;
each of m, n, and p is independently 2 or 3;
Y is O or S;
each R¹⁶ is independently —OR¹⁷ or —N(R¹⁸)₂;
R¹⁷ is selected from the group consisting of (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each R¹⁸ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
each R¹⁹ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R¹⁹ are not simultaneously hydrogen;
each R²⁰ is independently selected from the group consisting of hydrogen, (C₁-C₃₀)alkyl, (C₂-C₃₀)alkenyl, (C₂-C₃₀)alkynyl, aryl, heteroaryl, heterocyclyl, aryl(C₁-C₄)alkyl, heteroaryl(C₁-C₄)alkyl, and heterocyclyl(C₁-C₄)alkyl;
provided that all R²⁰ are not simultaneously hydrogen;
wherein R¹² is selected from the group consisting of substituted or unsubstituted (C₁-C₃₀ alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁—C₄)alkyl, substituted or unsubstituted heteroaryl(C₁-C₄)alkyl, and substituted or unsubstituted heterocyclyl(C₁-C₄)alkyl;
each R¹³ is independently selected from the group consisting of hydrogen, substituted or unsubstituted (C₁-C₃₀)alkyl, substituted or unsubstituted (C₂-C₃₀)alkenyl, substituted or unsubstituted (C₂-C₃₀)alkynyl, substituted or unsubstituted aryl, substituted or unsubstituted heteroaryl, substituted or unsubstituted heterocyclyl, substituted or unsubstituted aryl(C₁-C₄)alkyl, substituted or unsubstituted heteroaryl(C₁-C₄)alkyl, and substituted or unsubstituted heterocyclyl(C₁-C₄)alkyl; and
the substituted (C₁-C₃₀)alkyl, substituted (C₂-C₃₀)alkenyl, substituted (C₂-C₃₀)alkynyl, substituted aryl, substituted heteroaryl, substituted heterocyclyl, substituted aryl(C₁-C₄)alkyl, substituted heteroaryl(C₁-C₄)alkyl, and substituted heterocyclyl(C₁-C₄)alkyl are substituted with one or more substituents each of which is independently selected from the group consisting of —OH, —NH₂, —SR —CN, —C(O)NH₂, —C(O)NHR¹³, —C(O)NR¹³₂, —CO₂H, and —CO₂R¹³.

21. The method of claim 18, wherein the copper-coordinating additive is a compound selected from the group consisting of 2-ethylhexyl phosphate, bis(2-ethylhexyl)phosphate, methyl phosphate, dimethyl phosphate, trimethyl phosphate, phenyl phosphate, diphenyl phosphate, citric acid, ethoxyamine hydrochloride, triethyl citrate, thiourea, urea, 14-crown-4, 15-crown-5, 18-crown-6, dibenzo-18-crown-6, aza-15-crown-5, aza-18-crown-6, and salen.

22.-24. (canceled)
